(19) United States
(12) Patent Application Publication
(10) Pub. No.: US 2014/0081665 A1
(43) Pub. Date: Mar. 20, 2014

(54) INFORMATION MANAGEMENT SYSTEMS AND METHODS USING A BIOLOGICAL SIGNATURE

(71) Applicant: Theranos, Inc., Palo Alto, CA (US)

(72) Inventor: Elizabeth Holmes, Palo Alto, CA (US)

(73) Assignee: Theranos, Inc., Palo Alto, CA (US)

(21) Appl. No.: 14/019,946

(22) Filed: Sep. 6, 2013

Related U.S. Application Data
(60) Provisional application No. 61/699,632, filed on Sep. 11, 2012.

(51) Int. Cl. G06F 19/00

(52) U.S. Cl. CPC G06F 19/322
USPC 705/3

(57) ABSTRACT

Systems and methods are provided for generating a biological signature such as a genetic signature and using such signature of an individual. The biological signature may be used to verify the identity of the individual. A verified individual may be granted access to a secured location, item, and/or service. Biological signatures may also be used to search or aggregate records for an individual.

### CROSS-REFERENCE

This application claims the benefits of U.S. Provisional Application No. 61/699,632, filed Sep. 11, 2012, which application is incorporated herein by reference in its entirety.

### BACKGROUND

With the explosion of technology and electronic data, a more accurate way of identifying an individual is desired. Improved identification and authentication techniques are particularly desirable to enable the positive identification of individuals in the digital era to address issues such as identify fraud, inaccurate and/or incomplete records, and unreliable identification of individuals.

Medical recordkeeping is one area that could benefit from improved identification techniques. Currently, access to medical records for individuals is limited. As people move between different medical facilities, many of their past medical records are lost and not shared with the current medical facilities. When attempting to aggregate data across multiple systems, or even access data from multiple systems for a particular individual, there are many difficulties that arise with respect to uncertainties surrounding whether an individual identified in a record is the same individual as identified in another record. For example, multiple people may have the same name. Even combining several different types of information, it may be difficult to verify the identity of an individual with absolute certainty. There may also be cases of identity theft or fraud where an individual may be trying to pass off as another individual. Due to the uncertainty in confirming an individual's identity, many past records which may be useful to provide health care for an individual are not relied upon.

Importantly, currently there are no truly unique identifiers or effective conventional methods for creating unique patient identities in a database. Using traditional techniques does not enable a truly unique way to identify an individual. Today, an individual identifier is assigned by the system programmatically or sequentially, and there is no other unique way to identify, for example, a patient because names, addresses and date of birth (DOB) are not truly unique and not everyone uses them as unique identifiers.

As a result, large scale data integration across different types of data sets using conventional identification methods is highly compromised. A patient with a common name may show up multiple times in a database. A medical practitioner, for example, is at great risk in assuming that a patient with a certain name who shows up in their office is the same person whose data they are viewing in a database as the risk of treatment inaccurately has critical consequences. Also a person cannot organize or index data effectively as the same name may show up over and over multiple times.

Fingerprints and retinal scans have been used in some settings to provide identification. See, e.g., U.S. Patent Publication No. 2007/0047770, which is hereby incorporated herein by reference in its entirety for all purposes. These methods can be compromised, however, through duplication of the identifier such as by lifting or scanning a fingerprint of another person or duplication of a person's retinal image. Thus, a need exists for improved identification techniques.

### SUMMARY

Improved systems and methods are provided for identifying individuals. At least some embodiments herein provide for generating and using databases that include unique identifiers for individuals. At least some embodiments herein provide for systems and methods for authenticating individuals and providing individuals with access to locations, devices, and/or information. As different kinds of records are associated with a large number of people who may share common characteristics, such as identical names, at least some embodiments herein provide a more accurate way of identifying an individual is desired to positively associate the individual with one or more records, such as medical records, financial records, commercial records, or any other records that may be stored in electronic form. One or more embodiments herein use certain biological identifiers that are unique to an individual. One or more embodiments herein will (1) facilitate large scale integration of data across different databases and different types of data, and/or (2) eliminate fragmentation of data across multiple databases or diverse systems around the same subject, same patient or same member or individual.

In one embodiment, a method of creating a data repository for records of individual subjects is provided, the method including: associating, using a processor, a genetic signature of a subject with at least one record of the subject, wherein the genetic signature is obtained by (i) obtaining a biological sample containing at least one nucleic acid molecule of the subject, and (ii) generating a genetic signature from said at least one nucleic acid molecule, wherein the genetic signature is indicative of the identity of said subject; and storing the genetic signature and the record within one or more database. The method may be used to create a data repository for records of individual subjects. The method may further include repeating the above steps for at least one additional subject. The method may further include performing nucleic acid amplification of the at least one nucleic acid molecule on the sample processing device.

In another embodiment, a method of verifying an identity of an individual is provided, the method including: comparing, with the aid of a processor, a genetic signature of the individual with a pre-collected genetic signature of the individual stored in a memory unit, wherein, the genetic signature is obtained by analyzing a biological sample of the individual tendered at a point of service location, the point of service location includes a sample processing device configured to receive the biological sample from the individual and process the sample to yield the genetic signature, and a match between the genetic signature and the pre-collected genetic signature verifies the identity of the individual. The processor and the memory unit may or may not be part of the same device.

In another embodiment, a method of verifying the identity of an individual is provided, the method including: comparing, with the aid of a processor, a genetic signature of the individual with a pre-collected genetic signature of the individual stored in a memory unit, wherein, the genetic signature is obtained by analyzing a biological sample of the individual, the amount of time between collecting the biological sample from the individual and completion of comparing the genetic signature with the pre-collected genetic signature is no more than twenty-four hours, and a match between the genetic signature and the pre-collected genetic signature verifies the identity of the individual. The processor and the memory unit may or may not be part of the same device.

In another embodiment, a method of associating a genetic signature of an individual with a medical record is provided, including: comparing, with the aid of a processor, a genetic signature of the individual with a pre-collected genetic signature of the individual stored in a memory unit, wherein, the genetic signature is obtained by analyzing a biological sample of the individual tendered at a point of service location, a match between the genetic signature and the pre-collected genetic signature verifies the identity of said individual, the pre-collected genetic signature has one or more medical record associated therewith, and, verification of the identity of the individual permits the association of the genetic signature with said one or more medical record.

In another embodiment, a method of providing an individual with access to a secured location or device is provided, including: comparing, with the aid of a processor, a genetic signature of the individual with a pre-collected genetic signature of the individual stored in a memory unit, wherein, the genetic signature is obtained by analyzing a biological sample of the individual tendered at a point of service location, a match between said genetic signature and said pre-collected genetic signature verifies the identity of the individual, and provides the individual with access to a secured location or device if the verified identity of the individual falls within a group of one or more identities permitted to access the secured location or device.

In another embodiment, a method of verifying an identity of an individual is provided, including: comparing, with the aid of a processor, a genetic signature of the individual with a pre-collected genetic signature of the individual stored in a memory unit, and a dynamic biological signature of the individual with a pre-collected dynamic biological signature of the individual stored in a memory unit, wherein, the genetic signature and the dynamic biological signature are obtained by analyzing one or more biological sample of the individual tendered at a point of service location, and a match between the genetic signature and the pre-collected genetic signature, and a degree of change between the dynamic biological signature and the pre-collected dynamical biological signature falling within a predicted trajectory, verifies the identity of the individual. The predicted trajectory may be determined based on knowledge of trends of the dynamic biological signature. The predicted trajectory may be determined based on one or more predictive model. The predictive model may incorporate pre-collected dynamic biological signature data from the individual.

In another embodiment, a method of aggregating a plurality of records is provided, including: providing a first record system comprising a first memory unit that stores one or more records relating to one or more subjects, an individual record comprising a genetic signature of an individual subject that is associated with at least one type of personal information of said individual subject; providing a second record system comprising a second memory unit that stores one or more records relating to one or more subjects, an individual record comprising a genetic signature of an individual subject that is associated with at least one type of personal information of said individual subject; and comparing, using a processor, a genetic signature of the first record system and a genetic signature of the second record system, wherein if the genetic signature of the first record system and the genetic signature of the second record systems are the same, associating the records of the first and second records systems, thereby aggregating the plurality of records.

In another embodiment, a method of creating a data repository having unique identifiers for records of individual subjects is provided, the method including: associating, using a processor, the genetic signature of a subject with at least one record of said subject, wherein the genetic signature is a unique identifier of said subject, and wherein the genetic signature is obtained by (i) obtaining a biological sample containing at least one nucleic acid molecule of the subject, and (ii) generating a genetic signature from the at least one nucleic acid molecule, wherein the genetic signature is indicative of the identity of said subject, storing the genetic signature and the record in one or more database; and using the genetic signatures as an index providing access to the record in the one or more data repositories.

In another embodiment, a method of encrypting data is provided, the method including: generating, using a processor, a data encryption key using a genetic signature of a subject, wherein the genetic signature is obtained by (i) obtaining a biological sample containing at least one nucleic acid molecule of the subject, and (ii) generating a genetic signature from the at least one nucleic acid molecule; and encrypting data provided by the subject with the data encryption key.

In another embodiment, a method of encrypting data is provided, the method including: generating, using a processor, a data encryption key using a biological sample of a subject, wherein the data encryption key is obtained by (i) obtaining the biological sample of the subject, and (ii) generating a static signature from the biological sample and a dynamic signature from the biological sample; and encrypting data provided by the subject with the data encryption key.

In another embodiment, a system for creating a data repository for records of individual subjects is provided, the system including: a sample collection unit configured to obtain a biological sample suspected to contain at least one nucleic acid molecule of a subject; a signature generator configured to generate a genetic signature from the at least one nucleic acid molecule, wherein the genetic signature is indicative of the identity of said subject; a processor configured to associate the genetic signature with at least one record of the subject; and one or more databases configured to store the genetic signature and the record.

In another embodiment, a system for verifying an identity of an individual is provided, the system including: a sample processing device configured to receive a biological sample from the individual; a memory unit configured to store a pre-collected genetic signature of the individual; a processor configured to compare a genetic signature of the individual with the pre-collected genetic signature; a sample collection unit configured to obtain a biological sample suspected to contain at least one nucleic acid molecule of a subject; a signature generator configured to generate a genetic signature from the at least one nucleic acid molecule, wherein the genetic signature is indicative of the identity of said subject; wherein, the genetic signature is obtained by analyzing a biological sample of the individual tendered at a point of service location, the point of service location includes a sample processing device configured to receive the biological sample from the individual and process the sample to yield said genetic signature, and a match between the genetic signature and said pre-collected genetic signature verifies the identity of the individual.

In another embodiment, a system for verifying the identity of an individual is provided herein, the system including: a memory unit configured to store a pre-collected genetic signature of the individual; and a processor configured to compare a genetic signature of the individual with the pre-collected genetic signature, wherein, the genetic signature is obtained by analyzing a biological sample of the individual, the amount of time between collecting the biological sample from the individual and completion of comparing the genetic signature with the pre-collected genetic signature is no more than twenty-four hours, and a match between the genetic signature and said pre-collected genetic signature verifies the identity of the individual.

In another embodiment, a system for associating a genetic signature of an individual with a medical record is provided, the system including: a memory unit configured to store a pre-collected genetic signature of the individual; and a processor configured to compare a genetic signature of the individual with the pre-collected genetic signature, wherein, the genetic signature is obtained by analyzing a biological sample of the individual, a match between the genetic signature and the pre-collected genetic signature verifies the identity of said individual, the pre-collected genetic signature has one or more medical record associated therewith, and verification of the identity of the individual permits the association of the genetic signature with the one or more medical record.

In some embodiments, a system for providing an individual with access to a secured location or device is provided, the system including: a memory unit configured to store a pre-collected genetic signature of the individual; and a processor configured to compare a genetic signature of said individual with said pre-collected genetic signature, wherein, the genetic signature is obtained by analyzing a biological sample of the individual, a match between the genetic signature and the pre-collected genetic signature verifies the identity of the individual, and the individual is provided with access to a secured location or device if the verified identity of the individual falls within a group of one or more identities permitted to access the secured location or device. The system may further include a sample collection unit configured to obtain a biological sample suspected to contain at least one nucleic acid molecule of a subject and a signature generator configured to generate a genetic signature from the at least one nucleic acid molecule, wherein the genetic signature is indicative of the identity of said subject.

In another embodiment, a system of verifying an identity of an individual is provided, the system including: one or more memory units configured to store a pre-collected genetic signature of said individual and a pre-collected proteomic signature; and a processor configured to compare a genetic signature of said individual with said pre-collected genetic signature, and a proteomic signature of said individual with a pre-collected proteomic signature of said individual, wherein said genetic signature and said proteomic signature is obtained by analyzing one or more biological samples of said individual tendered at a point of service location, and wherein a match between said genetic signature and said pre-collected genetic signature, and a degree of change between said proteomic signature and said pre-collected proteomic signature falling within an acceptable range, verifies the identity of said individual.

In another embodiment, a records aggregation system is provided, including: a first record system comprising a first memory unit that stores one or more individual records relating to one or more subjects, an individual record comprising a genetic signature of an individual subject that is associated with at least one type of personal information of said individual subject; a second record system comprising a second memory unit that stores one or more individual records relating to one or more subjects, an individual record comprising a genetic signature of an individual subject that is associated with at least one type of personal information of said individual subject; and a processor configured to compare the genetic signature of the first record system and the genetic signature of the second record system, wherein if the genetic signature of the first record system and the genetic signature of the second record systems are the same, the processor associates the records of the first and second records systems, thereby aggregating the plurality of records.

In another embodiment, a system for creating a data repository having unique identifiers for records of individual subjects is provided, the system including: a signature generator configured to generate a genetic signature from at least one nucleic acid molecule from an individual subject, wherein the genetic signature is indicative of the identity of the subject; a processor configured to associate the genetic signature with at least one record of the subject, wherein the genetic signature is a unique identifier of the subject; and one or more database configured to store the genetic signature and the record, wherein the genetic signature is an index for the record in the one or more database. The system may further include a sample collection unit configured to obtain a biological sample suspected to contain at least one nucleic acid molecule of a subject.

In another embodiment, a tangible computer readable media comprising machine-executable code for implementing a method of creating a data repository for medical records of individual subjects is provided, the method comprising: associating, using a processor, a genetic signature of a subject with at least one record of the subject, wherein the genetic signature is obtained by (i) obtaining a biological sample containing at least one nucleic acid molecule of the subject, and (ii) generating a genetic signature from said at least one nucleic acid molecule, wherein the genetic signature is indicative of the identity of said subject; and storing the genetic signature and the record within one or more database, to create a data repository for records of individual subjects.

In another embodiment, a tangible computer readable media comprising machine-executable code for implementing a method of verifying an identity of an individual is provided, the method including: comparing, with the aid of a processor, a genetic signature of the individual with a pre-collected genetic signature of said individual stored in a memory unit, wherein, the genetic signature is obtained by analyzing a biological sample of said individual tendered at a point of service location, the point of service location includes a sample processing device configured to receive the biological sample from said individual and process said sample to yield the genetic signature, and a match between the genetic signature and the pre-collected genetic signature verifies the identity of the individual.

In another embodiment, a tangible computer readable media comprising machine-executable code for implementing a method of verifying an identity of an individual is provided, the method including: comparing, with the aid of a processor, a genetic signature of the individual with a pre-collected genetic signature of said individual stored in a memory unit, wherein, the genetic signature is obtained by analyzing a biological sample of the individual, the amount of time between collecting the biological sample from the individual and completion of comparing the genetic signature with the pre-collected genetic signature is no more than twenty-four hours, and a match between the genetic signature and said pre-collected genetic signature verifies the identity of the individual.

In another embodiment, a tangible computer readable media comprising machine-executable code for implementing a method of verifying an identity of an individual is provided, the method including: comparing, with the aid of a processor, a genetic signature of the individual with a pre-collected genetic signature of said individual stored in a memory unit, wherein, the genetic signature is obtained by analyzing a biological sample of the individual tendered at a point of service location, a match between the genetic signature and the pre-collected genetic signature verifies the identity of said individual, the pre-collected genetic signature has one or more medical record associated therewith, and, verification of the identity of the individual permits the association of the genetic signature with said one or more medical record.

In another embodiment, a tangible computer readable media comprising machine-executable code for implementing a method of verifying an identity of an individual is provided, the method including: comparing, with the aid of a processor, a genetic signature of the individual with a pre-collected genetic signature of the individual stored in a memory unit, and a proteomic signature of the individual with a pre-collected proteomic signature of the individual stored in a memory unit, wherein, the genetic signature and the proteomic signature are obtained by analyzing one or more biological sample of the individual tendered at a point of service location, a match between the genetic signature and the pre-collected genetic signature, and a degree of change between said proteomic signature and the pre-collected proteomic signature falling within an acceptable range, verifies the identity of said individual.

In another embodiment, a tangible computer readable media comprising machine-executable code for implementing a method of aggregating a plurality of records is provided, including: providing a first record system comprising a first memory unit that stores one or more records relating to one or more subjects, an individual record comprising a genetic signature of an individual subject that is associated with at least one type of personal information of said individual subject; providing a second record system comprising a second memory unit that stores one or more records relating to one or more subjects, an individual record comprising a genetic signature of an individual subject that is associated with at least one type of personal information of said individual subject; and comparing, using a processor, the genetic signature of the first record system and the genetic signature of the second record system, wherein if the genetic signature of the first record system and the genetic signature of the second record systems are the same, associating the records of the first and second records systems, thereby aggregating the plurality of records.

In another embodiment, a tangible computer readable media comprising machine-executable code for implementing a method of creating a data repository having unique identifiers for records of individual subjects is provided, the method including: associating, using a processor, the genetic signature of a subject with at least one record of said subject, wherein the genetic signature is a unique identifier of said subject, and wherein the genetic signature is obtained by (i) obtaining a biological sample containing at least one nucleic acid molecule of the subject, and (ii) generating a genetic signature from the at least one nucleic acid molecule, wherein the genetic signature is indicative of the identity of said subject; storing the genetic signature and the record in one or more database; and using the genetic signature as an index providing access to the record in the one or more database.

In some embodiments, a record described above or elsewhere herein may be a medical or financial institution record. In some embodiments, a record described above or elsewhere herein may include one or more of the subject's name, date of birth, address, telephone number, email address, analyte levels, financial records, or payer records. In some embodiments, a record described above or elsewhere herein may include proteomic information of a subject.

In some embodiments, a biological sample described above or elsewhere herein may be obtained via a fingerstick, lancet, swab, or breath capture.

In some embodiments, a biological sample described above or elsewhere herein may contain at least one material selected from the group consisting of: blood, serum, saliva, urine, gastric fluid, tears, stool, semen, vaginal fluid, interstitial fluids derived from tumorous tissue, ocular fluids, sweat, mucus, earwax, oil, glandular secretions, hair, fingernail, skin, spinal fluid, plasma, nasal swab or nasopharyngeal wash, spinal fluid, cerebral spinal fluid, tissue, throat swab, breath, biopsy, placental fluid, amniotic fluid, cord blood, emphatic fluids, cavity fluids, sputum, pus, micropiota, meconium, breast milk, and any combination thereof.

In some embodiments, a biological sample described above or elsewhere herein, alone or in combination, may be obtained through a sample collection unit of a sample processing device.

In some embodiments, in a system, method, or tangible computer readable media described above or elsewhere herein involving the generation of a genetic signature, a sample processing device may generate the genetic signature.

In some embodiments, in a system, method, or tangible computer readable media described above or elsewhere herein involving the generation of a genetic signature, the genetic signature may be generated on an external device that is at a different location from the a sample processing device.

In some embodiments, in a system, method, or tangible computer readable media described above or elsewhere herein involving the collection of a biological sample, the biological sample may be obtained at a point of service location.

In some embodiments, in a system, method, or tangible computer readable media described above or elsewhere herein involving a sample processing device, the sample processing device may be located at a point of service location.

In some embodiments, in a system, method, or tangible computer readable media described above or elsewhere herein involving a genetic signature, the genetic signature may include a hash of a sequenced portion of the biological sample.

In some embodiments, in a system, method, or tangible computer readable media described above or elsewhere herein involving one or more database, the one or more database may have a cloud computing-based infrastructure.

In some embodiments, in a system, method, or tangible computer readable media described above or elsewhere herein involving one or more database, the one or more database may use a genetic signature as a unique identifier for at least one medical record.

In some embodiments, in a system, method, or tangible computer readable media described above or elsewhere herein involving one or more database, the one or more database may use a genetic signature as a unique identifier for at least one financial institution record.

In some embodiments, in a system, method, or tangible computer readable media described above or elsewhere herein involving a memory unit, the memory unit may have a cloud computing-based infrastructure.

In some embodiments, in a system, method, or tangible computer readable media described above or elsewhere herein involving a pre-collected genetic signature, the pre-collected genetic signature may be associated with at least one medical record of the individual.

In some embodiments, in a system, method, or tangible computer readable media described above or elsewhere herein involving a pre-collected genetic signature, the pre-collected genetic signature may be associated with at least one financial record of the individual.

In some embodiments, in a system, method, or tangible computer readable media described above or elsewhere herein involving verification of the identity of an individual, the identity of the individual is verified for receiving or providing one or more of the following: health care, banking, embassy, electronic commerce, private or public transportation services, building security, location access, or device access.

In some embodiments, in a system, method, or tangible computer readable media described above or elsewhere herein involving a sample processing device, the sample processing device may be configured to run one or more chemical reaction with the biological sample.

In some embodiments, in a system, method, or tangible computer readable media described above or elsewhere herein involving a sample processing device, the sample processing device may be configured to prepare a biological sample for a chemical reaction.

In some embodiments, in a system, method, or tangible computer readable media described above or elsewhere herein involving a sample processing device, the sample processing device may be configured to prepare a biological sample for a chemical reaction.

In some embodiments, in a system, method, or tangible computer readable media described above or elsewhere herein involving a sample processing device, the sample processing device may be configured to prepare a biological sample or run a chemical reaction with a coefficient of variation of 10% or less.

In some embodiments, in a system, method, or tangible computer readable media described above or elsewhere herein involving a medical record, the one or more medical record may be a laboratory test result.

In some embodiments, in a system, method, or tangible computer readable media described above or elsewhere herein involving a static signature, the static signature may be a genetic signature. A genetic signature may be generated from a nucleic acid molecule.

In some embodiments, in a system, method, or tangible computer readable media described above or elsewhere herein involving a dynamic signature, the dynamic signature may be a proteomic signature. A proteomic signature may be generated from the protein level of a biological sample.

In some embodiments, in a system, method, or tangible computer readable media described above or elsewhere herein involving personal information, the personal information may include one or more of an individual's name, date of birth, address, telephone number, email address, medical records, financial records, or payer records.

In some embodiments, in a system, method, or tangible computer readable media described above or elsewhere herein involving a data repository, the data repository may be used in a health care system or a banking system.

In some embodiments, in a system, method, or tangible computer readable media described above or elsewhere herein involving a data encryption key, the data encryption key is generated using one or more of: a genetic signature of the subject, a proteomic signature of the subject, or additional personal information about the subject. In some embodiments, additional person information includes one or more of the subject's name, password, or biometric data.

In some embodiments, in a system, method, or tangible computer readable media described above or elsewhere herein involving generating, using a processor, a data encryption key using a genetic signature of a subject, wherein the genetic signature is obtained by (i) obtaining a biological sample containing at least one nucleic acid molecule of the subject, and (ii) generating a genetic signature from the at least one nucleic acid molecule, the method further includes verifying that the steps fall within a set protocol for securely obtaining a biological sample.

In some embodiments, a system described above or elsewhere herein may include a device that is configured to perform nucleic acid amplification of a biological sample on the device and that contains a sample collection unit that is integral to the device.

In some embodiments, a system described above or elsewhere herein may include a device that is configured to perform nucleic acid amplification of a biological sample on the device and that may interface with a sample collection unit that is not integral to the device.

In some embodiments, a system or method described above or elsewhere herein may include a device that is configured to perform nucleic acid amplification of a biological sample on the device and which contains a sample collection unit and a signal generator, wherein the sample collection unit and the signal generator are part of the same device.

In some embodiments, a system described above or elsewhere herein may include a device that is configured to perform nucleic acid amplification of a biological sample on the device and which contains a sample collection unit and a signal generator, wherein the sample collection unit and the signal generator are not part of the same device.

In some embodiments, in a system, method, or tangible computer readable media described above or elsewhere herein involving a processor and a memory unit, the processor and the memory unit may be part of the same device.

In some embodiments, in a system, method, or tangible computer readable media described above or elsewhere herein involving a processor and a memory unit, the processor and the memory unit may not be part of the same device.

In some embodiments, in a system, method, or tangible computer readable media described above or elsewhere herein involving a memory unit, the memory unit may have a cloud computing-based infrastructure.

In some embodiments, in a system, method, or tangible computer readable media described above or elsewhere herein involving personal information, the personal information may include one or more of the subject's name, date of birth, address, telephone number, email address, analyte levels, financial records, or payer records.

In some embodiments, in a system, method, or tangible computer readable media described above or elsewhere herein involving a data repository, the data repository may be utilized in a health care system or in banking.

In some embodiments, in a system, method, or tangible computer readable media described above or elsewhere herein involving a sample processing device, the sample processing device comprises at least one of: a sample collection unit, a sample processing unit, a detection unit, or a transmission unit.

In some embodiments, in a system, method, or tangible computer readable media described above or elsewhere herein involving a sample processing device, the sample processing device comprises at least two of: a sample collection unit, a sample processing unit, a detection unit, or a transmission unit.

In some embodiments, in a system, method, or tangible computer readable media described above or elsewhere herein involving a sample processing device, the sample processing device comprises at least three of: a sample collection unit, a sample processing unit, a detection unit, or a transmission unit.

In some embodiments, in a system, method, or tangible computer readable media described above or elsewhere herein involving a sample processing device, the sample processing device comprises a sample collection unit, a sample processing unit, a detection unit, and a transmission unit.

In some embodiments, in a system, method, or tangible computer readable media described above or elsewhere herein involving processing a biological sample, the sample is processed in a sample processing device, the sample processing device comprising at least one of: a sample collection unit, a sample processing unit, a detection unit, or a transmission unit.

In some embodiments, in a system, method, or tangible computer readable media described above or elsewhere herein involving processing a biological sample, the sample is processed in a sample processing device, the sample processing device comprising at least two of: a sample collection unit, a sample processing unit, a detection unit, or a transmission unit.

In some embodiments, in a system, method, or tangible computer readable media described above or elsewhere herein involving processing a biological sample, the sample is processed in a sample processing device, the sample processing device comprising at least three of: a sample collection unit, a sample processing unit, a detection unit, or a transmission unit.

In some embodiments, in a system, method, or tangible computer readable media described above or elsewhere herein involving processing a biological sample, the sample is processed in a sample processing device, the sample processing device comprising a sample collection unit, a sample processing unit, a detection unit, and a transmission unit.

In some embodiments, in a system, method, or tangible computer readable media described above or elsewhere herein involving a sample processing unit, the sample processing unit comprises a nucleic acid amplification unit.

In some embodiments, in a system, method, or tangible computer readable media described above or elsewhere herein involving a sample processing device, the sample processing device comprising at least one of a sample collection unit, a sample processing unit, a detection unit, or a transmission unit, the units are enclosed in a housing.

In some embodiments, in a system, method, or tangible computer readable media described above or elsewhere herein involving a sample processing device, the sample processing device comprises a sample processing unit, wherein nucleic acid amplification is performed.

In some embodiments a system described above or elsewhere herein includes at least one of a detection unit and a transmission unit.

In some embodiments a system described above or elsewhere herein includes a detection unit and a transmission unit.

In some embodiments, in a system, method, or tangible computer readable media described above or elsewhere herein involving a sample processing device and a sample collection unit, the sample collection unit is integral to the sample processing device.

In some embodiments, in a system, method, or tangible computer readable media described above or elsewhere herein involving a sample processing device and a sample collection unit, the sample collection unit is not integral to the sample processing device.

In some embodiments, in a system, method, or tangible computer readable media described above or elsewhere herein involving a system, the system comprises a sample processing device, the sample processing device comprising at least one of: a sample collection unit, a sample processing unit, a detection unit, or a transmission unit.

In some embodiments, in a system, method, or tangible computer readable media described above or elsewhere herein involving a system, the system comprises a sample processing device, the sample processing device comprising at least two of: a sample collection unit, a sample processing unit, a detection unit, or a transmission unit.

In some embodiments, in a system, method, or tangible computer readable media described above or elsewhere herein involving a system, the system comprises a sample processing device, the sample processing device comprising at least three of: a sample collection unit, a sample processing unit, a detection unit, or a transmission unit.

In some embodiments, in a system, method, or tangible computer readable media described above or elsewhere herein involving a system, the system comprises a sample processing device, the sample processing device comprising a sample collection unit, a sample processing unit, a detection unit, and a transmission unit.

In some embodiments, a system, method, or tangible computer readable media described above or elsewhere herein may be used with multiple records and/or multiple subjects. In some embodiments, in a system, method, or tangible computer readable media described above or elsewhere herein involving method steps, the method steps may be repeated with multiple samples, records, and or subjects.

In some embodiments, a genetic signature may be stored in a database. Optionally in some embodiments, instead of the genetic signature, a genetic signature identifier representative of the genetic signature is stored in the database. Optionally, the genetic signature identifier is an abstraction of the genetic signature. Optionally, the genetic signature identifier is an abbreviation of the genetic signature. Optionally, the genetic signature identifier is only a portion of the genetic signature. Optionally, the genetic signature identifier is information that is unique and used to determine the actual genetic signature. Optionally, the genetic signature identifier is a pointer for locating the genetic signature, which may be located in the same or different database. Optionally, the genetic signature identifier is a locator for determining the user identity, which may be located in the same or different database.

In some embodiments, the genetic signature in the database can be used to confirm and/or link identification information between databases. By way of non-limiting example, one database having the genetic signature information can be deemed to be accurate. Once that status is given to information in that database, other database(s) may update any inaccurate information with accurate information form the confirmed database that has the genetic signature. In one embodiment, if a similar entry in another database matches information in the genetic signature database to a certain level, such as but not limited to about 90%, a linkage can be established. Once that linkage is established, the information such as birth date or other information can be propagated to the other databases as the correct information, in case both databases reference the same person, but each database contains different personal or other information about that person. In this manner, once a person has verified that their genetic signature user profile is correct, that information can be propagated to other databases to make the information in those other databases conform to that which the user has verified by genetic signature to be the correct information.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### INCORPORATION BY REFERENCE

All publications, patents, and patent applications mentioned in this specification are incorporated herein by reference to the same extent as if each individual publication, patent, or patent application was specifically and individually indicated to be incorporated herein by reference.

### BRIEF DESCRIPTION OF THE DRAWINGS

In the drawings,

FIG. 1 provides an example of a genetic signature generation system disclosed herein.

FIG. 2 provides an example of a sample processing device disclosed herein.

FIG. 3 provides an example of a record containing a genetic ID.

FIG. 4 shows an example of a method of generating a genetic signature.

FIG. 5 shows an example of an identifier, having a plurality of components.

FIG. 6 provides an example of data which may utilize a genetic signature to assist with tracking information about a subject.

FIG. 7 provides an illustration of an example master system capable of accessing a plurality of subsystems.

FIG. 8 shows an example of a system for authenticating one or more subject.

FIG. 9 shows an example of an amplification unit in an open position.

FIG. 10 shows an example of an amplification unit in a closed position.

FIG. 11 shows a cross-section of an example of a temperature control unit, vials, and light source.

FIG. 12A shows a side lengthwise view of example assay vials.

FIG. 12B shows a side end view of example assay vials.

FIG. 12C provides a perspective view of example assay vials.

FIG. 12D shows a top view of example assay vials.

FIG. 13 shows a side view of an example assay strip.

FIG. 14A shows a side view of an example assay strip.

FIG. 14B shows a top view of an example assay strip.

FIG. 14C provides a perspective view of an example assay strip.

FIG. 15A shows a side view of an example of an assay tip.

FIG. 15B shows a perspective view of an example of an assay tip.

FIG. 16 shows an example nucleic acid extraction process.

### DETAILED DESCRIPTION

Provided herein are systems and methods of generating and using genetic signatures of subjects. Various features described herein may be applied to any of the particular applications set forth below or for any other types of identification and/or authentication systems. Systems and methods described herein may be applied as a standalone system or method, or as part of an integrated system, such as in a system accessing medical records, financial records, or providing access to a location, device, and/or information. It shall be understood that different aspects of the disclosed systems and methods can be appreciated individually, collectively, or in combination with each other.

Genetic Signature System

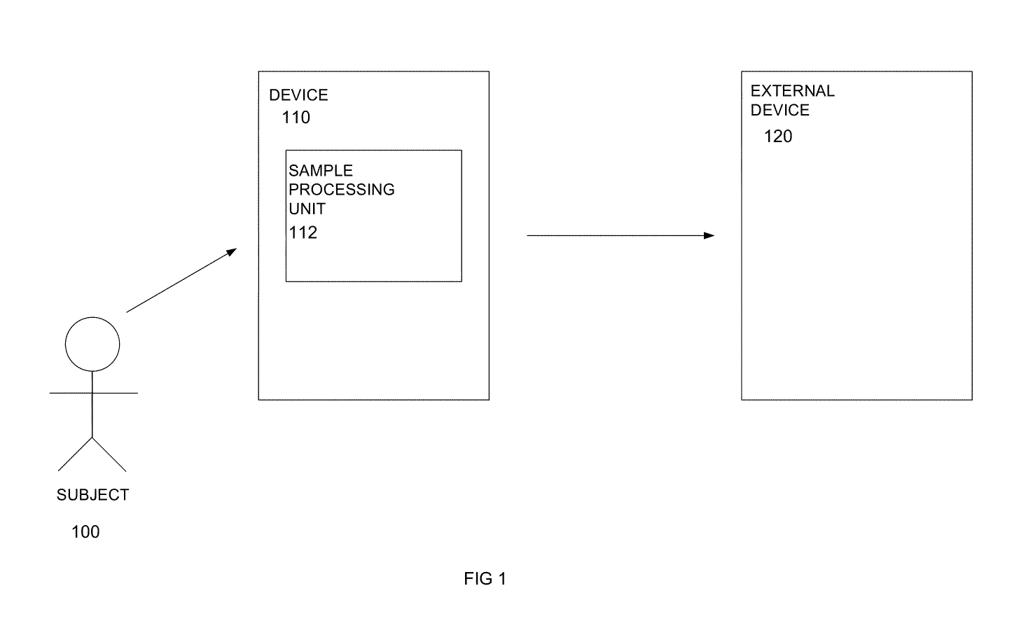

FIG. 1 provides an example of a genetic signature generation system. A sample collected from a subject 100 may be received by a device 110. The device may include one or more sample processing unit 112. The device may be capable of communicating with an external device 120.

A genetic signature of the subject 100 may be generated based on the sample received by the device. One or more sample processing units of the device may perform one or more steps that may generate data useful for the generation of the genetic signature. The data and/or genetic signature may be transmitted to the external device. The genetic signature may be generated on-board the device or may be generated external to the device, such as at an external device.

A subject may provide a sample, and/or the sample may be collected from a subject. A subject may be a human or animal. The subject may be living or dead. The subject may be a patient, clinical subject, or pre-clinical subject. A subject may be undergoing diagnosis, treatment, monitoring, and/or disease prevention. The subject may or may not be under the care of a health care professional, such as a physician (e.g., prescribing physician or non-prescribing physician), pathologist, pharmacist, nurse, or technician. The subject may be a person of any age, an infant, a toddler, an adult or an elderly.

A sample may be received by the device 110. Examples of samples may include various fluid samples. In some instances, the sample may be a bodily fluid sample from the subject. The sample may be an aqueous or gaseous sample. The sample may be a gel. The sample may include one or more fluid component. In some instances, solid or semi-solid samples may be provided. The sample may include tissue collected from the subject. The sample may be a biological sample. The biological sample may be a bodily fluid, a secretion, and/or a tissue sample. Examples of biological samples may include but are not limited to, blood, serum, saliva, urine, gastric fluid, tears, stool, semen, vaginal fluid, interstitial fluids, tumorous tissue, pathophysiologic tissue, normal tissue, ocular fluids, sweat, mucus, earwax, oil, glandular secretions, lymphoid fluid or tissue, hair, fingernail, bone, tooth, skin, spinal fluid, plasma, nasal swab or nasopharyngeal wash, cerebral spinal fluid, tissue, throat swab, cheek swab, breath, biopsy, placental fluid, amniotic fluid, cord blood, emphatic fluids, cavity fluids, synovial fluid, sputum, pus, micropiota, meconium, breast milk and/or other excretions. The sample may be provided from a human or animal. The sample may be collected from a living or dead subject.

The sample may comprise or may be suspected to contain at least one nucleic acid molecule. The sample may include DNA, RNA and/or any other genetic information of subject.

The sample may be collected fresh from a subject or may have undergone some form of pre-processing, storage, and/or transport. The sample may be provided to a device from a subject without undergoing intervention or much time. The subject may contact the device to provide the sample. The subject may be at the same location as the device when the sample is collected from the subject. Alternatively, the subject may be at a different location from the device when the sample is collected from the subject. The subject may or may not be present when the device receives the sample. Systems and methods may be provided which include a secure chain of custody for the sample between the collection of the sample from the subject and the receiving of the sample by the device.

A sample may be collected from the subject by puncturing the skin of the subject, or without puncturing the skin of the subject. A sample may be collected through an orifice of the subject. A tissue sample may be collected from the subject, whether it is an internal or external tissue sample. A sample may be removed from the subject or may have been cast off by the subject. The sample may be collected from any portion of the subject including, but not limited to, the subject's finger, hand, arm, shoulder, torso, abdomen, leg, foot, neck, or head. A sample may be obtained by swabbing mucosal surfaces such as are found inside the mouth.

One type of sample may be accepted and/or processed by the device. Alternatively, multiple types of samples may be accepted and/or processed by the device. For example, the device may be capable of accepting one or more, two or more, three or more, four or more, five or more, six or more, seven or more, eight or more, nine or more, ten or more, twelve or more, fifteen or more, twenty or more, thirty or more, fifty or more, or one hundred or more types of samples. The device may be capable of accepting and/or processing any of these numbers of sample types simultaneously and/or at different times. For example, the device may be capable of preparing, assaying and/or detecting one or multiple types of samples.

Any volume of sample may be provided from the subject or from another source. Examples of volumes may include, but are not limited to, about 10 mL or less, 5 mL or less, 3 mL or less, 1 μL or less, 500 μL or less, 300 μL or less, 250 μL or less, 200 μL or less, 170 μL or less, 150 μL or less, 125 μL or less, 100 μL or less, 75 μL or less, 50 μL or less, 25 μL or less, 20 μL or less, 15 μL or less, 10 μL or less, 5 μL or less, 3 μL or less, 1 μL or less, 500 nL or less, 250 nL or less, 100 nL or less, 50 nL or less, 20 nL or less, 10 nL or less, 5 nL or less, 1 nL or less, 500 pL or less, 100 pL or less, 50 pL or less, or 1 pL or less. The amount of sample may be about a drop of a sample. The amount of sample may be about 1-5 drops of sample, 1-3 drops of sample, 1-2 drops of sample, or less than a drop of sample. The amount of sample may be the amount collected from a pricked finger or fingerstick. The sample may be a single cell or cluster of cells. Any volume, including those described herein, may be provided to the device.

The sample processing device may be of any size or format, including a bench top device, handheld device, wearable device, patch, or ingestible device (e.g., pill).

The sample processing device 110 may be located at a point of service location. Point of service locations may include locations where a subject may receive a service (e.g. testing, monitoring, treatment, diagnosis, guidance, sample collection, ID verification, medical services, non-medical services, etc.), and may include, without limitation, a subject's home, a subject's business, the location of a healthcare provider (e.g., doctor), hospitals, emergency rooms, operating rooms, clinics, health care professionals' offices, laboratories, retailers [e.g. pharmacies (e.g., retail pharmacy, clinical pharmacy, hospital pharmacy), drugstores, supermarkets, grocers, etc.], transportation vehicles (e.g. car, boat, truck, bus, airplane, motorcycle, ambulance, mobile unit, fire engine/truck, emergency vehicle, law enforcement vehicle, police car, or other vehicle configured to transport a subject from one point to another, etc.), traveling medical care units, mobile units, schools, day-care centers, security screening locations, combat locations, health assisted living residences, government offices, office buildings, tents, bodily fluid sample acquisition sites (e.g. blood collection centers), sites at or near an entrance to a location that a subject may wish to access, sites on or near a device that a subject may wish to access (e.g., the location of a computer if the subject wishes to access the computer), a location where a sample processing device receives a sample, or any other point of service location described elsewhere herein.

A sample processing device may be moved to a point of service location or within a point of service location. The device may be moved by human intervention or may move independently without requiring human intervention. The device may be moved by being carried, may move robotically, via remote control, and/or autonomously. The device may be self-mobilized or may be attached to another vehicle or machine. The device may move via land, air, water, or any combination thereof.

In one example, the sample processing device may be provided on an ambulance or other vehicle. The device may be utilized to collect a sample from a subject and/or perform sample processing on a sample in the ambulance or other vehicle. The device may collect a sample from a subject and/or perform sample processing on a sample at a location that the device has been brought to via ambulance or other vehicle. The device may generate or assist with the generation of a genetic signature of the subject in the ambulance or other vehicle, or at a location that the device has been brought to via ambulance or other vehicle. In addition to generating or assisting with the generation of a genetic signature, additional sample processing with the device may occur. For example, the device may measure an analyte level of an individual, a physiological or biometric parameter of an individual, or capture an image of the individual or a biological sample of the individual, in an ambulance or other vehicle, or at a location that the device has been brought to via ambulance or other vehicle. Such information may be associated with the genetic signature. Such information may form medical records for the individual.

A subject may or may not provide the sample at the location where the sample processing device is located. The subject may or may not be at the location where the sample processing device is located when the device receives the sample.

In some situations, a sample processing device is deployed at a location that is designated for use by a certifying or licensing entity (e.g., a government certifying entity). In an embodiment, a sample processing device may be used at a location and/or as part of an entity that is certified by a government agency to perform laboratory testing (e.g. CLIA certified or other certification authorizing test results to be used to make medical diagnostic or treatment decisions). In an embodiment, a sample processing device may be used as a registered medical device.

In some embodiments, a sample processing device may be deployed at a location outside of a central laboratory (e.g. at a school, home, field hospital, clinic, business, vehicle, etc.). In some embodiments, a sample processing device may be deployed at a location that has a primary purpose other than laboratory services (e.g. at a school, home, field hospital, clinic, business, vehicle, etc.). In some embodiments, the sample processing device may be deployed at a location that is not dedicated to processing samples received from multiple sample acquisition locations. In some embodiments, a sample processing device may be located less than about 1 kilometer, 500 meters, 400 meters, 300 meters, 200 meters, 100 meters, 75 meters, 50 meters, 25 meters, 10 meters, meters, 3 meters, 2 meters, or 1 meter from the location at which a sample is obtained from a subject. In some embodiments, a sample processing device may be located within the same room, building, or campus at which a sample is obtained from a subject. In some embodiments, a sample processing device may be on or in a subject. In some embodiments, a sample may be provided directly from a subject to a sample processing device. In some embodiments, a sample may be provided to a sample processing device within 48 hours, 36 hours, 24 hours, 12 hours, 8 hours, 6 hours, 4 hours, 3 hours, 2 hours, 1 hour, 45 minutes, 30 minutes, 15 minutes, 10 minutes, 5 minutes, 1 minute, or 30 seconds of collection of the sample from a subject.

In some embodiments, a sample processing device may be portable. In some embodiments, a sample processing device may have a total volume of less than about 4 m³, 3 m³, 2 m³, 1 m³, 0.5 m³, 0.4 m³, 0.3 m³, 0.2 m³, 0.1 m³, 1 cm³, 0.5 cm³, 0.2 cm³, or 0.1 cm³. In some embodiments, a sample processing device may have a mass of than about 1000 kg, 900 kg, 800 kg, 700 kg, 600 kg, 500 kg, 400 kg, 300 kg, 200 kg, 100 kg, 75 kg, 50 kg, 25 kg, 10 kg, 5 kg, 2 kg, 1 kg, 0.5 kg, 0.1 kg, 25 g, 10 g, 5 g, or 1 g. In some embodiments, a sample processing device may be configured for ambulatory sample processing.

The device may monitor its locations and surroundings. In some instances, the device may use machine vision for navigation and identification of objects in its surroundings. The device may utilize cameras or any other type of sensors described herein in monitoring its surroundings. The device may utilize the sensed information in order to determine how it moves.

A device may comprise a sample collection unit. The sample collection unit may be configured to receive a sample from a subject. The sample collection unit may be configured to receive the sample directly from the subject or may be configured to receive a sample indirectly, that has been collected from the subject. A subject may provide a sample at the location of the device, or at a different location. The subject may or may not be at the location of the device when the device receives the sample.

One or more collection mechanisms may be utilized in the collection of a sample from a subject. A collection mechanism may utilize one or more principle in collecting the sample. For example, a sample collection mechanism may utilize gravity, capillary action, surface tension, electrical forces, aspiration, vacuum force, pressure differential, density differential, thermal differential, or any other mechanism in collecting the sample.

A bodily fluid may be drawn from a subject and provided to a device in a variety of ways, including but not limited to, fingerstick, lancing, injection, pumping, swabbing, pipetting, venous draw, venapuncture, and/or any other technique described elsewhere herein. In some embodiments, the sample may be collected from the subject's breath. The bodily fluid may be provided using a bodily fluid collector. A bodily fluid collector may include a lancet, capillary, tube, pipette, syringe, needle, microneedle, pump, or any other collector described elsewhere herein. In some embodiments, the sample may be a tissue sample which may be provided from the subject. The sample may be removed from the subject or may have been cast off by the subject.

In one embodiment, a lancet punctures the skin of a subject and withdraws a sample using, for example, gravity, capillary action, aspiration, pressure differential or vacuum force. The lancet, or any other bodily fluid collector, may be part of the device, part of a cartridge of the device, part of a system, or a standalone component. Where needed, the lancet or any other bodily fluid collector may be activated by a variety of mechanical, electrical, electromechanical, or any other known activation mechanism or any combination of such methods.

In one example, a subject's finger (or other portion of the subject's body) may be punctured to yield a bodily fluid. The bodily fluid may be collected using a capillary tube, pipette, swab, drop, or any other mechanism known in the art. The capillary tube or pipette may be separate from the device and/or a cartridge of the device that may be inserted within or attached to a device, or may be a part of a device and/or cartridge. In another embodiment where no active mechanism is required, a subject can simply provide a bodily fluid to the device and/or cartridge, as for example, with a saliva sample.

A bodily fluid may be drawn from a subject and provided to a device in a variety of ways, including but not limited to, fingerstick, lancing, injection, and/or pipetting. The bodily fluid may be collected using venous or non-venous methods. The bodily fluid may be provided using a bodily fluid collector. A bodily fluid collector may include a lancet, capillary, tube, pipette, syringe, venous draw, or any other collector described elsewhere herein. In one embodiment, a lancet punctures the skin and withdraws a sample using, for example, gravity, capillary action, aspiration, or vacuum force. The lancet may be part of the device, part of the cartridge of the device, part of a system, or a standalone component. Where needed, the lancet may be activated by a variety of mechanical, electrical, electromechanical, or any other known activation mechanism or any combination of such methods. In one example, a subject's finger (or other portion of the subject's body) may be punctured to yield a bodily fluid. Examples of other portions of the subject's body may include, but are not limited to, the subject's hand, wrist, arm, torso, leg, foot, or neck. The bodily fluid may be collected using a capillary tube, pipette, or any other mechanism known in the art. The capillary tube or pipette may be separate from the device and/or cartridge, or may be a part of a device and/or cartridge. In another embodiment where no active mechanism is required, a subject can simply provide a bodily fluid to the device and/or cartridge, as for example, could occur with a saliva sample. The collected fluid can be placed within the device. A bodily fluid collector may be attached to the device, removably attachable to the device, or may be provided separately from the device.

The collected sample can be placed within the device. In some instances, the collected sample is placed within a cartridge of the device. The collected sample can be placed in any other region of the device. The device may be configured to receive the sample, whether it be directly from a subject, from a bodily fluid collector, or from any other mechanism. A sample collection unit of the device may be configured to receive the sample.

A bodily fluid collector may be attached to the device, removably attachable to the device, or may be provided separately from the device. In some instances, the bodily fluid collector is integral to the device. The bodily fluid collector can be attached to or removably attached to any portion of the device. The bodily fluid collector may be in fluid communication with, or brought into fluid communication with a sample collection unit of the device.

A cartridge may be inserted into the sample processing device or otherwise interfaced with the device. The cartridge may be attached to the device. The cartridge may be removed from the device. In one example, a sample may be provided to a sample collection unit of the cartridge. The sample may or may not be provided to the sample collection unit via a bodily fluid collector. A bodily fluid collector may be attached to the cartridge, removably attachable to the cartridge, or may be provided separately from the cartridge. The bodily fluid collector may or may not be integral to the sample collection unit. The cartridge may then be inserted into the device. Alternatively, the sample may be provided directly to the device, which may or may not utilize the cartridge. The cartridge may comprise one or more reagents, which may be used in the operation of the device. The reagents may be self-contained within the cartridge. Reagents may be provided to a device through a cartridge without requiring reagents to be pumped into the device through tubes and/or tanks of buffer. Alternatively, one or more reagents may already be provided onboard the device.

A bodily fluid collector or any other collection mechanism can be disposable. For example, a bodily fluid collector can be used once and disposed. A bodily fluid collector can have one or more disposable components. Alternatively, a bodily fluid collector can be reusable. The bodily fluid collector can be reused any number of times. In some instances, the bodily fluid collector can include both reusable and disposable components.

A sample collection unit and/or any other portion of the device may be capable of receiving a single type of sample, or multiple types of samples. For example, the sample collection unit may be capable of receiving two different types of bodily fluids (e.g., blood, tears). In another example, the sample collection unit may be capable of receiving two different types of biological samples (e.g., urine sample, stool sample). Multiple types of samples may or may not be fluids, solids, and/or semi-solids. For example, the sample collection unit may be capable of accepting one or more of, two or more of, or three or more of a bodily fluid, secretion and/or tissue sample.

A device 110 may be capable of receiving a single type of sample, or multiple types of samples. The device may be capable of processing the single type of sample or multiple types of samples. In some instances, a single bodily fluid collector may be utilized. Alternatively, multiple and/or different bodily fluid collectors may be utilized.

The device may have a communication unit that may be capable of transmitting the information stored within the device. The communication unit may also receive a query for information from the device. The device may be capable of two-way communication with one or more external device. The external device may provide instructions to the device and/or have additional information stored about the subject or back-end support. The external device may have one or more medical records, or other records stored thereon. Alternatively, the medical records, or other records may be stored on the device.

In some examples, a device may be an ingestible device such as a pill, an implantable device such as a subcutaneous device, or a wearable device such as a patch. The device may be configured to obtain a sample and perform one or more sample processing step on the sample. For example the device may be configured to perform an assay and/or analysis. The sample collection, sample processing and/or analysis step may be performed on a periodic basis. The periodic basis may be at regular or irregular time intervals. The device may receive instructions for sample collection, sample processing and/or analysis step may be performed on a periodic basis. Alternatively, the device may perform sample collection, sample processing and/or analysis steps and/or receive instructions and/or be programmed to perform sample collection, sample processing and/or analysis steps on a non-periodic basis.

If the device is in contact with the subject, such as through an ingestible, implantable, and/or wearable form, the device may be able to continuously, periodically, and/or non-periodically obtain the sample from the subject and perform any subsequent processing and/or analysis.

The device may be capable of storing information related to the subject. For example, the device may be an ingestible device such as a pill, an implantable device such as a subcutaneous device, or a wearable device such as a patch, article of clothing, or accessory (e.g., bracelet, watch), that may store information about the subject that has ingested it, into whom it is implanted, or that is wearing the device. Such information may include information that has been collected by the device. For example, such information may include a genetic signature of the subject, and information pertaining to one or more analysis of the subject. Such information may also include additional information pertaining to the subject's identity, such as the subject's name, address, contact information, date of birth, social security number, insurance policy number or any other identifying information. The information may also include the subject's medical records, financial records, legal identity records, security information, access information, or any other type of information discussed elsewhere herein. Alternatively, the information within the device may be used to access information about the subject that may be stored off board, such as the subject's medical records, financial records, legal identity records, security information, access information, or any other type of information discussed elsewhere herein.

In an example, a device that may have been implanted subcutaneously may be scanned. The information on the device, such as the subject's identity, genetic signature, and/or other information associated with the subject may be read. In some instances, the device may be broadcasting the information. In other instances, the device may send the information in response to a query. The device may send all information, or may send information only specific to the query.

The information may be useful to gather information about the subject. For example, a subject may be unconscious. A device on or in the subject may be scanned to collect information about the subject. As previously mentioned, such information may include information about the subject's identity, records associated with the subject, and/or information about subject based on a sample collected from the subject (e.g., latest analyte levels).

The device may be capable of releasing a therapeutic agent. For example, the device may have one or more drug reservoir that may store a therapeutic agent therein. In response to one or more command from within the device, or generated off-board the device, the device may release one or more therapeutic agent. The device may have one or more communication unit that may be capable of receiving instructions from an external device. The instructions may or may not be associated with the subject's genetic signature. In some instances, the therapeutic agent may be released only if the subject's genetic signature matches the genetic signature associated with the instructions.

The amount, timing, and/or rate of therapeutic agent released may be controlled. In some instances the device may contain a plurality of therapeutic agents. One or more desired therapeutic agents may be selected and may be released in a controlled manner. For example, an ingestible device may be within a subject's gastrointestinal tract and may release one or more therapeutic agent at one or more desired point in time. A subcutaneous device may release one or more therapeutic agent. In some instances, the therapeutic agent may be released on a periodic basis, or at any point in time. Similarly, a wearable device, such as a patch, may release one or more therapeutic agent in accordance with a release profile. The release profile may include information about which therapeutic agents to release, the amount of therapeutic agent to release, the timing of the release (which may be one-time or multiple times), and/or the rate of release (which may be constant or may vary). Such a release profile may be predetermined or generated in real time.

In some instances, a release profile and/or instructions relating to release of therapeutic information may be generated based on information about a sample collected from the subject. For example, the same device may collect the sample and/or release the therapeutic agent. Alternatively, different devices may be used to collect the sample and/or release the therapeutic agent.

The device may process the biological sample and deliver all or part of the processed material back into the patient. The biological sample may be stored in the device before processing. The processed material may be stored before delivering into the patient. The timing of collection, processing, and delivery of the processed material into the patient may be predetermined and/or generated based on information about a sample collected from the subject and/or other information stored about the subject or collected from an external device. The sample processing steps may be may be predetermined and/or generated based on information about a sample collected from the subject and/or other information stored about the subject or collected from an external device. The amount of processed material delivered to the patient may be may be predetermined and/or generated based on information about a sample collected from the subject and/or other information stored about the subject or collected from an external device.

The device may be controlled and/or activated by voice commands and may use voice recognition algorithms.

One or more device may be acquiring data from a single subject at a time. For example, a plurality of devices may simultaneously collect data about a single subject. The plurality of devices may substantially simultaneously collect a sample from the subject, process the sample (e.g., perform a preparation and/or assay step), and/or analyze the sample. In one example, a plurality of patches may be worn by the subject simultaneously. Any combination of the devices described herein may be used simultaneously for a single subject (e.g., a subject may wear one or more patches while having swallowed an ingestible device and/or providing a sample to a bench-top device).

The device may be loaded or preloaded with information, such as reference genomic sequence data, to be used for subsequent subject identification. The assay results in said device may be analyzed and compared to data stored on said device (and/or external to the device). The assay results may be analyzed to determine the identification of an individual. If more than one device is being used simultaneously for the testing of single subject, the devices may communicate with one another and/or transmit data/results. For example, the devices may communicate directly with one another (e.g., multiple patches communicating with one another). The devices may communicate with an intermediary device or an external device that may optionally communicate with others of the devices (e.g., multiple patches communicating with a base station).

When periodic sampling is conducted, fewer sequences may be assayed at a given time to confirm a subject's identification than if periodic sampling is not conducted. Similarly, if two or more devices are collecting samples from the same subject simultaneously, fewer sequences may be assayed to confirm the subject's identification than if a single device is being used. This may reduce the testing time. The genomic sequences assayed to confirm the subject identification may be chosen at random or per an algorithm. If two or more devices are performing analysis at the same time, they may analyze different or the same genomic sequences. Similarly, if a single device is performing analysis on the same subject at different points in time, the device may analyze different or the same genomic sequences at those points in time. Any combination of single or multiple devices, and/or collecting/processing/analyzing samples at a single point in time or multiple points in time may be utilized.

For example, if a single device is accepting a sample from a subject one time, the device may analyze or provide data that may be used to analyze 13 genomic sequences. If two devices are accepting the sample from the subject, the devices may analyze or provide data that may be used to analyze less than 13 genomic sequences (e.g., 7 genomic sequences each). These may be different and/or the same genomic sequences. If three devices are accepting the sample from the subject, the devices may analyze or provide data that may be used to analyze less than 13 genomic sequences (e.g., 5 genomic sequences each), which may be the same or different from one another. If a single device accepts the sample from the subject multiple times (e.g., twice), the device may analyze less than 13 genomic sequences each time (e.g., 7 genomic sequences each time), which may be the same or different from one another.

In one example if a single device is accepting a sample from a subject one time, the device analyzes or provides data that may be used to analyze n genomic sequences, where ‘n’ is a whole number greater than 1 (e.g., n=2, 3, 4, 5, 6, 7, 8, 9, 10, 11, 12, 13, 14, 15, 16, 17, 18, 19, or 20). In some instances, n may be a whole number sufficiently high to yield the statistical likelihood that an individual with n analyzed genomic sequences can be identified from a selected population pool. The population pool may vary based on situation. For example, if the population pool is the whole world, it may be about 7 billion people. If the population pool is individuals staying at a hotel, it may be several hundred people. If m number of devices is accepting the sample from the subject simultaneously, the devices may analyze or provide data that may be used to analyze less than n genomic sequences. For example, the devices may analyze or provide data that may be used to analyze (n/m) sequences rounded up (e.g., if n=13, and m=2, n/m rounded up=7; if n=13, and m=3, n/m rounded up=5; if n=13, and m=4, n/m rounded up=4). Similarly, if a device accepts a sample from a subject p number of times, the device may analyze or provide data that may be used to analyze less than n genomic sequences. For example, the devices may analyze or provide data that may be used to analyze (n/p) sequences rounded up (e.g., if n=13, and p=2, n/p rounded up=7; if n=13, and p=3, n/p rounded up=5; if n=13, and p=4, n/p rounded up=4). If a combination is used of multiple devices and/or multiple sample collection times, such combinations may be taken into account to further reduce the number of genomic sequences being analyzed. For example, the devices may analyze or provide data that may be used to analyze (n/(m×p)) sequences rounded up (e.g., if n=13, and there are m devices, and they each sample twice from the subject p=2, (n/(m×p)) rounded up=4). Such illustrations are provided by way of example only. Any calculation or algorithm or random selection may be performed to determine the number of sequences to use and/or which sequences to use.

The resulting subject identification and/or additional assay data may be transmitted from the device over a secure communication channel, wired or wirelessly. The data may be transmitted in an encrypted manner. The transmitted data may be received at another device (whether it be the same type of device, different type of device, external device) having the appropriate security permissions. The transmitted data may be decrypted by another device having the appropriate security permissions.

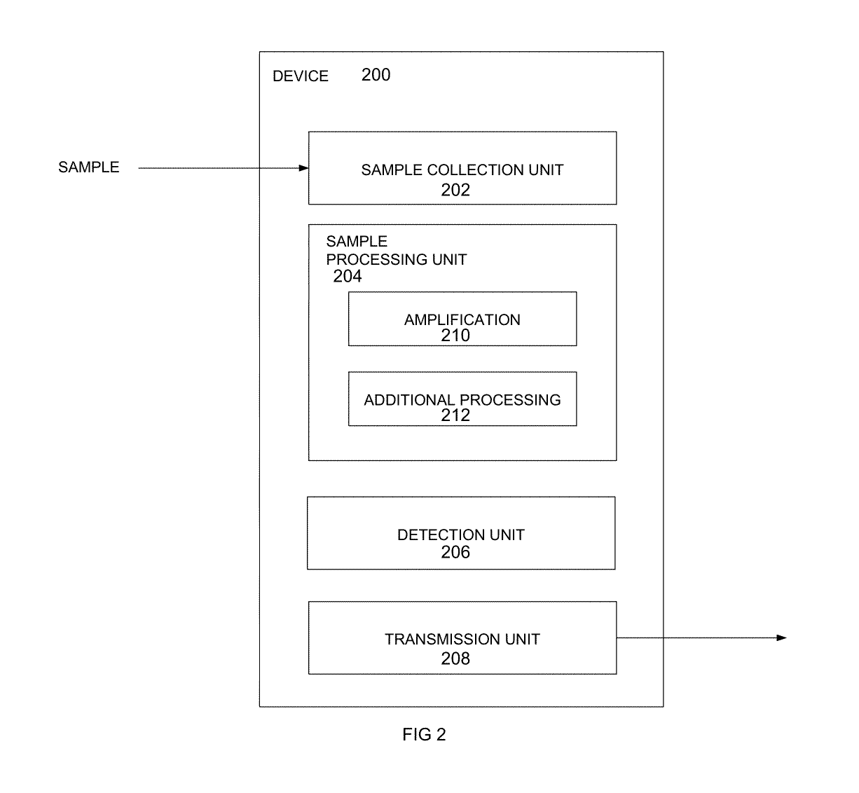

FIG. 2 provides an example of a sample processing device 200 disclosed herein. The sample processing device may comprise a sample collection unit 202, a sample processing unit 204, a detection unit 206, and/or a transmission unit 208. The sample processing unit may have one or more unit useful for nucleic acid amplification 210 and/or one or more unit useful for additional processing steps 212. The device may have a housing that may support and/or enclose one or more of the units.

Additional components of the device may include, without limitation, a centrifuge, magnetic separator, filter, pipette or other fluid handling system, vessels, containers, assay units, reagent units, heater, thermal block, cytometer, light source, optical sensor, photometer, temperature sensor, motion sensor, or sensor for electrical properties. Fluid may be transferred from one component to another via a fluid handling system, such as a pipette, channels, or pumps.

The device may be configured to receive a sample. A sample collection unit 202 of the device may receive the sample. The sample collection unit may have one or more of the features described elsewhere herein.

A sample collection unit may be integral to the device. The sample collection unit may be separate from the device. In some embodiments, the sample collection unit may be removable and/or insertable from the device. The sample collection unit may or may not be provided in a cartridge. A cartridge may or may not be removable from and/or insertable into the device.

A sample collection unit may be configured to receive a sample. The sample collection unit may be capable of containing and/or confining the sample. The sample collection unit may be capable of conveying the sample to another portion of the device.

The sample collection unit may be in fluid communication with one or more sample processing units of a device. In some instances, the sample collection unit may be in permanent fluid communication with one or more sample processing unit of the device. Alternatively, the sample collection unit may be brought into and/or out of fluid communication with a sample processing unit. The sample collection unit may or may not be selectively fluidically isolated from one or more sample processing unit. In some instances, the sample collection unit may be in fluid communication with each of the sample processing units of the device. The sample collection unit may be in permanent fluid communication with each of the sample processing units, or may be brought into and/or out of fluid communication with each sample processing unit.

A sample collection unit may be selectively brought into and/or out of fluid communication with one or more sample processing unit. The fluid communication may be controlled in accordance with one or more protocol or set of instructions. A sample collection unit may be brought into fluid communication with a first sample processing unit and out of fluid communication with a second sample processing unit, and vice versa.

One or more mechanisms may be provided for transferring a sample from the sample collection unit to a preparation and/or reaction site. In some embodiments, flow-through mechanisms may be used. For example, a channel or conduit may connect a sample collection unit with a preparation and/or reaction site of a sample processing unit. The channel or conduit may or may not have one or more valves or mechanisms that may selectively permit or obstruct the flow of fluid.

Another mechanism that may be used to transfer a sample from a sample collection unit to a sample processing unit may utilize one or more fluidically isolated component. The fluid may be transferred via a hydraulically disconnected mechanism. The fluidically isolated component may be movable relative to other components of the device. For example, a sample collection unit may provide the sample to one or more tip or vessel that may be movable within the device. The one or more tip or vessel may be transferred to one or more module. In some embodiments, the one or more tip or vessel may be shuttled to one or more sample processing unit via a pipettor, robotic arm or other component of the device. In some embodiments, the tip or vessel may be received at a sample processing unit. In some embodiments, a fluid handling mechanism at the sample processing unit may handle the tip or vessel. For example, a pipettor may pick up and/or aspirate a sample provided to the sample processing unit.

A device may be configured to accept a single sample, or may be configured to accept multiple samples. In some instances, the multiple samples may or may not be multiple types of samples. For example, in some instances a single device may handle a single sample at a time. For example, a device may receive a single sample, and may perform one or more sample processing step, such as a sample preparation step, assay step, and/or detection step with the sample. The device may complete processing a sample, before being able to accept a new sample.

In another example, a device may be capable of handling multiple samples simultaneously. In one example, the device may receive multiple samples simultaneously. The multiple samples may or may not be multiple types of samples. For example the device may be capable of accepting a bodily fluid, such as blood, and a tissue sample, such as skin cells.

Alternatively, the device may receive samples in sequence. Samples may be provided to the device one after another, or may be provided to device after any amount of time has passed. A device may be capable of beginning sample processing on a first sample, receiving a second sample during said sample processing, and process the second sample in parallel with the first sample. The first and second sample may or may not be the same type of sample. The device may be able to parallel process any number of samples, including but not limited to more than, less than, and/or equal to about one sample, two samples, three samples, four samples, five samples, six samples, seven samples, eight samples, nine samples, ten samples, eleven samples, twelve samples, thirteen samples, fourteen samples, fifteen samples, sixteen samples, seventeen samples, eighteen samples, nineteen samples, twenty samples, twenty-five samples, thirty samples, forty samples, fifty samples, seventy samples, one hundred samples.

A sample processing unit 204 of a device may be capable of processing a sample. Sample processing may include one or more of a sample preparation step or assay step. A sample processing unit may be a sample preparation station or an assay station. A sample preparation station may include one or more sample preparation component, such as a centrifuge, magnets for magnetic separation, a filter, a heater, or diluents.

One or more assay station may be provided to a sample processing device. The assay station may include one or more component configured to perform one or more of the following assays or steps: immunoassay, nucleic acid assay, nucleic acid amplification, receptor-based assay, cytometric assay, colorimetric assay, enzymatic assay, electrophoretic assay, electrochemical assay, spectroscopic assay, chromatographic assay, microscopic assay, topographic assay, calorimetric assay, turbidimetric assay, agglutination assay, radioisotope assay, viscometric assay, coagulation assay, clotting time assay, protein synthesis assay, histological assay, culture assay, osmolarity assay, and/or other types of assays or combinations thereof. Examples of such components may include, but are not limited to, a temperature control unit, thermal block, cytometer, energy source (e.g., x-ray, light source), assay units, reagent units, or supports.

An assay station may or may not be located separately from a preparation station. In some instances, an assay station may be integrated within the preparation station. Alternatively, they may be distinct stations, and a sample or other substance may be transmitted from one station to another.

Assay units may be provided, and may have one or more characteristics as described further elsewhere herein. Assay units may be capable of accepting and/or confining a sample. The assay units may be fluidically isolated from one another. In some embodiments, assay units may have a tip format. An assay tip may have an interior surface and an exterior surface. The assay tip may have a first open end and a second open end. In some embodiments, assay units may be provided as an array. Assay units may be movable. In some embodiments, individual assay units may be movable relative to one another and/or other components of the device. In some instances, one or a plurality of assay units may be moved simultaneously. In some embodiments, an assay unit may have a reagent or other reactant coated on a surface. Alternatively, assay units may contain beads or other surfaces with reagents or other reactants coated thereon. In another example, assay units may contain beads or other surfaces formed of reagents or other reactants that may dissolve.

Reagent units may be provided and may have one or more characteristics as described further elsewhere herein. Reagent units may be capable of accepting and/or confining a reagent or a sample. Reagent units may be fluidically isolated from one another. In some embodiments, reagent units may have a vessel format. A reagent vessel may have an interior surface and an exterior surface. The reagent unit may have an open end and a closed end. In some embodiments, the reagent units may be provided as an array. Reagent units may be movable. In some embodiments, individual reagent units may be movable relative to one another and/or other components of the device. In some instances, one or a plurality of reagent units may be moved simultaneously. A reagent unit can be configured to accept one or more assay unit. The reagent unit may have an interior region into which an assay unit can be at least partially inserted.

A support may be provided for the assay units and/or reagent units. In some embodiments, the support may have a cartridge format or a microcard format. One or more assay/reagent unit support may be provided within a module. The support may be shaped to hold one or more assay units and/or reagent units. The support may keep the assay units and/or reagent units aligned in a vertical orientation. The support may permit assay units and/or reagent units to be moved or movable. Assay units and/or reagent units may be removed from and/or placed on a support. The device and/or system may incorporate one or more characteristics, components, features, or steps provided in U.S. Patent Publication No. 2009/0088336 and/or U.S. patent application Ser. No. 13/244,947, which are hereby incorporated herein by reference in their entirety for all purposes.

A sample processing unit may be provided for amplification 210. The amplification unit may comprise one or more components useful for nucleic acid amplification. Such components may be useful for PCR or isothermal amplification methods.

An amplification unit may include one or more chamber, well, container, vessel, channel, tip, or any other configuration capable of containing and/or confining a sample. Examples of amplification units may be described in greater detail elsewhere herein. These sample holders may or may not be movable independently of one another. One or more sample holder may be in thermal communication with a temperature control unit. In some embodiments, all sample holders are in thermal communication with the same temperature control unit. Alternatively, one or more sample holders may be in thermal communication with a first temperature control unit and one or more other sample holders may be in thermal communication with a second temperature control unit. One or more sample holders may be in thermal communication with multiple temperature control units.

An amplification unit may also include one or more temperature control unit. For example, one or more temperature control unit may be provided within a device housing. A temperature control unit may be configured to heat and/or cool a sample or other fluid. Any discussion of controlling the temperature of a sample may also refer to any other fluid herein, including but not limited to reagents, diluents, dyes, or wash fluid. In some embodiments, separate temperature control unit components may be provided to heat and cool the sample. Alternatively, the same temperature control unit components may both heat and cool the sample.

The temperature control unit may be used to vary and/or maintain the temperature of a sample to keep the sample at a desired temperature or within a desired temperature range. In some embodiments, the temperature control unit may be capable of maintaining the sample within 1 degree C. of a target temperature. In other embodiments, the temperature control unit may be capable of maintaining the sample within 5 degrees C., 4 degrees C., 3 degrees C., 2 degrees C., 1.5 degrees C., 0.75 degrees C., 0.5 degrees C., 0.3 degrees C., 0.2 degrees C., 0.1 degrees C., 0.05 degrees C., or 0.01 degrees C. of the target temperature.

The target temperature may remain the same or may vary over time. In some embodiments, the target temperature may vary in a cyclic manner. The target temperature may vary in a manner that may be useful for PCR. In some embodiments, the target temperature may vary for a while and then remain the same. In some embodiments, the target temperature may follow a profile as known in the art for nucleic acid amplification. The temperature control unit may control the sample temperature to follow the profile known for nucleic acid amplification. In some embodiments, the temperature may be in the range of about 30-40 degrees Celsius. In some instances, the range of temperature is about 0-100 degrees Celsius. For example, for nucleic acid assays, temperatures up to 100 degrees Celsius can be achieved. In an embodiment, the temperature range is about 15-65 degrees Celsius. In some embodiments, the temperature may be used to incubate one or more samples.

The temperature control unit may be capable of varying the temperature of one or more samples quickly. For example, the temperature control unit may ramp the sample temperature up or down at a rate of more than, less than, and/or equal to 1 C/min, 5 C/min, 10 C/min, 15 C/min, 30 C/min, 45 C/min, 1 C/sec, 2 C/sec, 3 C/sec, 4 C/sec, 5 C/sec, 7 C/sec, or 10 C/sec.

A temperature control unit of the system can comprise a thermoelectric device. In some embodiments, the temperature control unit can be a heater. A heater may provide active heating. In some embodiments, voltage and/or current provided to the heater may be varied or maintained to provide a desired amount of heat. A temperature control unit may be a resistive heater. The heater may be a thermal block. A temperature control unit may employ evaporative and/or phase change cooling. The temperature control unit may utilize conduction, convection, radiation, and/or any combination thereof. In some instances, a temperature control unit may utilize a heat pipe and/or plate type set-up.

The heater may or may not have components that provide active cooling. In some embodiments, the heater may be in thermal communication with a heat sink. The heat sink may be passively cooled, and may permit heat to dissipate to the surrounding environment. Is some embodiments, the heat sink or the heater may be actively cooled, such as with forced fluid flow. The heat sink may or may not contain one or more surface feature such as fins, ridges, bumps, protrusions, grooves, channels, holes, plates, or any other feature that may increase the surface area of the heat sink. In some embodiments, one or more fan or pump may be utilized to provide forced fluid cooling.

In some embodiments, the temperature control unit can be a Peltier device or may incorporate a Peltier device.

The temperature control unit may optionally incorporate fluid flow to provide thermal control. For example, one or more heated fluid or cooled fluid may be provided to the temperature control unit. In some embodiments, heated and/or cooled fluid may be contained within the temperature control unit or may flow through the temperature control unit.

In some embodiments, a temperature control unit may utilize conduction, convection and/or radiation to provide heat to, or remove heat from a sample. In some embodiments, the temperature control unit may be in direct physical contact with a sample or sample holder. The temperature control unit may contact a conductive material that may be in direct physical contact with a sample or sample holder. In some embodiments, the temperature control unit may be formed of or include a material of high thermal conductivity. For example, the temperature control unit may include a metal such as copper, aluminum, silver, gold, steel, brass, iron, titanium, nickel or any combination or alloy thereof. For example, the temperature control unit can include a metal block. In some embodiments, the temperature control unit may include a plastic or ceramic material.

The temperature control unit may be configured to be in thermal communication with a sample of a small volume. For example, the temperature control unit may be configured to be in thermal communication with a sample with a volume as described elsewhere herein.

The temperature control unit may be in thermal communication with a plurality of samples. In some instances, the temperature control unit may keep each of the same samples at the same temperature relative to one another. In some instances, a temperature control unit may be thermally connected to a heat spreader which may evenly provide heat to the plurality of samples.

In other embodiments, the temperature control unit may provide different amounts of heat to the plurality of samples. For example, a first sample may be kept at a first target temperature, and a second sample may be kept at a second target temperature. The temperature control unit may form a temperature gradient. In some instances, separate temperature control units may keep different samples at different temperatures, or operating along separate target temperature profiles. A plurality of temperature control units may be independently operable.

One or more sensor may be provided at or near the temperature control unit. One or more sensor may be provided at or near a sample in thermal communication with the temperature control unit. In some embodiments, the sensor may be a temperature sensor. Any temperature sensor known in the art may be used including, but not limited to thermometers, thermocouples, or IR sensors. A sensor may provide one or more signal to a controller. Based on the signal, the controller may send a signal to the temperature control unit to modify (e.g., increase or decrease) or modify the temperature of the sample. In some embodiments, the controller may directly control the temperature control unit to modify or maintain the sample temperature. The controller may be separate from the temperature control unit or may be a part of the temperature control unit.

In some embodiments, the sensors may provide a signal to a controller on a periodic basis. In some embodiments, the sensors may provide real-time feedback to the controller. The controller may adjust the temperature control unit on a periodic basis or in real-time in response to the feedback.

An amplification unit may comprise one or more cover or other mechanism that may prevent sample from evaporating. In some embodiments, amplification components may also include an optically transmissive cover or path from which an optical sensor may detect one or more optical signal from the samples. In some embodiments, an optical sensor may be integrated with or within the sample holder. Further examples of amplification units are provided in greater detail below.

A sample processing device may comprise one or more additional processing units 212. Additional processing unit may be useful for preparation and/or assays of samples. Additional processing units may detect signals relating to the absence or presence of one or more analytes. Additional processing units may be useful for running a chemical reaction. Additional processing units may include one or more of the components described elsewhere herein. The additional processing units may also receive at least a portion of the sample that was received by the device. One or more amplification unit may receive another portion of the same sample received by the device. Alternatively, they may utilize different samples received by the device, which may or may not be different types of samples.

The device may be configured to run one or more chemical reactions with the sample. The device may be configured to prepare the sample for the one or more chemical reaction. The device may prepare the sample and/or run the chemical reaction with a coefficient of variation of about 0.01% or less, 0.1% or less, 0.5% or less, 1% or less, 1.5% or less, 2% or less, 3% or less, 4% or less, 5% or less, 6% or less, 7% or less, 8% or less, 9% or less, 10% or less, 11% or less, 12% or less, 13% or less, 15% or less, 17% or less, 20% or less, 25% or less, or 30% or less.

An additional processing unit may be capable of determining the presence and/or concentration of one or more, two or more, three or more, four or more, five or more, six or more, seven or more, eight or more, nine or more, ten or more, fifteen or more, twenty or more, thirty or more, fifty or more, or one hundred or more analytes of a sample. The one additional processing unit may be capable of determining the presence and/or concentration of one or more, two or more, three or more, four or more, five or more, six or more, seven or more, eight or more, nine or more, ten or more, fifteen or more, twenty or more, thirty or more, fifty or more, or one hundred or more proteins, biomarkers, or other analytes of a sample, including but not limited to nucleic acids (DNA, RNA, hybrids thereof, microRNA, RNAi, EGS, antisense), metabolites, gasses, ions, particles (including crystals), small molecules and metabolites thereof, elements, toxins, enzymes, lipids, carbohydrates, prions, and formed elements (e.g., cellular entities such as whole cell, cell debris, and cell surface markers). Such additional information may be used for the diagnosis, prognosis, and/or treatment of a subject. In some embodiments, such information may be used for the identification of the subject.

One or more detection unit 206 may be provided in the sample processing device. For example, one or more detection unit may be provided within a sample processing device housing. A sample detection unit may be separate from other components of a sample processing device, or it may be linked to another component of the sample processing device. For example, a sample detection unit may be incorporated into a sample processing unit, such as an assay unit.

The detection unit may be used to detect a signal produced by at least one assay on the device. The detection unit may be used to detect a signal produced at one or more sample preparation station in a device. The detection unit may be capable of detecting a signal produced at any stage in a sample preparation or assay of the device. For example, the detection unit may detect a signal produced before, during, or after nucleic acid amplification.

In some embodiments, a plurality of detection units may be provided. The plurality of detection units may operate simultaneously and/or in sequence. The plurality of detection units may include the same types of detection units and/or different types of detection units. The plurality of detection units may operate on a synchronized schedule or independently of one another.

The detection unit may be above the component from which the signal is detected, beneath the component from which the signal is detected, to the side of the component from which the signal is detected, or integrated into the component from which the signal is detected, or may have different orientation in relation to the component from which the signal is detected. For example, the detection unit may be in communication with an assay unit. The detection unit may be proximate to the component from which the signal is detected, or may be remote to the component from which the signal is detected.

The detection unit may have a fixed position, or may be movable. The detection unit may be movable relative to a component from which a signal is to be detected. For example, a detection unit can be moved into communication with an amplification unit or the amplification unit can be moved into communication with the detection unit. In one example, a sensor is provided to locate an amplification unit relative to a detection unit when an assay is detected.

A detection unit may include one or more optical sensor. For example, a detection unit may include an electronic optical sensor such as a charge-coupled device (CCD), super-cooled CCD array, complementary metal-oxide semiconductor (CMOS) sensor, or a non-electronic sensor, such as photographic film. Other optical sensors that may be used include, without limitation, a photodiode, avalanche photodiode (APD), photomultiplier tube (PMT), photon counting detector, photocell, avalanche photo diode, or avalanche photo diode array. In some embodiments a pin diode may be used. In some embodiments a pin diode can be coupled to an amplifier to create an optical sensor with sensitivity comparable to a PMT. In some embodiments a detection unit could include a plurality of fiber optic cables connected as a bundle to a CCD detector or to a PMT array. The fiber optic bundle could be constructed of discrete fibers and/or of many small fibers fused together to form a solid bundle. Such solid bundles are commercially available and easily interfaced to CCD detectors. In some embodiments, fiber optic cables may be directly incorporated into assay or reagent units. For example, samples or tips as described elsewhere herein may incorporate fiber optic cables.

A detection unit may include an imaging device, such as a camera. A camera may include any optical sensor disclosed herein. In some instances, a camera may contain a CCD, CMOS, or avalanche photodiode optical sensor. A camera may further include, without limitation, any one or more of: a lens, shutter, light source, or focus mechanism. In some instances, a camera may be a lens-less camera (e.g., Frankencamera, detection setups pin-hold camera) or may utilize any other visual detection technology known or later developed in the art. Cameras may include one or more feature that may focus the camera during use, or may capture images that can be later focused. In some embodiments, imaging devices may employ 2-d imaging, 3-d imaging, and/or 4-d imaging (incorporating changes over time). Imaging devices may capture static images. The static images may be captured at one or more point in time. The imaging devices may also capture video and/or dynamic images. The video images may be captured continuously over one or more periods of time. A camera may obtain images in real-time. A camera may take snapshots or video at selected time intervals or when triggered by an event. In some embodiments, the camera may image a plurality of samples simultaneously. Alternatively, the camera may image a selected view, and then move on to a next location for a different selected view.

In some embodiments, a detection unit or imaging device may utilize one or more component of the sample processing device in capturing the image. For example, the imaging device may use a tip and/or vessel to assist with capturing the image. The tip and/or vessel may function as an optic to assist in capturing an image.

A detection unit may be configured to support visual inspection to observe an image.

A detection unit may also contain or be in communication with a memory unit or controller to record, save, or analyze an image or signal.

One or more detection units may be configured to detect a detectable signal. Examples of detectable signals include luminescent signals, such as photoluminescence, electroluminescence, chemiluminescence, fluorescence, radioluminescence, or phosphorescence, and ionizing radiation signals. The detection unit may be able to detect optical signals relating to color and/or intensity. For example, the detection unit may be configured to detect selected wavelengths or ranges of wavelengths.

In some embodiments, one or more labels may be employed during a chemical reaction. The label may permit the generation of a detectable signal. The detectable signal may be correlated with the progress and/or outcome of a reaction, such as nucleic acid amplification. Methods of detecting labels are well known to those of skill in the art. Thus, for example, where the label is a radioactive label, means for detection may include a scintillation counter or photographic film as in autoradiography. Where the label is a fluorescent label, it may be detected by exciting the fluorochrome with the appropriate wavelength of light and detecting the resulting fluorescence by an optical sensor. Excitation of a fluorochrome with an appropriate wavelength of light may result in the release of light from the fluorchrome at a particular wavelength of interest for detection. Detection units may also be capable of capturing audio signals. The audio signals may be captured in conjunction with one or more image. Audio signals may be captured and/or associated with one or more static image or video images. Alternatively, the audio signals may be captured separate from the image.

A detection unit may have an output that is digital and generally proportional to a detected signal, e.g., photons reaching a sensor. Alternatively, the detection unit may output an analog signal. The detectable range for exemplary detection unit can be suitable to the sensor being used.

The detection unit may be capable of capturing and/or imaging a signal from anywhere along the electromagnetic spectrum. For example, a detection unit may be capable of capturing and/or imaging visible signals, infra-red signals, near infra-red signals, far infra-red signals, ultraviolet signals, and/or other signals.

A detection unit can also comprise a light source, such as an electric bulb, incandescent bulb, electroluminescent lamp, laser, laser diode, light emitting diode (LED), gas discharge lamp, high-intensity discharge lamp. Other examples of light sources include those provided elsewhere herein. The light source can illuminate a component in order to assist with detecting the results. For example, the light source can illuminate an assay in order to detect the results. For example, the assay can be a fluorescence assay or an absorbance assay, as are commonly used with nucleic acid assays. The detection unit can also comprise optics to deliver the light source to the assay, such as a lens, mirror, or fiber optics. The detection unit can also comprise optics to deliver light from an assay to a detection unit.

In some embodiments, the detection unit may include non-optical detectors or sensors for detecting a particular parameter of a subject. Such sensors may include sensors for temperature, spectrophotometer, electrical signals, for compounds that are oxidized or reduced, for example, O₂, H₂O₂, and I₂, or oxidizable/reducible organic compounds and/or redox inorganic compounds, and/or electrochemical sensors.

Examples of temperature sensors may include thermometers, thermocouples, or IR sensors. The temperature sensors may or may not utilize thermal imaging. The temperature sensor may or may not contact the item whose temperature is to be sensed.

Examples of sensors for electrical properties may include sensors that can detect or measure voltage level, current level, conductivity, impedance, or resistance. Electrical property sensors may also include potentiometers or amperometric sensors.

In some embodiments, labels may be selected to be detectable by a detection unit. The labels may be selected to be selectively detected by a detection unit. Examples of labels are discussed in greater detail elsewhere herein.

In some embodiments, a device may also have external sensors that may be capable of collecting information about a subject. For example, the device may have a camera that may be capable of capturing an image of the subject. The camera may capture an image of the subject's face, entire body, neck, torso, arm, hand, finger, leg, foot, waist, eye, or any other component of the subject. An image captured of the subject may be useful for further identification of the subject. For example facial recognition may be used to identify the subject's face. The image may also be used to calculate the subject's height or circumference (e.g., waist circumference, chest circumference, hip circumference, neck circumference, arm circumference, wrist circumference, leg circumference, ankle circumference). The image may include a video image which may capture a portion of the subject. For example, the subject's gait, gestures, or other movements may be analyzed. In some instances, an image may be useful for an iris scan or retinal scan. An image may also be useful for determining a fingerprint or handprint of the subject. A device may also utilize a touchscreen or other interface for collecting a fingerprint or handprint of the subject. The video or still recording could be used to establish a chain of custody by associating an image taken during sample collection with a particular individual and/or a particular analytical event.

The device may also include a microphone or other audio sensor that may be used to record the subject's voice or a physiological condition of the subject (e.g., subject's heartbeat). A peripheral device may be used to capture the subject's heart rate, blood pressure, or other physiological information. One or more electrode may be used to capture an electrical characteristic of the subject. In some instances, a subject may touch a first portion of a touchscreen with a first portion of the subject's body, and the subject may touch a second portion of the touchscreen with a second portion of the subject's body, and an electrical current may be sent through the subject. One or more electrical characteristic of the subject may be measured. Such electrical characteristics may include but are not limited to resistance, impedance, conductance, or rates of change thereof. A scale may be used to capture the subject's weight. An infrared sensor or scanner may be used to capture the body temperature at one or more location of the subject's body.

In some instances, one or more pieces of biometric information may be gathered about the subject as described in U.S. Patent Publication No. 2007/0047770, which is hereby incorporated herein by reference in its entirety for all purposes.

Any of the additional information, such as the biometric information of the subject or information from the sample (e.g., analyte level, biomarker level, protein level, etc.), collected herein may be associated with the subject's genetic information. The additional information may be used as part of an identifier. The information may be a static and/or dynamic component of the identifier.

Any of the sensors may be triggered according to one or more schedule, or a detected event. In some embodiments, a sensor may be triggered when it receives instructions from one or more controller. A sensor may be continuously sensing and may indicate when a condition is sensed.

A sample processing device may further contain one or more controllers. One or more sensors may provide signals indicative of measured properties to a controller. The one or more sensors may provide signals to the same controller or to different controllers. In some embodiments, the signals may be provided to the controller via a wired connection, or may be provided wirelessly. The controller may be capable of providing instructions for performing a desired nucleic acid amplification, and/or any other sample processing step. The controller may also contain and/or be associated with a memory unit.

The controller may, based on the signals from the sensors, effect a change in a component or maintain the state of a unit. For example, the controller may change the temperature of a temperature control unit. In some embodiments, based on the signals from the sensors, the controller may maintain one or more condition of the device. One or more signal from the sensors may also permit the controller to determine the current state of the device and track what actions have occurred, or are in progress.

The controller may also provide information to an external device. For example, the controller may provide an assay reading to an external device which may further analyze the results. The controller may provide the signals provided by the sensors to the external device. The controller may pass on such data as raw data as collected from the sensors. Alternatively, the controller may process and/or pre-process the signals from the sensors before providing them to the external device. The controller may or may not perform any analysis on the signals received from the sensors. In one example the controller may put the signals into a desired format without performing any analysis.

The sample processing device may have a transmission unit 208 that may permit the controller to transmit the data to the external device. The transmission unit may enable communications between the device and an external device. The transmission unit may permit such communications to occur over a wired connection or wirelessly.

The transmission unit may be capable of transmitting and/or receiving information wirelessly from an external device. The transmission unit may permit one way and/or two-way communication between the device and one or more external device. In some embodiments, the transmission unit may transmit information collected or determined by the device to an external device. In some embodiments, the transmission unit may be receiving a protocol or one or more instructions from the external device. The device may be able to communicate with selected external devices, or may be able to communicate freely with a wide variety of external devices.

In some embodiments, the transmission unit may permit the device to communicate over a network, such as a local area network (LAN) or wide area network (WAN) such as the Internet. In some embodiments, the device may communicate via a telecommunications network, such as a cellular or satellite network.

Some examples of technologies that may be utilized by a transmission unit may include Bluetooth or RTM technology. Alternatively, various communication methods may be utilized, such as a dial-up wired connection with a modem, a direct link such as TI, ISDN, or cable line. In some embodiments, a wireless connection may be using exemplary wireless networks such as cellular, satellite, or pager networks, GPRS, or a local data transport system such as Ethernet or token ring over a LAN. In some embodiments, the transmission unit may contain a wireless infrared communication component for sending and receiving information. In some instances, an asymmetric digital subscriber line (ADSL) and/or asynchronous transfer mode (ATM) may be used for wired communication. An example of wireless communications may also include code division multiple access (CDMA).

In some embodiments, the information may be encrypted before it is transmitted over a network, such as a wireless network.

In some instances, the external device 120 may be one or more fellow sample processing devices. In some embodiments the external device may be a server, computer, mobile device (e.g., telephone, pager, smartphone, laptop, tablet), or system-wide controller. The external device may have a processor and/or memory. The memory may include tangible computer readable media with code, logic, or instructions to perform one or more step. The processor may be capable of performing one or more step. In one example, a processor may be capable of performing one or more step relating to gene sequencing and/or generating a genetic signature or any other biological signature. A biological signature may include bits of data that may be generated based on information collected relating to a collected biological sample or biological information relating to a subject. The external device may be a cloud computing infrastructure, part of a cloud computing infrastructure, or may interact with a cloud computing infrastructure. In some instances, the external device that the device may communicate with may be a server or other device as described elsewhere herein.

The external device may comprise one or more database and/or memory suspected to contain one or more records associated with the subject. Alternatively, the device may be in communication with one or more database and/or memory suspected to contain one or more records associated with the subject. The records may be stored in one or more database, memory, device, and/or a cloud computing infrastructure. Such records may be stored at the same location as the external device and/or sample processing device, or at a different location from the external device and/or sample processing device.

The sample processing device and/or external device may be capable of accessing records that may be stored by one or more different systems. Such systems may have hardware external to the device and/or external device. Alternatively, the device and/or external device may be capable of accessing records that may be stored locally on the device and/or external device.

The sample processing device and the external device may be at the same location or may be at different locations. The sample processing device and external device may be in different rooms or different buildings. The sample processing device and external device may be at geographic locations that are remote from one another.

Additional examples of amplification units or components that may be utilized in nucleic acid amplification may be described herein. Any of the amplification units or components described herein may be provided in a sample processing device as described elsewhere herein.

FIG. 9 shows an example of an amplification unit in an open position. One or more module 900 or support may be provided which may contain one or more components of the amplification units. The module may optionally comprise one or more components that may be useful for additional processing.

An amplification unit may include a temperature control unit 902. The temperature control unit may be a heating block. The temperature control unit may have one or more features of any temperature control unit and/or heater described elsewhere herein.

The temperature control unit 902 may be in thermal communication with one or more assay vials 904. The assay vials may be tips, vessels, chambers, reservoirs, containers, and/or may have any other configuration that may accept and/or confine a sample, reagent, liquid, or any other substance therein. A plurality of assay vials may be provided. In some embodiments, assay vials may be connected to one another, thereby forming assay strips, arrays, or any other configuration. Assay vials may form groups which may or may not be connected to one another. A single group or a plurality of groups of assay vials may be in thermal communication with the temperature control unit. A single assay vial or a plurality of assay vials may be in thermal communication with the temperature control unit.

The temperature control unit may be capable of varying and/or maintaining the temperature of the assay vials. The temperature control unit may be capable of varying and/or maintaining the temperature of a sample, reagent, liquid, or other substance within the assay vials. In some embodiments, the temperature control unit may directly contact the assay vials. In other embodiments, the temperature control unit may contact one or more intermediate substances which may contact the assay vials. The temperature control unit may be capable of providing heat to the assay vials. The temperature control unit may be capable of receiving heat from the assay vials. The temperature control unit may be formed of a thermally conductive material.

The temperature control unit may be capable of controlling the temperature of the assay vials and/or samples, reagents, or other substances within the assay vials with a desired degree of precision and/or accuracy. For example, the desired temperature may be maintained within about 5 degrees C., 3 degrees C., 1 degree C., 0.5 degrees C., 0.3 degrees C., 0.1 degrees C., 0.05 degrees C., 0.03 degrees C., 0.01 degrees C., 0.005 degrees C. or 0.001 degrees C.

A ramp rate of greater than or equal to 1 degree C./sec, 3 degrees C./sec, 5 degrees C./sec, 7 degrees C./sec, 10 degrees C./sec, 15 degrees C./sec, 20 degrees C./sec, 25 degrees C./sec, or 30 degrees C./sec may be achieved. This may include ramp up for temperature increase and/or ramp down for temperature decrease. The capabilities for the ramp up and ramp down times may be approximately the same, and/or the ramp up capabilities may be faster than the ramp down, or the ramp down capabilities may be faster than the ramp up.

In some embodiments, the temperature control unit may contact one, or more than one side of the assay vials. The temperature control units may contact a bottom of the assay vials. The temperature control units may completely surround or partially surround the exterior of the assay vials. The assay vials may be at least partially embedded within the temperature control unit. The temperature control unit may contact at least 50% or more, 70% or more 80% or more, 90% or more, 95% or more, or 99% or more of an exterior surface of an assay vial.

The temperature control unit may also utilize the use of convection. For example, one or more fan may be provided which may cause fluid flow to assist with temperature control. For example, the fan may blow air or another fluid over a heating block. The heating block may have one or more fins or other surface features that may assist with heat dissipation. In some instances, the fan may assist with cooling the assay vials.

An amplification unit may have a movable portion 910. The movable portion may be capable of moving along a first axis. In some embodiments, the first axis may be along a length of the module. One or more track 912 may be provided which may assist with guiding the movable portion along the axis. In some embodiments, an actuator may drive the movable portion along the first axis. The movable portion may be capable of moving in either direction along the first axis. In some instances, the actuator may be a motor, or any other actuation mechanism. In some instances, the movable portion may or may not be capable of moving along an additional axis. The additional axis may or may not be orthogonal to the first axis. In some instances, a third axis may be provided which may or may not be orthogonal to the first and second axes. The movable portion may have one degree of motion, two degrees of motion, and/or three degrees of motion. The movable portion may remain in the same orientation as it moves. Alternatively, the movable portion may be capable of having an altered orientation.

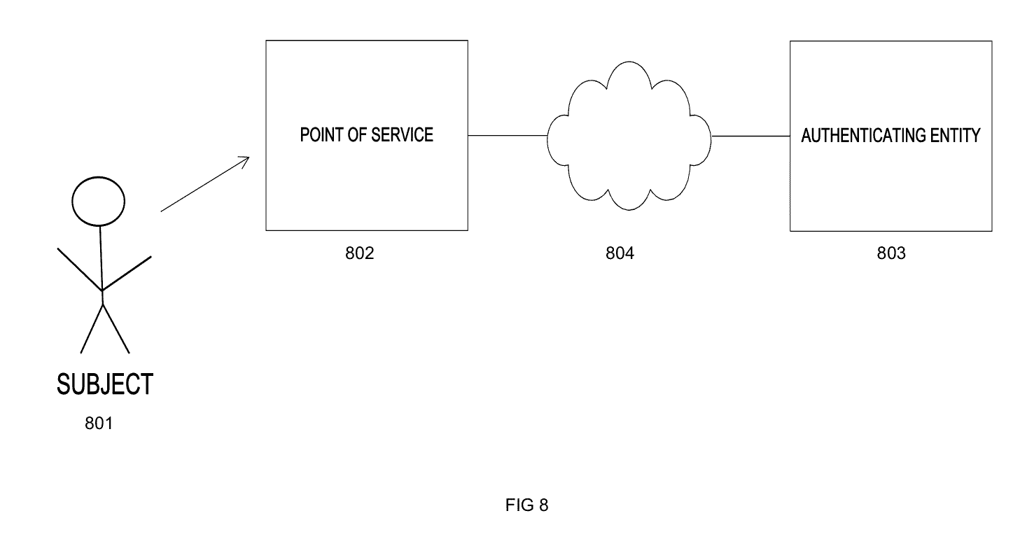

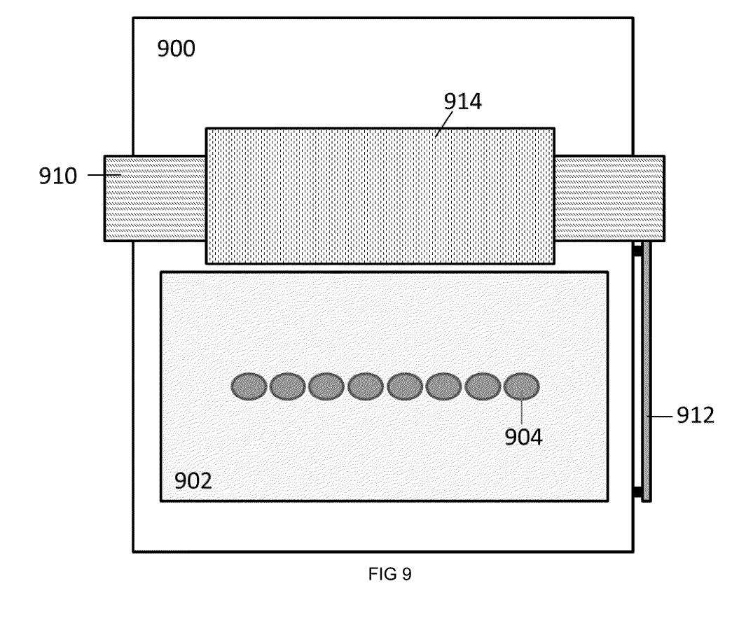

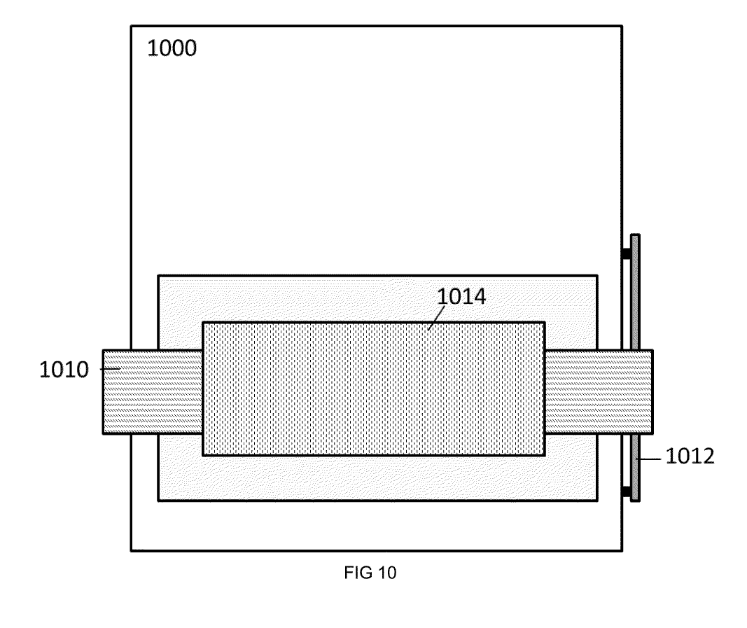

In some embodiments, the movable portion may include a light source support 914. The light source support may cover one or more assay vials in a closed position, and may leave the assay vials exposed in an open position. FIG. 9 shows an example of an open position, while FIG. 10 shows an example of a closed position. The movable portion may cover the temperature control unit and/or assay vials in a closed position, and may leave the temperature control unit and/or assay vials exposed in an open position. The movable portion may be permitted to slide any amount over the temperature control unit. In some instances, the movable portion may rest only at a fully open or fully closed position. Alternatively, the movable portion may be at rest at any point at fully open, fully closed, or therebetween. In some instances, the temperature control unit and/or assay vials may be completely exposed, partially exposed, or completely covered.

When in an open position, the movable portion may leave the assay vials exposed. The assay vials may be removed and/or inserted into the module 900 when the movable portion is open. The assay vials may be removed from a temperature control unit and/or inserted into a temperature control unit. The assay vials may be moved by a sample handling apparatus/fluid handling apparatus as described elsewhere herein. The assay vials may be individually movable with respect to one another and/or the temperature control unit. The assay vials may be moved one at a time, or as a group.

FIG. 10 shows an example of an amplification unit in a closed position. A module 1000 may be provided for an amplification unit. A movable portion 1010 may be in a closed position, which may cover one or more portions of the amplification unit. In some instances, the movable portion may cover a temperature control unit and/or one or more assay vials.

One or more track 1012, groove, protrusion, bar, channel, or any other type of guide may assist with guiding the movable portion in one or more direction. In some instances, two tracks may be provided, each one on opposing sides of a module.

The movable portion may include one or more light source support 1014. The light source support may cover underlying portions, such as a temperature control unit and/or one or more assay vials. The light source may cover the underlying portions so that exterior light does not reach the underlying portions, or only a selected amount of exterior light reaches the underlying portion when in a closed position. The light source support may cover the underlying portion and form an air tight seal so that ambient air does not reach the underlying portions, when in a closed position. Alternatively, the source support may permit ambient air to reach the underlying portions when in a closed position.

In some embodiments, a module 900, 1000 may include one or more electronics therein that may cause one or more action to occur within an amplification unit. For example, electronics may be provided which may drive a movable portion to open and/or close. A controller may be provided which may send a signal to one or more actuator, which may cause the movable portion to approach an open or closed position. The electronics may also cause one or more action with respect to the temperature control unit. For instance, a controller may be provided which may send one or more signals to the temperature control unit to vary and/or maintain the temperature of the temperature control unit. A controller may also send one or more signals to one or more light source to control the light provided by the light source. Electronics and/or controller may be enclosed within a housing of the module. Alternatively, they may be partially or completely exposed.

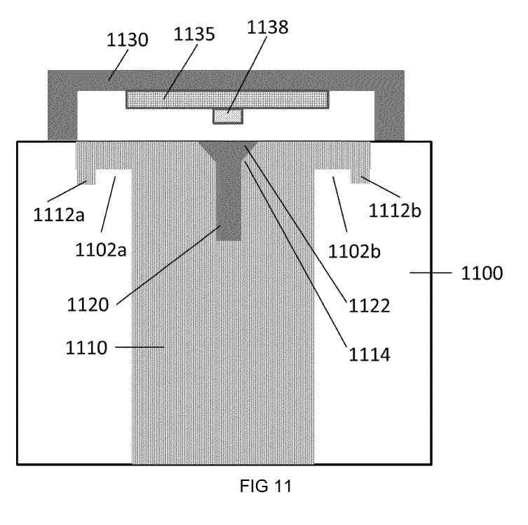

FIG. 11 shows an example of a cross-section of a temperature control unit, vials, and light source. For example, a support 1100 may be provided. One or more temperature control unit 1110, such as a heating block may be provided. In some embodiments, the temperature control unit may have a complementary shape to the support. For example, the temperature control unit may have one or more lip 1112a, 1112b which may overhang and fit into a complementary shape within the support. The lip or other shaped feature may keep the temperature control unit mated to the support. In some embodiments, one or more interlocking shape or features may be provided between the support and the temperature control unit. The support may have one or more complementary lip 1102a, 1102b that may assist with the interlocking mechanism.

The temperature control unit 1110 may be configured to accept one or more assay vials 1120. The assay vials may be in thermal communication with the temperature control unit. In some instances, the assay vials may be configured to be entirely embedded or partially embedded within the temperature control unit. The temperature control unit may have one or more cavity, groove, indentation, or any other shaped feature to accept one or more assay vials. Any description of a cavity herein may refer to any shaped feature that may be capable of accepting at least a portion of one or more vials, and vice versa. An individual cavity may be shaped to accept an individual assay vial. Alternatively, an individual cavity may be shaped to accept a group of assay vials. The assay vials may or may not be connected to one another. The temperature control unit may have one or more shaped feature that may accept connections between assay vials.

In some embodiments, a cavity of a temperature control unit may be shaped to complement an assay vial. In some instances, the cavity of the temperature control unit may be shaped to accept a specific assay vial. Alternatively, the cavity may have one or more shaped features that may permit the cavity to accept a plurality of types of assay vials. An assay vial may fit snugly within a cavity of a temperature control unit. The walls of the assay vial and/or the bottom of the assay vial may contact the temperature control unit.

The temperature control unit may be formed of a conductive material. In some embodiments, a heat source and/or cooling source may be within the conductive material. For examples, a voltage may be applied to the conductive material and/or wires or other features within the conductive material to apply heat to the temperature control unit. In some instances, the temperature control unit may contact a separate heater and/or cooler, and the conductive material may transfer heat to and/or from the assay vials.

In some embodiments, the assay vials may have a tapered portion 1122. The temperature control unit may have a complementary tapered receiving portion 1114. The tapered portion of the assay vial may rest on the complementary tapered receiving portion. In some instances, any other shaped feature of an assay vial may have a complementary portion on the temperature control unit. In some instances, no substantial gaps are provided between an assay vial exterior surface and the temperature control unit cavity surface. Alternatively, some gaps may be provided between an assay vial exterior surface and the temperature control unit cavity surface.

The tops of the assay vials may or may not extend beyond the temperature control unit. For example, the assay vial may be completed embedded within the temperature control unit so that the assay vial does not protrude from the temperature control unit. Alternatively, a portion or the entire assay vial may protrude from the temperature control unit.

In some instances, a single temperature control unit may be provided for an amplification unit. A single temperature control unit may have a uniform temperature. Alternatively, the single temperature control unit may have a temperature gradient where one or more portion of the temperature control unit may be hotter than one or more other portions of the temperature control unit. Alternatively, a plurality of temperature control units may be provided. The plurality of temperature control units may be independently controllable and/or may have different temperature profiles. Alternatively, the plurality of temperature control units may be controlled together and may have the same temperature profiles.

Within an amplification unit, the same temperatures profiles may be provided to each of the assay vials (e.g., assay vials in thermal communication with a temperature control unit). Alternatively, the different temperature profiles may be provided for the assay vials (e.g., assay vials in thermal communication with the same temperature control unit, or assay vials in thermal communication with different temperature control units). The different temperature profiles may or may not be individually controllable. In some instances, each assay vial may be exposed to a different temperature profile—alternatively, groups of assay vials may be exposed to different temperature profiles but may have the same temperature profile within the group. In some embodiments, within an amplification unit, the same type of nucleic acid amplification may be occurring. Alternatively, within an amplification unit, different types of nucleic acid amplification may occur simultaneously.

A movable portion may be provided in an amplification unit. The movable portion may include a light source support 1130. The movable portion may have an open position where the temperature control unit and/or assay vials are exposed, and a closed position, where the temperature control unit and/or assay vials are covered. Assay vials may be removed and/or inserted when the movable portion is in the open position. In some instances, the assay vials are not removed and/or inserted when the movable portion is in the closed position. A nucleic acid amplification reaction may be run while the movable portion is in a closed position. The movable portion may have horizontally and/or vertically with respect to the assay vials.

The light source support 1130 may also include a light source assembly 1135. The light source assembly may include a common substrate and/or one or more individual light sources 1138.

The light sources 1138 may be any type of light source including but not limited to electroluminescent light sources (e.g., light-emitting diodes (LEDs—e.g., LED lamp, solid-state lighting, organic LED, polymer LED), electroluminescent sheets, electroluminescent wires), electron stimulated light sources (e.g., cathodoluminescence, electron stimulated luminescence, cathode ray tube, nixie tube), incandescent light sources (e.g., incandescent light bulb, halogen light source, carbon button lamp, globar, Nernst), gas discharge light sources (e.g., fluorescent, inductive lighting, hollow cathode lamp, neon, argon, plasma, xenon flash), high-intensity discharge light sources (e.g., carbon arc, ceramic discharge metal halide, hydragyrum medium-arc iodide, mercury-vapor, metal halide, sodium vapor, sulfur, xenon arc), lasers, or any other light source described elsewhere herein. Light sources may emit light of a particular wavelength or range of wavelengths. In some instances, one or more filters may be used with a light source such that only a particular wavelength or range of wavelengths from the light source pass through the filter.

The light sources may be capable of illuminating one or more assay vials. In some embodiments, a plurality of light sources may be provided. The light sources may be arranged so that the assay vials receive a uniform amount of light. Alternatively, the light sources may be arranged so that different assay vials may receive different amounts of light. In some instances, one or more light sources may correspond to one or more assay vial. For example, one or more light sources may be located above an assay vial. In one example, a light source may be located directly above an assay vial. Each assay vial may have a light source located above it.

The light sources may be controlled together. For example, each of the light sources may have the same light emitting profile (e.g., whether the light is on or off, light intensity, brightness, wavelength). In other embodiments, the light sources may have different light emitting profiles. The light sources may be individually controllable or groups of light sources may be independently controllable. The light sources may be the same type of light sources and/or different types of light sources may be used.

In some embodiments, the illumination provided by the light sources may assist with nucleic acid amplification. Alternatively, the light sources may be useful for detection. One or more sensors may be provided which may detect the results of nucleic acid amplification. The sensor may operate to detect one or more signal from the assay vials before, during, and/or after the nucleic acid amplification. The sensor may be part of a detection unit. In some instances, a detection unit may detect one or more signal while the movable portion is in a closed position. Alternatively, a detection unit may detect one or more signal while the movable portion is in an open position.

A detection unit may include an optical sensor as described elsewhere herein. The optical sensor may be a component of a camera. The detection unit may be incorporated within an amplification unit. One or more portion of the detection unit may be contained within a housing of a module or may be separate from a module. In one example, a detection unit may be incorporated into a movable portion. For example, one or more camera may be provided over the assay units within the movable portion. In another example, a detector unit may be incorporated into the temperature control unit and/or the assay vials themselves. In some embodiments, a detection unit may be separate from the amplification unit and may read one or more signals from the amplification unit when the movable portion is an open position.

FIG. 12A shows a side lengthwise view of an example of assay vials provided herein. FIG. 12B shows a side end view of assay vials provided herein. FIG. 12C provides a perspective view of assay vials. FIG. 12D shows a top view of assay vials. The assay vials may form an assay strip.

The assay strip may have a body 1200. The body may be formed from a single integral piece or multiple pieces. The body may have a molded shape. The body may form a plurality of circular pieces 1210a, 1210b connected to one another, or various shapes connected to one another. The bodies of the circular pieces may directly connect to one another or one or more strip or space may be provided between the bodies.

The assay strip may include one or more cavities 1230. In some embodiments, the cavities may be provided as a row in the body. The cavities may optionally be provided in a straight row, in an array (e.g., m×n array where m, n are whole numbers greater than zero including but not limited to 1, 2, 3, 4, 5, 6, 7, 8, 9, 10, 11, 12, 13, 14, 15, 16, or more). The cavities may be positioned in staggered rows, concentric circles, or any other arrangement.

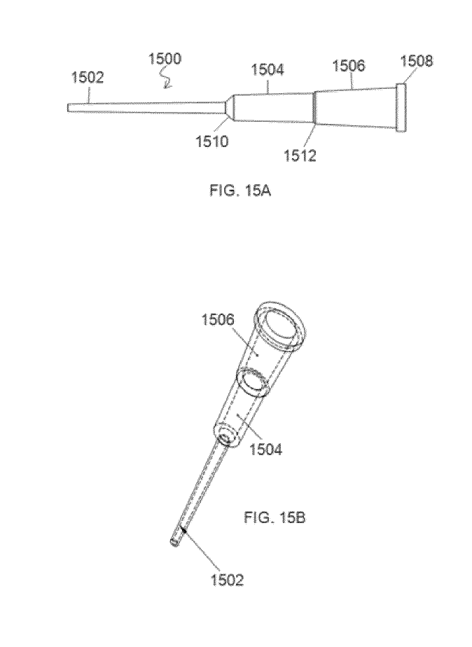

The cavities may accept a sample, fluid or other substance directly therein, or may accept a vessel and/or tip that may be configured to confine or accept a sample, fluid, or other substance therein. The cavities may be configured to accept a tip, such as a tip illustrated in FIG. 15, or any other tip and/or vessel described elsewhere herein. The assay strip may optionally be a nucleic acid strip, which may be configured to accept and support nucleic acid tips. In some instances, the assay strip may receive one or more samples within the cavities which may be used for nucleic acid amplification.

The assay strip body 1200 may be molded around the cavities 1230. For example, if a cavity has a circular cross-section, the assay strip body portion 1210a, 1210b around that cavity may have a circular cross-section. Alternatively, the assay strip body need not match the cavity shape.

The assay strip may be placed in thermal communication with a temperature control unit. The assay strip may be partially or completed embedded within a temperature control unit. The temperature control unit may have one or more indented shape or feature that may be complementary to the external shape of the assay strip. In some instances, the assay strip may rest on top of the temperature control unit. The assay strip may or may not be formed of a thermally conductive material.

In some embodiments, the assay strip may include an external pick-up receptacle 1220. One or more pipette nozzle may engage with one or more external pick-up receptacle of the assay strip. One, two, three, four, five, six or more pipette nozzles may simultaneously engage with corresponding pick-up receptacles of the assay strip. The nozzles may be part of a sample handling apparatus/fluid handling apparatus as described elsewhere herein. Alternatively, other pick-up and/or drop-off mechanisms may be used. A pick-up receptacle may have one or more cavity 1240 or through-hole that may be capable of interfacing with a pipette nozzle. The pipette nozzle may be press-fit into the cavity or may interface with the receptacle in any other manner described herein.

One or more samples and/or reagents may be provided in an assay strip. The one or more sample may be directly within a cavity or may be provided in tips and/or vessels that may be placed in a cavity of the assay strip. The assay strips may have a narrow profile. A plurality of assay strips may be positioned adjacent to one another. They may be provided adjacent to one another end-to-end, and/or side-by-side. In some instances, a plurality of assay strips adjacent to one another may form an array of cavities. The assay strips may be swapped out for modular configurations. The assay strips may be movable independently of one another. The assay strips and/or reagents may have different samples therein, which may need to be kept at different conditions and/or shuttled to different parts of the device on different schedules.

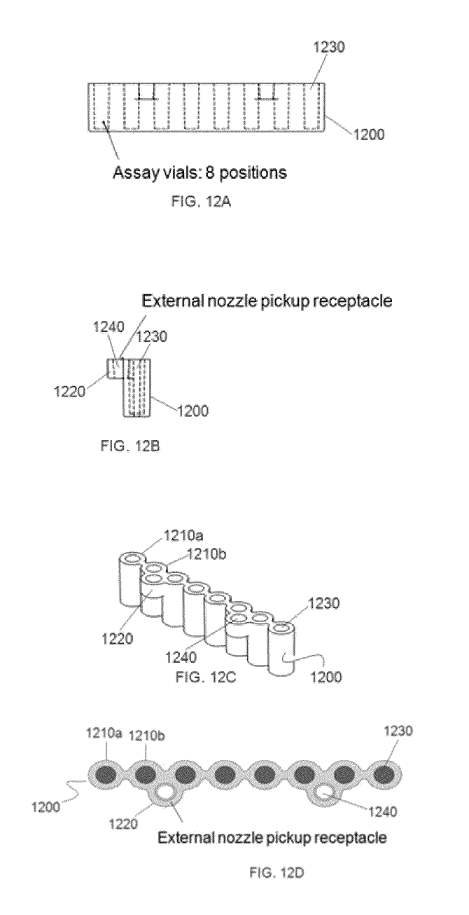

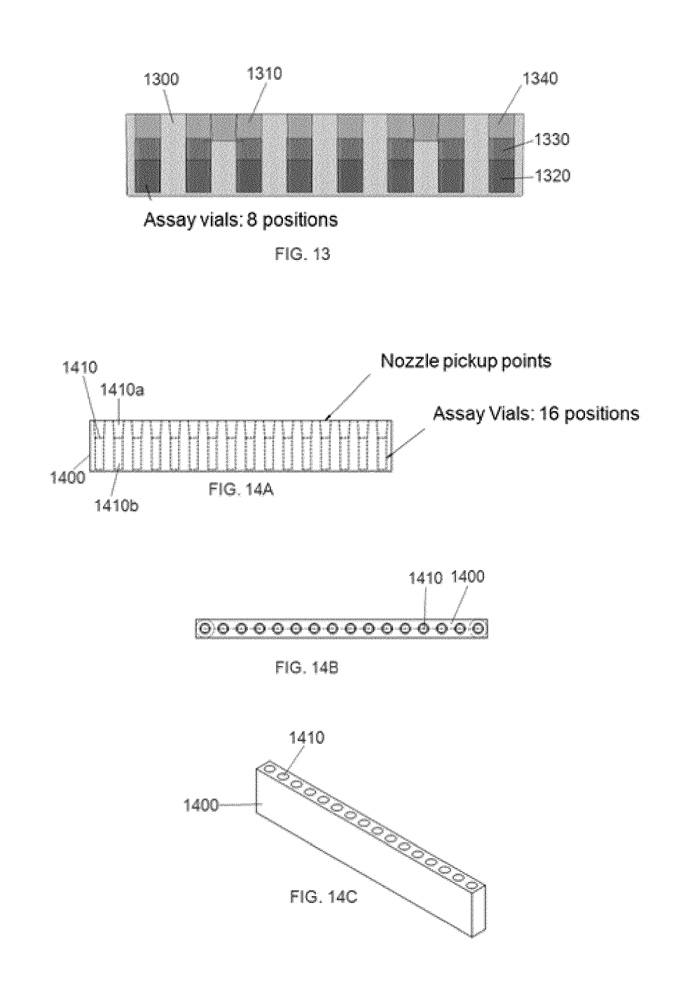

FIG. 13 shows a side view of an example of an assay strip provided herein. The assay strip may include an assay strip body 1300. The assay strip body may be formed from a solid material or may be formed from a hollow shell, or any other configuration.

The assay strip may include one or more cavities 1310. In some embodiments, the cavities may be provided as a row in the body. The cavities may optionally be provided in a straight row, in an array (e.g., m×n array where m, n are whole numbers greater than zero including but not limited to 1, 2, 3, 4, 5, 6, 7, 8, 9, 10, 11, 12, 13, 14, 15, 16, or more). The cavities may be positioned in staggered rows, concentric circles, or any other arrangement.

The cavities may accept a sample, fluid or other substance directly therein, or may accept a vessel and/or tip that may be configured to confine or accept a sample, fluid, or other substance therein. The cavities may be configured to accept a tip, such as a tip illustrated in FIG. 15, or any other tip and/or vessel described elsewhere herein. The assay strip may optionally be a nucleic acid strip, which may be configured to accept and support nucleic acid tips. The cavities of a nucleic acid strip may be configured to accept one or more sample and/or contain one or more sample during nucleic acid amplification.

A cavity may form an assay vial. The cavity may include one or more reagents 1320 therein. The reagents may also be provided with samples which may or may not react with the reagents. Any description herein of reagent portions may also include the sample. The sample may be suspected of containing at least one nucleic acid molecule. The reagents may undergo nucleic acid amplification.

In some instances, the cavity may also include one or more sealing substance 1330. The sealing substance may provide a seal between the reagents and the ambient air. The sealing substance may help prevent or reduce contamination of the reagents from the ambient air. Similarly, the sealing substance may help prevent contaminating the rest of the device with the reagents. In some instances, the sealing substance may help prevent evaporation of the reagents. In one example, the sealing substance may be a wax seal layer. In other examples, the sealing substance may include a self-healing layer, a flexible membrane, a film, an oil layer, or any other form of sealing substance. The sealing substance may rest on top of the reagents. Optionally, the sealing layer may be optically transparent and/or may allow for an optical sensor to detect one or more signal from the reagents below the sealing layer.

An extra gap 1340 may or may not be provided between the sealing substance and the top of the cavity. The extra gap may be a space within the cavity which is not filled.

A tip may be capable of being inserted into the cavity. A tip may be capable of penetrating to a desired depth within the cavity. For example, the tip may penetrate the sealing layer to enter the reagent layer. The tip may enter the reagent layer and may provide additional reagents, and/or sample. The tip may enter the reagent layer and may aspirate amplified product. The amplified product may be removed from the cavity.

In some embodiments, the cavity may be configured to accept a pipette nozzle for pick-up. One or more pipette nozzle may engage with one or more cavity of the assay strip. One, two, three, four, five, six or more pipette nozzles may simultaneously engage with corresponding cavities of the assay strip. A tapered opening of the cavity may be useful for nozzle pick-up. The pipette nozzle may be press-fit into the cavity or may interface with the cavity in any other manner described herein.

One or more sample and/or reagent may be provided in an assay strip. The assay strips may have a narrow profile. A plurality of assay strips may be positioned adjacent to one another. In some instances, a plurality of assay strips adjacent to one another may form an array of cavities. The assay strips may be swapped out for modular configurations. The assay strips and/or reagents may be movable independently of one another. The assay strips may have different samples therein, which may need to be kept at different conditions and/or shuttled to different parts of the device on different schedules.

FIG. 14A shows a side view of an example assay strip provided herein. The assay strip may include an assay strip body 1400. The assay strip body may be formed from a solid material or may be formed from a hollow shell, or any other configuration.

The assay strip may include one or more cavities 1410. In some embodiments, the cavities may be provided as a row in the body. The cavities may optionally be provided in a straight row, in an array (e.g., m×n array where m, n are whole numbers greater than zero including but not limited to 1, 2, 3, 4, 5, 6, 7, 8, 9, 10, 11, 12, 13, 14, 15, 16, or more). The cavities may be positioned in staggered rows, concentric circles, or any other arrangement.

The cavities may accept a sample, fluid or other substance directly therein, or may accept a vessel and/or tip that may be configured to confine or accept a sample, fluid, or other substance therein. The cavities may be configured to accept a tip, such as a tip illustrated in FIG. 15, or any other tip and/or vessel described elsewhere herein. The assay strip may optionally be a nucleic acid strip, which may be configured to accept and support nucleic acid tips. The cavities of a nucleic acid strip may be configured to accept one or more sample and/or contain one or more sample during nucleic acid amplification.

A cavity may have a tapered opening. In one example, a cavity may include a top portion 1410a, and a bottom portion 1410b. The top portion may be tapered and may have an opening greater in diameter than the bottom portion.

In some embodiments, the cavity may be configured to accept a pipette nozzle for pick-up. One or more pipette nozzle may engage with one or more cavity of the assay strip. One, two, three, four, five, six or more pipette nozzles may simultaneously engage with corresponding cavities of the assay strip. A tapered opening of the cavity may be useful for nozzle pick-up. The pipette nozzle may be press-fit into the cavity or may interface with the cavity in any other manner described herein.

One or more sample and/or reagent may be provided in an assay strip. The assay strips may have a narrow profile. A plurality of assay strips may be positioned adjacent to one another. In some instances, a plurality of assay strips adjacent to one another may form an array of cavities. The assay strips may be swapped out for modular configurations. The assay strips and/or reagents may be movable independently of one another. The assay strips may have different samples therein, which may need to be kept at different conditions and/or shuttled to different parts of the device on different schedules.

FIG. 14B shows a top view of an assay strip. The assay strip may include an assay strip body 1400 and one or more cavities 1410. In some instances, the assay strip body may be inserted into an amplification unit. The assay strip body may be in thermal communication with a temperature control unit. In some instances, the assay strip body may be partially or completely embedded within a temperature control unit. The temperature control unit may have one or more groove or complementary shaped feature that may accept the assay strip. Alternatively, the assay strip may rest on a temperature control unit. The assay strip may or may not be formed of a thermally conductive material. The assay strip may be capable of transferring heat to or removing heat from the contents of the assay strip cavities.

In some instances, one or more LED or other light source may be capable of providing illumination to the cavities of the assay strip. In some instances, an individual light source may be provided directly over an individual assay strip cavity.

FIG. 14C provides a perspective view of an assay strip. One, two, three, four or more of the assay strips may be provided per amplification unit. In some instances, any number of assay strips may be in thermal communication with a temperature control unit. The assay strips may be provided adjacent to one another. The assay strips may or may not directly contact one another. The assay strips may be located lengthwise adjacent relative to one another, or may be widthwise adjacent (e.g., parallel) to one another.

FIG. 15A shows a side view of an example of an assay tip provided herein. The tip 1500 may be capable of interfacing with an assay vial and/or strip, including any examples described herein.

The tip may include a narrow portion that may deposit a sample 1502, a sample volume area 1504, and/or a nozzle insertion area 1506. In some instances, the tip may include one or more of the areas described. The sample deposit area may have a smaller diameter than a sample volume area. The sample volume area may have a smaller volume than a nozzle insertion area. The sample deposit area may have a smaller volume than a nozzle insertion area.

In some embodiments, a lip 1508 or surface may be provided at an end of the nozzle insertion area 1506. The lip may protrude from the surface of the nozzle insertion area.

The tip may include one or more connecting region, such as a funnel region 1510 or step region 1512 that may be provided between various types of area. For example, a funnel region may be provided between a sample deposit area 1502 and a sample volume area 1504. A step region 1512 may be provided between a sample volume area 1504, and a nozzle insertion area. Any type of connecting region may or may not be provided between the connecting regions.

A sample deposit area may include an opening through which a fluid may be aspirated and/or dispensed. A nozzle insertion area may include an opening into which a pipette nozzle may optionally be inserted. Any type of nozzle-tip interface as described elsewhere herein may be used. The opening of the nozzle insertion area may have a greater diameter than an opening of the sample deposit area.

The tip may be formed of a transparent, translucent, and/or opaque material. The tip may be formed from a rigid or semi-rigid material. The tip may be formed from any material described elsewhere herein. The tip may or may not be coated with one or more reagents.

The tip may be used for nucleic acid amplification, or any other assays, sample preparation steps, and/or processes described elsewhere herein.

FIG. 15B shows a perspective view of an assay tip. The assay tip may include a portion that may be inserted into an assay vial 1502, a sample volume area 1504, and/or a nozzle insertion area 1506. In some embodiments, a portion of the tip may be inserted into an assay vial and a substance may be dispensed into the assay vial and/or aspirated from the assay vial. In some instances, the substance may be the sample. In other instances, the substance may be a reagent or any other substance that may be useful for nucleic acid amplification and/or detection of amplified products. The tip may be inserted all the way into the assay vial. Alternatively the tip may be inserted part way into the assay vial. In some instances, e.g., when the tip is dispensing, the tip may be over the assay vial without being inserted.

In some alternate embodiments, the tips may be the assay vials. The tips may be inserted in to an amplification unit. For example, the tips may be inserted into a temperature control unit. One or more reaction, such as nucleic acid amplification, may occur within the tip.

The tips may pick up one or more substance from within the assay vials. The tips may pick up amplified product. The tips may transport the product to a location where they may be detected. In some instances, detection may occur while the product is within the tips. In another example, detection may occur while the product is within the assay vial.

In one example, a nucleic acid amplification unit may be provided within a module. The module may comprise a reaction block that can hold any number of assay strips. For example, the reaction block may hold up to four assay vessel strips arranged in two rows. Each strip may contain any number of vessels. For example, each strip may have eight vessels. The strips may be delivered and removed from the block with a pipette or other transfer apparatus. The block may be heated with two 45 watt cartridge heaters embedded in the block and cooled by a fan blowing air over cooling fins on the bottom of the block. The block may be a temperature control unit.

The temperature may be controlled with a controller monitoring thermistors embedded in the block. The block may be suspended in a housing made of high temperature plastic (for thermal isolation). The block may have viewing windows. For example, viewing windows may be provided on each side that allows cameras on either side of the block to photograph the vials.

A motor driven plate with light sources (e.g., 32 LEDs) may be located on a sliding mechanism above the block. The LED plate may be moved out of the way for loading and unloading the strips and to access the strips with pipette tips. When the LED plate is moved over the vials, one LED may be situated over each vial for illumination during the photography.

All of the electronics to drive the motors and heaters may be located on a printed circuit board assembly (PCBA) horizontally mounted above the fan in the back. Intake air for the cooling fan may be drawn in from the side of the instrument through a cylindrical duct in the block and the exhaust air may be released through two rectangular ducts on each side.

The methods, assays, components, device and/or systems may be a method, assay, component, device and/or system described in one or more of the following or may share characteristics, features, steps with a method, assay, component, device, and/or system described in one or more of the following alone or in combination: U.S. Pat. No. 7,291,497, U.S. Pat. No. 7,635,594, U.S. Patent Publication No. 2009/0088336, U.S. Patent Publication No. 2009/0318775, U.S. patent application Ser. No. 13/244,947, U.S. patent application Ser. No. 13/355,458, and/or U.S. patent application Ser. No. 13/244,946, which are all hereby incorporated herein by reference in their entirety for all purposes.

Records and Identifiers

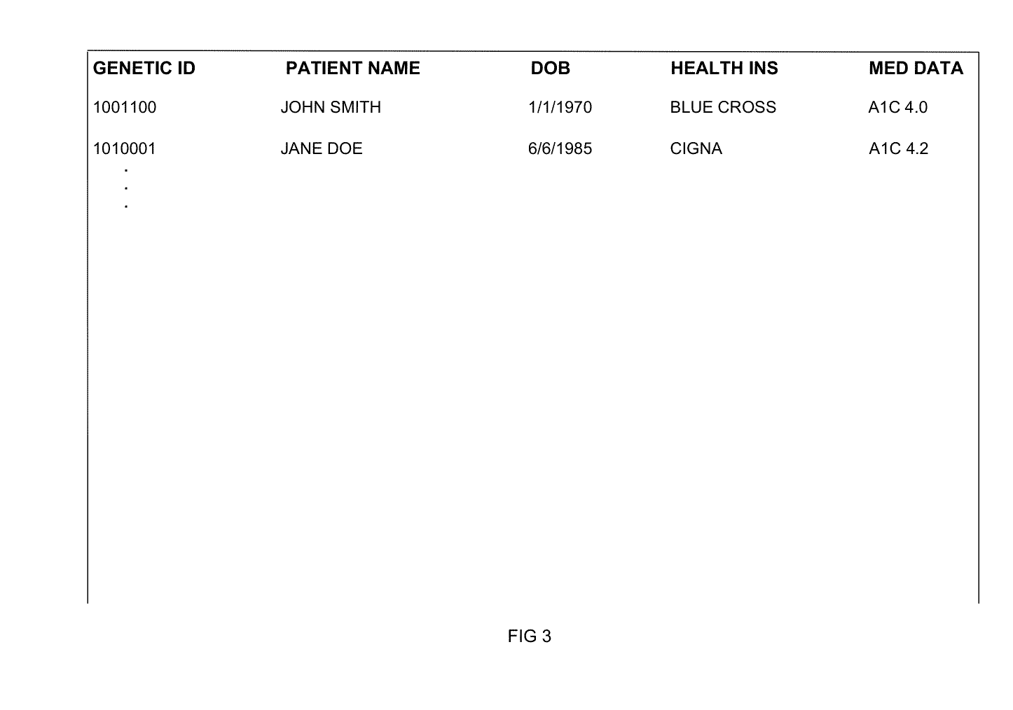

FIG. 3 provides an example of a record in accordance certain systems and methods provided herein. A record may include an identifier for a subject and one or more types of additional information associated with the subject. In some embodiments, the identifier is a unique identifier for the subject. An example of a unique identifier for the subject may be a type of biological signature such as but not limited to a genetic signature for the subject. A unique identifier may include a genetic signature alone, or may incorporate additional information about the subject to form the unique identifier. For example, a unique identifier may be generated based on genetic information of the subject plus the subject's date of birth. The identifier may be an index of the records that may be stored. For example, a database may be indexed by a subject's identifier, such as a genetic signature.

An identifier may include electronic bits of data that may be representative of a subject's genetic signature. The genetic signature may be based on a subject's sequenced genetic information, or some other identifying sequence characteristic (ISC), including but not limited to sequence length (e.g. repeated sequences, insertions, deletions, or transposons), and/or Single Nucleotide Polymorphisms (SNP's), and sequences inferred from the presence or absence of restriction endonuclease cleavage sites. The genetic signature may include the sequence of the entirety of the subject's genome or a portion of the subject's genome. The genetic signature may include one or more, two or more, three or more, four or more, five or more, six or more, seven or more, eight or more, nine or more, ten or more, eleven or more, twelve or more, thirteen or more, fourteen or more fifteen or more, seventeen or more, twenty or more, twenty-five or more, thirty or more, forty or more, fifty or more, or one hundred or more sections of the subject's genome that have been sequenced, or otherwise analyzed to determine the status of an ISC. The portions of the subject's genome to be sequenced or otherwise analyzed may be selected based on the frequency (e.g. rarity) of the portions within a population. In general, the more rare an ISC is, the fewer ISCs will be required to uniquely identify an individual. For example, thirteen sections of the subject's genome may be sequenced or otherwise analyzed and used to create a genetic signature.

The number of ISC's incorporated into a genetic signature in order to uniquely identify an individual will depend on a number of factors, including but not limited to the degree of independence of each ISC from one another, and the number and frequency of alleles for the genetic locus of the ISC. The frequency of a homozygous genotype of a random individual at a given ISC equals the product of the frequencies of both alleles in the population, while the frequency of a heterozygous genotype equals twice the product of the frequencies of both alleles. The probability that a randomly selected individual matches a set of ISC genotypes is the product of the frequencies associated with each genotype. For example, considering 13 ISCs, each with three alleles that occur with equal frequency, the probability of a random individual having a particular homozygous genotype at seven of the ISCs and a particular heterozygous genotype at the remaining six ISCs is (⅓×⅓)⁷×(2×⅓×⅓)⁶, which equals approximately 2.517×10⁻¹¹ or one in 40 billion. Given that the total world population is on the order of 10 billion people, such a result is sufficient to uniquely identify a single person from the entire global population with a high degree of certainty, approaching absolute certainty, and without any other information. Because the number of alleles and the frequency of each can vary from one ISC to the next, the number of ISCs required to reach such a degree of specificity will vary as well, such as about, less than about, or more than about 3, 4, 5, 6, 7, 8, 9, 10, 11, 12, 13, 14, 15, 16, 17, 18, 19, 20, 25, 30, 35, 40, 45, 50, 60, 70, 80, 90, 100, or more ISCs.

In some embodiments, genetic signatures for multiple subjects are prepared using the same genetic elements to develop each subject's genetic signature. For example, for multiple subjects, the same ISCs may be examined for each subject, to generate genetic signatures which each have the same format and/or contain information regarding the same genetic elements.

In some embodiments, an individual is uniquely identified using a combination of a genetic signature and some other information, such as personal knowledge (e.g., events, such as dates or purposes of doctor visits, dates or types of recent vaccinations, birthdays, passwords, addresses, and names of family members or pets), biometric data (e.g., fingerprint, retinal scan, height, weight, eye color, or hair color), data derived from analysis of one or more analytes (e.g. proteins, nucleic acids, lipids, carbohydrates, etc.), and any combination thereof. Each point of such additional data decreases the population size of potentially matching individuals, which in turn decreases the number of ISCs required in a genetic signature to uniquely identify an individual, even out of the entire global population. The required number of ISCs to be analyzed to provide the required level of certainty could be calculated on a per patient or per sample basis based on other complementary information about the subject or sample in real time or prior to analysis. The required number of ISCs to be analyzed could also be determined and updated based on the analysis of some ISCs during the analysis process. In some embodiments, uniquely identifying a single individual may comprise comparing a combined set of data comprising about, less than about, or more than about 1, 2, 3, 4, 5, 6, 7, 8, 9, 10, 15, 20, or more points of non-genetic signature information and about, less than about, or more than about 1, 2, 3, 4, 5, 6, 7, 8, 9, 10, 11, 12, 13, 14, 15, 20, 50, 100, or more ISCs, with a stored record containing the same information. In some embodiments, the probability of a person selected at random matching a stored record is about, or smaller than about 10⁻⁵, 10⁻⁶, 10⁻⁷, 10⁻⁸, 10⁻⁹, 10⁻¹⁰, 10⁻¹¹, 10⁻¹², 10⁻¹³, 10⁻¹⁴, 10⁻¹⁵, or smaller. In general, when the probability is lower than a specified threshold, the match is indicative of an individual's identity.

In some embodiments, the electronic bits may be stored as binary codes of information. Alternatively, the electronic bits may be stored as a string, alphanumeric string, hashed function, or any other type of information representative of the genetic signature. The system may perform one or more algorithm, calculation, hash, on sequenced genetic information, thereby providing the identifier. Alternatively, the identifier may be raw data representative of the sequenced genetic information that may not require an algorithm, calculation, or hash.

The additional information may include any other type of information associated with a subject. This may include but is not limited to a subject's name, date of birth, social security number, address, telephone number, email address, credit card information, gender, height, weight, eye color, finger prints, retinal image, voice recordings, driver's license information, passport information, health insurance/payer coverage, medical records, financial records, legal identity records, travel records, access records, education records, employment records, or any other information associated with the subject.

Examples of medical records may include but are not limited to data collected from past medical tests and/or visits, analyte levels, notes relating to the subject's health and/or medical conditions, lifestyle information, fitness or exercise information, dietary or nutritional information, vaccination information, emergency information, medical history, family medical history, family tree, genetic data, diagnoses, treatments, prescriptions, medications, conditions to monitor, health insurance or other payer information, or any other medical and/or health related information. A subject's medical records may also include the subject's name, date of birth, address, telephone number, email address, analyte levels, financial records, and/or payer records. The medical records may include health insurance information which may include items covered, degree of coverage, how/when the insurance has been used, insurance premiums, payments made or outstanding, or any other health insurance information. Some examples of medical records may pertain to laboratory test results, device test results, health information or data (e.g., information about the state of a subject's health whether it be normal or otherwise), pharmacy records used at a pharmacy location, electronic medical records used in a physician's location, hospital records, information collected on an ambulance, medical records tagged with a genetic signature, information collected for occupational screening, or any other information.

Examples of financial records may include but are not limited to data relating to the subject's bank records, mortgages, loans, credit information, credit card information, spending habits, donations, savings, assets, investments, expenditures, funds, interactions with financial institutions, credit card information, debit card information, ATM information, access information, or any other type of financial information. Financial information may include information related to monetary aspects of health insurance, such as insurance premiums, copayments, payments disbursed by the insurance company, or payments made to the insurance company.

Examples of legal identity records may include but are not limited to data relating to the subject's driver's license information, passport information, birth certification information, social security information, or any other type of legal identification information. The systems and methods described herein may be relied upon for legal identification purposes. For example, for situations that may typically require an individual to bring in documentation identifying the individual (e.g., passports, drivers' licenses, birth certificates, social security cards, or any other identifying information), an individual may be identified through the systems and methods described herein. The legal identity records may be used in procedures that may require an individual's legal identification—e.g., travel, job application processes, interactions with financial institutions, or interactions with educational institutions. The legal identity information may be used in one or more legal proceeding. The legal identity information may be used to provide access to one or more location, device, and/or information, such as a secured location, device, and/or information.

An example of a record, as illustrated in FIG. 3 includes a genetic identifier indicated by binary bits that are generated based on genetic information about the subject. The record also includes personal information about the subject, such as the subject's name, date of birth, health insurance, and medical data. Any other types of information relating to the subject may also be stored in the record and may be associated with the genetic identifier.

As previously described, a unique identifier may be associated with additional information of the subject. The unique identifier, such a genetic signature or a combination of a genetic signature with another metric (e.g., biometrics, physiological information, analyte (e.g., protein) levels), may be used as an index for records relating to the subject. The records may be searchable or ordered based on the unique identifier, such as the genetic signature.

The system may be documented to prevent cross contamination of one specimen with another or by amplification products made from another person's DNA. The system may track the sample within the device and/or any sample processing that may occur within the device. The system may track the detectable signals generated from the device and transmitted from the device. The system may also be documented and/or track genetic signature information that is generated and/or associated with additional data. The system may be capable of tracking genetic signatures and/or other identifiers described herein as they are used in medical records.

The system may provide a cradle-to-grave health care system. For examples, newborns may be entered into the system at birth and their medical records may be able to follow them throughout their life. Traditionally, medical records may be kept by doctors and if a patient moves or switches physicians, the medical records may be lost. However, the system as provided herein utilizing a genetic signature may permit medical records to not be lost but remain associated with the patient. This may also be useful for individuals with mental impairment. Such lifelong records may also be useful for a national database, such as for organ transplants.

Generating a Genetic Signature

Systems and methods may be useful for the generation of a genetic signature. The genetic signature may be used as a unique identifier, or may be incorporated as part of a unique identifier.

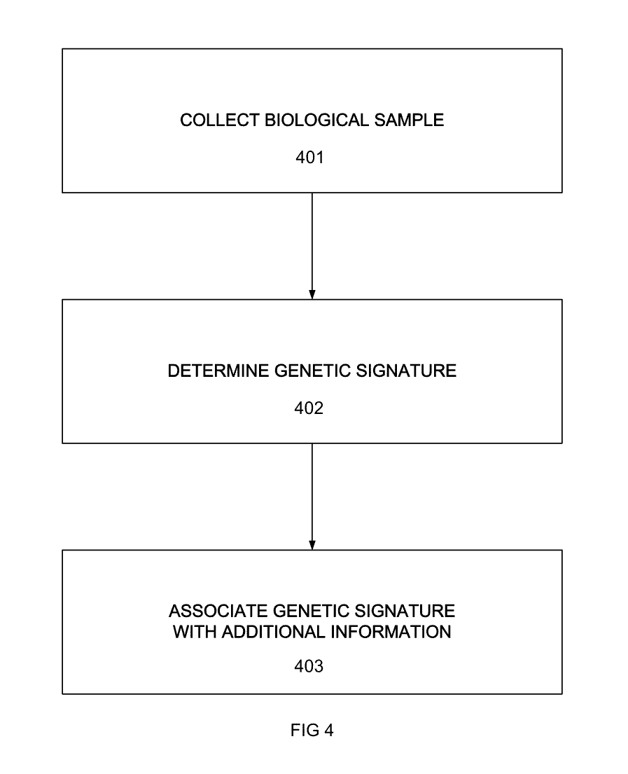

FIG. 4 shows an example of a method of generating a genetic signature. The method can include collecting a biological sample from a subject 401, determining a genetic signature 402 based on the collected biological sample, and associating the genetic signature with additional information 403 about the subject. A method of generating a genetic signature may include receiving a sample, processing a sample, detecting one or more signals related to said processing of the sample, and/or transmitting information relating to the detected signals. The receiving, processing, detecting, and transmitting steps may occur by use of a sample processing device. The method may also include generating a genetic signature based on the sample. This may include conducting nucleic acid amplification of at least a portion of the sample, and/or sequencing the genes of the sample. This may occur on-board the sample processing device, or external to the device. The nucleic acid amplification may occur on-board the sample processing device or external to the device. Genetic (or gene) sequencing may occur on-board the sample processing device or external to the device. A genetic signature may be generated based on the sequenced genes on-board the device or external to the device. The genetic signature may be associated with additional information. Such association may occur on-board the sample processing device, or external to the device.

In some embodiments, determining the genetic signature 402 of the sample comprises determining the genetic (e.g., DNA) sequence of the sample. Genetic sequencing can be carried out by any of a variety of sequencing devices, systems and methods, such as by massively parallel sequencing platforms, including, but not limited to, Roche/454 (pyrosequencing), Illumina (e.g. Genome Analyzer, HySeq), Life Technologies (e.g. SOLiD), Pacific Biosciences (e.g., single molecule sequencing), Ion Torrent (FET/chemFET based sequencing), Complete Genomics, Nanopore, and Helicos.

In some embodiments, the massively parallel sequencing platform produces at least about 75 base pairs (bp) from a single end read. In some embodiments, the massively parallel sequencing platform produces at least about 100, 150, 200, 300, 400, 500, 600, 800, 900, 1000, 1200, 1300, 1400, or 1500 bp from a single end read.

In some embodiments, additional sequences are added to each member of a pool of polynucleotides prior to sequencing. In some situations, one or more barcode sequences are ligated to each polynucleotide of the pool. A barcode is useful in providing an identifying element to a sequence, such as, for example, species identification or confirmation of the connection of one end of a linear polynucleotide to its other end.

In some embodiments, one or more adapters are ligated to each polynucleotide of the pool. Adapters may facilitate amplification of a polynucleotide using universal PCR primers. A barcode or adapter may be less than about 5, 6, 7, 8, 9, 10, 12, 15, 16, 18, 20, 25, 30, 35, 40, 45, or 50 bp in length.

In some embodiments, a sequencing platform is a massively parallel sequencing platform that produces at least 75 bp from a single end read. In some embodiments, the massively parallel sequencing platform produces at least 100, 150, 200, 300, 400, 500, 600, 700, 800, 900, 1000, 1100, 1200, 1300, 1400, 1500, or more than 2000 bp from a single end read.

A methodology useful in determining the genetic sequence 402 of the sample is based on massively parallel sequencing of thousands or millions of fragments using attachment of randomly fragmented genomic DNA to a planar, optically transparent surface and solid phase amplification to create a high density sequencing flow cell with millions of clusters, each containing about 1,000 copies of template per square cm. The surface may be a bead surface or the surface of a flow cell. These templates are sequenced using four-color DNA sequencing-by-synthesis technology, such as using, for example, products or methods offered by Illumina, Inc., San Diego Calif. Also, see U.S. Patent Publication No. 2003/0022207 to Balasubramanian et al., published Jan. 30, 2003 (“Arrayed polynucleotides and their use in genome analysis”), which is entirely incorporated herein by reference. Using such methods, two unique adapters are ligated to each DNA fragment, which are then amplified using PCR.

In some cases, in the process of bridge amplification the flow cell surface can be coated with single stranded oligonucleotides that correspond to the sequences of the adapters ligated during the sample preparation stage. Single-stranded, adapter-ligated fragments can be bound to the surface of the flow cell exposed to reagents for polymerase-based extension. Priming occurs as the free/distal end of a ligated fragment “bridges” to a complementary oligonucleotide on the surface. Repeated denaturation and extension results in localized amplification of single molecules in millions of unique locations across the flow cell surface. A flow cell containing millions of unique clusters is then loaded into a sequencing device for automated cycles of extension and imaging. The first cycle of sequencing includes the incorporation of a single fluorescent nucleotide, followed by high resolution imaging of the entire flow cell. These images represent the data collected for the first base. Any signal above background identifies the physical location of a cluster, and the fluorescent emission identifies which of the four bases was incorporated at that position. This cycle can be repeated, one base at a time, generating a series of images each representing a single base extension at a specific cluster. The images can be captured using a camera, such as a charge coupled device (CCD) camera, or a so-called lens-less camera (e.g., Frankencamera). Base calls are derived with an algorithm that identifies the emission color over time.

In some cases, in paired-end sequencing a simple modification to the standard single-read DNA library preparation facilitates reading both the forward and reverse template strands of each cluster during one paired-end read. In some embodiments, the massively parallel sequencing platform produces at least about 150, 200, 300, 400, 500, 600, 700, 800, 900, 1000, 1100, 1200, 1300, 1400, 1500, 2000, 3000, 5000, or more than 10,000 bp from a paired-end read.

In some embodiments, DNA polymerase may be employed to image sequence information in a single DNA template as its complementary strand is synthesized. The nucleotides are inserted sequentially; only the time resolution to discriminate successive incorporations is required. After each successful incorporation event, a fluorescent signal is measured and then nulled by photobleaching. This method may lend itself to massive parallelism. This technique may permit observations of single molecule fluorescence by a conventional microscope equipped with total internal reflection illumination, which reduces background fluorescence. The surface of a quartz slide is chemically treated to specifically anchor DNA templates while preventing nonspecific binding of free nucleotides and a plastic flow cell is attached to the surface to exchange solutions. DNA template oligonucleotides are hybridized to fluorescently labeled primers and bound to the surface via streptavidin and biotin with a surface density low enough to resolve single molecules. The primed templates are detected through their fluorescent tags, their locations are recorded for future reference, and the tags are photobleached. Labeled nucleotide triphosphates and DNA polymerase enzyme are then washed in and out of the flow cell while the known locations of the DNA templates are monitored for the appearance of fluorescence. The technique uses a combination of evanescent wave microscopy and single-pair fluorescence resonance energy transfer (spFRET) to reject unwanted noise. The donor fluorophore excites acceptors only within the Forster radius, thus effectively creating an extremely high-resolution near-field source. Because the Forster radius of this fluorophore pair is 5 nm, the spatial resolution of this method exceeds the diffraction limit by a factor of 50 and conventional near-field microscopy by an order of magnitude.

Another method of determining the identity of genomic DNA from the present samples is termed direct linear analysis (DLA), and is described in Chan et al. “DNA Mapping Using Microfluidic Stretching and Single-Molecule Detection of Fluorescent Site-Specific Tags,” Genome Research 14:1137-1146 (2004), which is entirely incorporated herein by reference. In this method, a microfluidic device, such as a device provided in systems described herein, is used for stretching DNA molecules in elongational flow that is coupled to a multicolor detection system capable of single fluorophore sensitivity. Double-stranded DNA molecules are tagged at sequence-specific motif sites with fluorescent bisPNA (Peptide Nucleic Acid) tags. The DNA molecules are then stretched in the microfluidic device and driven in a flow stream past confocal fluorescence detectors. DLA can provide the spatial locations of multiple specific sequence motifs along individual DNA molecules, and thousands of individual molecules can be analyzed per minute.

In some embodiments, determining the genetic signature 402 includes using high throughput sequencing, which can involve sequencing-by-synthesis, sequencing-by-ligation, and ultra deep sequencing. Sequence-by-synthesis can be initiated using sequencing primers complementary to the sequencing element on the nucleic acid tags. The method involves detecting the identity of each nucleotide immediately after (substantially real-time) or upon (real-time) the incorporation of a labeled nucleotide or nucleotide analog into a growing strand of a complementary nucleic acid sequence in a polymerase reaction. After the successful incorporation of a label nucleotide, a signal is measured and then nulled by methods known in the art. Examples of sequence-by-synthesis methods are described in U.S. Patent Publication Nos. 2003/0044781, 2006/0024711, 2006/0024678 and 2005/0100932, which are entirely incorporated herein by reference. Examples of labels that can be used to label nucleotide or nucleotide analogs for sequencing-by-synthesis include, but are not limited to, chromophores, fluorescent moieties, enzymes, antigens, heavy metal, magnetic probes, dyes, phosphorescent groups, radioactive materials, chemiluminescent moieties, scattering or fluorescent nanoparticles, Raman signal generating moieties, and electrochemical detection moieties. Sequencing-by-synthesis can generate at least about 1,000, at least 5,000, at least 10,000, at least 20,000, 30,000, at least 40,000, at least 50,000, at least 100,000 or at least 500,000 reads per hour. Such reads can have at least 50, at least 60, at least 70, at least 80, at least 90, at least 100, at least 120 or at least 150 bases per read.

In some cases, another sequencing method involves hybridizing the amplified regions to a primer complementary to the sequence element in an LST. This hybridization complex is incubated with a polymerase, ATP sulfurylase, luciferase, apyrase, and the substrates luciferin and adenosine 5′ phosphosulfate. Next, deoxynucleotide triphosphates corresponding to the bases A, C, G, and T (U) are added sequentially. Each base incorporation is accompanied by release of pyrophosphate, converted to ATP by sulfurylase, which drives synthesis of oxyluciferin and the release of visible light. Since pyrophosphate release is equimolar with the number of incorporated bases, the light given off is proportional to the number of nucleotides adding in any one step. The process is repeated until the entire sequence is determined. Yet another sequencing method involves a four-color sequencing by ligation scheme (degenerate ligation), which involves hybridizing an anchor primer to one of four positions. Then an enzymatic ligation reaction of the anchor primer to a population of degenerate nonamers that are labeled with fluorescent dyes is performed. At any given cycle, the population of nonamers that is used is structure such that the identity of one of its positions is correlated with the identity of the fluorophore attached to that nonamer. To the extent that the ligase discriminates for complementarily at that queried position, the fluorescent signal allows the inference of the identity of the base. After performing the ligation and four-color imaging, the anchor primer:nonamer complexes are stripped and a new cycle begins. Methods to image sequence information after performing ligation are known in the art.

In some embodiments, the genetic sequence 402 of the sample is determined using waveguides, such as zero-mode waveguides. The method may be as described in U.S. Pat. No. 7,056,661, which is entirely incorporated herein by reference. In some cases, the method involves providing a complex of a nucleic acid polymerizing enzyme and a target nucleic acid molecule oriented with respect to each other in a position suitable to add a nucleotide analog at an active site complementary to the target nucleic acid. A plurality of types of nucleotide analogs are provided proximate to the active site, where each type of nucleotide analog is complementary to a different nucleotide in the target nucleic acid, leaving the added nucleotide analog ready for subsequent addition of nucleotide analogs. The nucleotide analog added at the active site as a result of the polymerizing step is identified. The steps of providing a plurality of nucleotide analogs, polymerizing, and identifying are repeated so that the sequence of the target nucleic acid is determined. The zero-mode waveguide is used to carry out the step of identifying the nucleotide analog added to the target nucleic acid.

In some embodiments, high throughput sequencing involves the use of ultra-deep sequencing, as described in, for example, Marguiles et al., Nature 437 (7057): 376-80 (2005), which is entirely incorporated herein by reference. Briefly, the amplicons are diluted and mixed with beads such that each bead captures a single molecule of the amplified material. The DNA molecule on each bead is then amplified to generate millions of copies of the sequence which all remain bound to the bead. Such amplification can occur by PCR. Each bead can be placed in a separate well, which can be a (optionally addressable) picoliter-sized well. In some embodiments, each bead is captured within a droplet of a PCR reaction-mixture-in-oil emulsion and PCR amplification occurs within each droplet. The amplification on the bead results in each bead carrying at least one million, at least about 5 million, or at least 10 million copies of the original amplicon coupled to it. The beads are then placed into a highly parallel sequencing-by-synthesis machine which generates over 400,000 reads (−100 by per read) in a single 4 hour run. Other methods for ultra-deep sequencing that can be used are described in Hong, S, et al. Nat. Biotechnol. 22(4): 435-9 (2004); Bennett, B. et al. Pharmacogenomics 6(4):373-82 (2005); Shendure, P. et al. Science 309 (5741):1728-32 (2005), which are entirely incorporated herein by reference.

In other embodiments, determining the genetic signature 402 of the sample comprises short tandem repeat (STR) analysis. The analysis is performed by extracting nuclear DNA from the cells of a sample of interest, then amplifying specific polymorphic regions of the extracted DNA using polymerase chain reaction. Next, the amplified sequences are resolved either through gel electrophoresis or capillary electrophoresis, which will enable a determination as to the number of repeats of the STR sequence.

In some cases, if the DNA has been resolved by gel electrophoresis, the DNA can be visualized either by silver staining (low sensitivity, safe, inexpensive), or an intercalating dye such as ethidium bromide (fairly sensitive, moderate health risks, inexpensive), or as most modern forensics labs use, fluorescent dyes (highly sensitive, safe, expensive). Instruments built to resolve DNA fragments by capillary electrophoresis may also use fluorescent dyes.

The genetic sequencing methods described herein can be implemented in a system for collecting and processing a biological sample. In some situations, the system includes a processing module for sequencing a sample collected from a subject. The processing module can include, for example, an array of field effect transistors for ion-sensitive field effect transistor based sequencing or a zero-mode waveguide for use with methods described above, to name a few examples.

There are various approaches for collecting a biological sample from the subject 401. In some cases, a sample can be received by a system. The sample may be provided by a subject. The sample may be a biological sample of the subject. The sample may be received by a sample processing device. The sample may be directly collected by the sample processing device or may be collected from the subject external to the device. The subject may be present at the device when the sample is provided to the device. Alternatively, the subject need not be present when the sample is received by the device. The sample may be provided fresh from the subject without any pre-processing to the device.

In some embodiments, one or more security procedure may be implemented to ensure that a sample comes from a particular subject. In one example, a sample processing device may have one or more cameras, or other sensors described herein to ensure that the subject is tendering the subject's own biological sample to a sample processing device. For example, one or more cameras may be provided at one or more location in the device to capture the subject's face and/or simultaneously capture an image of the subject's finger contacting a lancet that may draw the sample into the device. In another example, both multiple types of sensors may be utilized to verify sample collection, such as a camera that captures an image of a finger being pricked, and a thermal imager that ensures that the finger is the subject's actual finger emitting an expected body heat and not a prosthetic with a blood reservoir therein. In one example, a temperature sensor may be within the device to measure the temperature of a bodily fluid sample provided to the device. For example, a fresh sample provided from a subject may be expected to be warm within a certain temperature range, while a sample that has been pre-collected and later transmitted to the device may have cooled down. In another example, a sensor may be within the device to measure the pulse of the finger from which the sample is being collected, ensuring that the finger is the subject's actual finger emitting a pulse and not a prosthetic with a blood reservoir therein. The additional sensors may collect biometric and/or physiological information about the subject that may be used in conjunction with the sample, to further verify that the individual tendering the sample is the subject from whom the sample was collected. Any combination of biometric and/or physiological information described elsewhere herein may be utilized in the collection of the sample.

The one or more security procedure may assist with preventing or reducing the likelihood of identity fraud. Biological samples containing DNA may run the risk of being expropriated. Methods establishing a chain of custody analogous to that used in forensic evidence collection may be used. An authorized professional may be able to document that a specimen was collected from a specific individual, and that the specimen was not contaminated and was under secure possession up to and including genetic analysis. The one or more security procedure may be used to provide confirmation and/or evidence that the analyzed sample was collected from a specific individual. Human review or oversight of the security procedures may also be provided.

A single sample may be collected from the subject. In some instances, the sample collected from the subject may be randomly selected. For example, sometimes the subject's blood may be collected, while at other times, the subject's finger nail clippings, hair, saliva, skin cells, or any other type of sample described elsewhere herein, may be collected. The random selection of sample may make it difficult for an individual to falsify a sample (e.g., take someone else's sample) to be provided to a sample processing device ahead of time.

Alternatively, multiple samples may be collected from the subject. Multiple types of samples may be collected from a subject. For example, the subject's blood, hair, and fingernail clippings may all be rendered to the device. Which of the multiple samples may be collected may be randomly selected. Requiring more types of samples and/or making a random selection of sample type may make it more difficult to falsify a sample to be provided to the sample processing device ahead of time.

Additional information may be collected from the individual tendering the sample at the device. For example, the individual may need to answer one or more questions or provide a password or identification card.

The device may process the sample. The device may perform one or more sample preparation step, assay step, and/or detection step. Examples of preparation and/or assay steps may include one or more of the steps described elsewhere herein.

In some embodiments, processing a sample may include performing nucleic acid amplification of the sample. Nucleic acid amplification may be performed in conjunction with one or more additional assay procedure on the device. For example, both a nucleic acid amplification and immunoassay may be run on the device using one or more portion of the received sample. The device may perform the nucleic acid amplification as well as one or more additional sample preparation step, assay step, and/or detection step. The nucleic acid amplification may be performed prior to, concurrently with, and/or subsequently to one or more additional sample preparation step, assay step, and/or detection step.

A sample from a subject may be used to determine the genetic signature of the subject. In general, a genetic signature is any combination of any number of identifying sequence characteristics (ISCs) that serve as a basis of comparing two or more samples. ISCs may be determined for amplified nucleic acids, unamplified nucleic acids, or combinations of these. Nucleic acids useful in the formation of a genetic signature include DNA, cDNA, genomic DNA, mitochondrial DNA, pathogenic DNA, RNA, mRNA, tRNA, miRNA, piRNA, and other DNA transcription products, either alone or in any combination. ISCs that form part of a particular genetic signature may be identified by any suitable means known in the art, including but not limited to probe hybridization methods and sequencing. Nucleic acid amplification for subject identification may comprise sequential, parallel, or simultaneous amplification of a plurality of nucleic acid sequences, such as about, less than about, or more than about 10, 11, 12, 13, 14, 15, 16, 17, 18, 20, 25, 30, 35, 40, 50, 100, or more target sequences. In some embodiments, a subject's entire genome or entire transcriptome is non-specifically amplified, the products of which are probed for one or more ISCs.

An ISC includes any feature of a nucleic acid sequence that can serve as a basis of differentiation between individuals. A variety of ISCs useful in the identification of an individual, especially by way of comparing a reference sample with a test sample, are known in the art. Examples of ISCs include Restriction Fragment Length Polymorphisms (RFLP; Botstein, et al., Am. J. Hum. Genet. 32: 314-331, 1980; WO 90/13668), Single Nucleotide Polymorphisms (SNPs; Kwok, et al., Genomics 31: 123-126, 1996), Randomly Amplified Polymorphic DNA (RAPD; Williams, et al., Nucl. Acids Res. 18: 6531-6535, 1990), Simple Sequence Repeats (SSRs; Zhao & Kochert, Plant Mol. Biol. 21: 607-614, 1993; Zietkiewicz, et al. Genomics 20: 176-183, 1989), Amplified Fragment Length Polymorphisms (AFLP; Vos, et al., Nucl. Acids Res. 21: 4407-4414, 1995), Short Tandem Repeats (STRs), Variable Number of Tandem Repeats (VNTR), microsatellites (Tautz, Nucl. Acids. Res. 17: 6463-6471, 1989; Weber and May, Am. J. Hum. Genet. 44: 388-396, 1989), Inter-Retrotransposon Amplified Polymorphism (IRAP), Long Interspersed Elements (LINE), Long Tandem Repeats (LTR), Mobile Elements (ME), Retrotransposon Microsatellite Amplified Polymorphisms (REMAP), Retrotransposon-Based Insertion Polymorphisms (RBIP), Short Interspersed Elements (SINE), and Sequence Specific Amplified Polymorphism (SSAP). Additional examples of ISCs are known in the art, for example in US20030170705, U.S. Pat. No. 7,734,656, and US20080027756, which are entirely incorporated herein by reference. A genetic signature may comprise multiple ISCs of a single type (e.g. SNPs), or may comprise a combination of two or more different types of ISCs in any number or combination.

The degree of certainty with which it may be determined that a test sample is derived from the same individual as a reference sample depends on a number of factors, including the number of ISCs used as part of a genetic signature, the degree of independence of each ISC from one another, and the frequency of each ISC in the population. Information useful in calculating a degree of certainty of identification by genetic signature is available and/or derivable from a number of database repositories known in the art, many of which are maintained by private companies, universities, consortiums, and government agencies. Examples of databases known in the art include: dbSNP (Akey et al., Genome Res (2002) 12:1805-1814; www.ncbi.nlm.nih.gov/projects/SNP); the International HapMap Project (hapmap.ncbi.nlm.nih.gov/index.html.en); and the National DNA Index System (NDIS), a database of genetic signatures maintained by the FBI for use in the criminal justice system. In the criminal justice system, it is common to rely on just 13 ISCs for the identification of a genetic signature as belonging to the same individual as provided a test sample. Furthermore, it has been estimated that as few as 30-80 statistically independent SNPs are sufficient to uniquely identify a single human subject from among the entire global population. A description of how SNPs in particular may be used in the determination of the uniqueness of a genetic signature is provided by Lin et al. (Science 305: 183, 2004), which is incorporated herein by reference, along with supplemental materials associated therewith. Similar calculations may be performed using similar population genetics information for other types of ISCs. In some embodiments, an individual is uniquely identified to a selected statistical significance using about, less than about, or more than about 10, 11, 12, 13, 14, 15, 20, 25, 30, 35, 40, 50, 100, or more ISCs. In some embodiments, statistical significance is expressed as the probability that an individual selected at random would have the same genetic signature as a reference sample. In some embodiments, the statistical significance is about, or smaller than about 10⁻², 10⁻³, 10⁻⁴, 10⁻⁵, 10⁻⁶, 10⁻⁷, 10⁻⁸, 10⁻⁹, 10⁻¹⁰, 10⁻¹¹, 10⁻¹², 10⁻¹³, 10⁻¹⁴, 10⁻¹⁵, or smaller.

In general, identification is accomplished by comparing the genetic signature of a test sample from a subject to the genetic signature of a reference sample. In some embodiments, the reference sample may be of unknown origin, such as a biological sample discovered after depositing by a subject not yet identified, for example at a crime scene. In some embodiments, the reference sample is a sample collected from a known subject. The subject providing the reference sample may or may not be the same individual as provides the test sample. In some embodiments, a subject provides a reference sample at a first point in time and further provides a test sample at a second point in time. The test sample and the reference sample may be processed to generate a genetic signature for each in parallel, or at different times. In some embodiments, the genetic signature of the reference sample is stored in a database and is used for the basis of comparison with the genetic signature of a test sample.

In some embodiments, the genetic signature of a test sample is compared against a plurality of genetic signatures in a database. The database may comprise signatures from about, or more than about 100, 500, 1000, 5000, 10000, 20000, 30000, 40000, 50000, 1×10⁶, 5×10⁶, 1×10⁷, 5×10⁷, 1×10⁸, 5×10⁸, 1×10⁹, 5×10⁹, 1×10¹⁰, or more individuals. Results of comparison may be given in terms of degree, percent, or likelihood of match or identity. Results of comparison may be given in terms of degree, percent, or likelihood of relatedness. In some embodiments, degree of match is measured as a percentage of matching ISC's, such as about, less than about, or more than about 1%, 2%, 3%, 4%, 5%, 6%, 7%, 8%, 9%, 10%, 20%, 30%, 40%, 50%, 60%, 70%, 80%, 90%, 95%, 99%, or more matching ISCs.

Genetic signatures can be used in any process requiring the identification of one or more subjects, such as in paternity or maternity testing, in immigration and inheritance disputes, in breeding tests in animals, in zygosity testing in twins, in tests for inbreeding in humans and animals; in evaluation of transplant suitability such as with bone marrow transplants; in identification of human and animal remains; in quality control of cultured cells; in forensic testing such as forensic analysis of semen samples, blood stains, and other biological materials; in characterization of the genetic makeup of a tumor by testing for loss of heterozygosity; and in confirming the identity of a subject providing a test sample as being the same individual as provided a past reference sample. Samples useful in the generation of a genetics signature include evidence from a crime scene, blood, blood stains, semen, semen stains, bone, teeth, hair, saliva, urine, feces, fingernails, muscle or other soft tissue, cigarettes, stamps, envelopes, dandruff, fingerprints, items containing any of these, and combinations thereof. In some embodiments, two or more genetic signatures are generated and compared. In some embodiments, one or more genetics signatures are compared to one or more known genetic signatures, such as genetic signatures contained in a database.

In some embodiments, the device extracts a nucleic acid to be analyzed from the sample provided. Methods for the extraction of nucleic acid are known in the art, examples of which are described in Sambrook, Fritsch & Maniatis, Molecular Cloning, A Laboratory Manual, 3rd edition, CSHL Press, 2001, incorporated herein by reference. In general, cells in a sample are lysed to release nucleic acid. In some embodiments, lysis is achieved chemically, sonically, and/or enzymatically. Nucleic acids released by lysis may be analyzed or amplified without purification. In some embodiments, released nucleic acids are purified before further manipulation. In some embodiments, purification comprises binding specific or non-specific binding of a target nucleic acid to a solid surface, such as the inside of a tip or to a bead. Bound nucleic acids may be washed, and manipulated in a purified state with or without release from the solid substrate.

In some embodiments, the genetic signature is determined for a sample from which nucleic acid has been amplified. Any method for the amplification of nucleic acids may be used with the systems and methods provided herein. Various methods for the amplification of nucleic acids, including DNA and/or RNA, are known in the art. Amplification methods may be enzymatic, using one or more enzymes in one or more steps of an amplification process. Amplification methods may be non-enzymatic, using no enzymes in any of the steps of an amplification process. Amplification methods may involve changes in temperature, such as a heat denaturation step, or may be isothermal processes that do not require heat denaturation. The polymerase chain reaction (PCR) uses multiple cycles of denaturation, annealing of primer pairs to opposite strands, and primer extension to exponentially increase copy numbers of the target sequence. Denaturation of annealed nucleic acid strands may be achieved by the application of heat, increasing local metal ion concentrations (e.g. U.S. Pat. No. 6,277,605), ultrasound radiation (e.g. WO/2000/049176), application of voltage (e.g. U.S. Pat. No. 5,527,670, U.S. Pat. No. 6,033,850, U.S. Pat. No. 5,939,291, and U.S. Pat. No. 6,333,157), and application of an electromagnetic field in combination with primers bound to a magnetically-responsive material (e.g. U.S. Pat. No. 5,545,540), which references are hereby incorporated herein by reference in their entirety for all purposes. In a variation called RT-PCR, reverse transcriptase (RT) is used to make a complementary DNA (cDNA) from RNA, and the cDNA is then amplified by PCR to produce multiple copies of DNA (e.g. U.S. Pat. No. 5,322,770 and U.S. Pat. No. 5,310,652, which are hereby incorporated herein by reference in their entirety).

One example of an isothermal amplification method is strand displacement amplification, commonly referred to as SDA, which uses cycles of annealing pairs of primer sequences to opposite strands of a target sequence, primer extension in the presence of a dNTP to produce a duplex hemiphosphorothioated primer extension product, endonuclease-mediated nicking of a hemimodified restriction endonuclease recognition site, and polymerase-mediated primer extension from the 3′ end of the nick to displace an existing strand and produce a strand for the next round of primer annealing, nicking and strand displacement, resulting in geometric amplification of product (e.g. U.S. Pat. No. 5,270,184 and U.S. Pat. No. 5,455,166, which are hereby incorporated herein by reference in their entirety). Thermophilic SDA (tSDA) uses thermophilic endonucleases and polymerases at higher temperatures in essentially the same method (European Patent No. 0 684 315, which is hereby incorporated herein by reference in its entirety for all purposes).

Other amplification methods include rolling circle amplification (RCA) (e.g., Lizardi, “Rolling Circle Replication Reporter Systems,” U.S. Pat. No. 5,854,033); helicase dependent amplification (HDA) (e.g., Kong et al., “Helicase Dependent Amplification Nucleic Acids,” U.S. Pat. Appln. Pub. No. US 2004-0058378 A1); and loop-mediated isothermal amplification (LAMP) (e.g., Notomi et al., “Process for Synthesizing Nucleic Acid,” U.S. Pat. No. 6,410,278), which are hereby incorporated herein by reference in their entirety for all purposes. In some cases, isothermal amplification utilizes transcription by an RNA polymerase from a promoter sequence, such as may be incorporated into an oligonucleotide primer. Transcription-based amplification methods commonly used in the art include nucleic acid sequence based amplification, also referred to as NASBA (e.g. U.S. Pat. No. 5,130,238); methods which rely on the use of an RNA replicase to amplify the probe molecule itself, commonly referred to as Qβ replicase (e.g., Lizardi, P. et al. (1988) BioTechnol. 6, 1197-1202); self-sustained sequence replication (e.g., Guatelli, J. et al. (1990) Proc. Natl. Acad. Sci. USA 87, 1874-1878; Landgren (1993) Trends in Genetics 9, 199-202; and HELEN H. LEE et al., NUCLEIC ACID AMPLIFICATION TECHNOLOGIES (1997)); and methods for generating additional transcription templates (e.g. U.S. Pat. No. 5,480,784 and U.S. Pat. No. 5,399,491), which references are hereby incorporated herein by reference in their entirety for all purposes. Further methods of isothermal nucleic acid amplification include the use of primers containing non-canonical nucleotides (e.g. uracil or RNA nucleotides) in combination with an enzyme that cleaves nucleic acids at the non-canonical nucleotides (e.g. DNA glycosylase or RNaseH) to expose binding sites for additional primers (e.g. U.S. Pat. No. 6,251,639, U.S. Pat. No. 6,946,251, and U.S. Pat. No. 7,824,890, which are all hereby incorporated herein by reference in their entirety for all purposes). Isothermal amplification processes can be linear or exponential. Amplification processes may include the use of probes for the detection of one or more ISCs concurrent with the amplification process (e.g. U.S. Pat. No. 5,538,848, fully incorporated herein by reference for all purposes).

An example process for isothermally amplifying a target sequence using partially degradable primers comprising one or more non-canonical nucleotides (e.g. uracil or other RNA base) may proceed as follows. A first primer comprising a 5′ portion containing one or more non-canonical nucleotides and a 3′ end complementary to a portion of the target sequence is hybridized to the target sequence. The first primer is extended to produce a first extension product. The 5′ portion of the first extension product is then removed or degraded. In some embodiments, degradation or removal is enzymatic, such as by an enzyme that cleaves single-stranded nucleic acids at the non-canonical base positions (e.g. RNaseH cleavage of RNA hybridized to DNA, or hydrolysis of uracil by uracil DNA glycosylase). Another copy of the first primer is then hybridized to the target sequence exposed in the degradation or removal step. Strand invasion and extension of the additional first primer by a strand-displacing polymerase releases the first extension product, and the process is repeated. Amplification using only sample target sequence as template may be used in a linear amplification process. Alternatively, exponential amplification may be achieved using first primer extension products as templates for the extension of a second primer. The second primer may comprise a 5′ portion containing one or more non-canonical nucleotides and a 3′ end complementary to a portion of the first extension product. Repetition of the process used in cyclical extension of first primers may then be applied to extend the second primers to produce multiple second primer extension products. Additional examples of amplification procedures involving partially degradable primers are described in U.S. Pat. No. 6,251,639, U.S. Pat. No. 6,946,251, and U.S. Pat. No. 7,824,890.

Amplification may comprise the joining of two oligonucleotide probes hybridized adjacent to one another along a target nucleic acid of known sequence in a process generally referred to as “ligation.” The adjacent oligonucleotide probes may be joined enzymatically, such as by a ligase, or non-enzymatically, such as by the inclusion of reactive groups on the ends to be joined, or a chemical in the reaction mixture capable of joining free adjacent oligonucleotide ends. The first joined oligonucleotide probes form a first joined amplification product. Dissociation of the first joined amplification product, such as by a denaturation method, frees the target nucleic acid to serve as template for the joining of another pair of oligonucleotide probes. Repeating the joining and release process produces multiple copies of joined amplification products. Many non-enzymatic methods for joining adjacent oligonucleotides are known in the art, and include without limitation the use of coupling agents (e.g. UV radiation, N-cyanoimidazole, cyanogen bromide, and 1-ethyl-3-(3-dimethylaminopropyl)-carbodiimide hydrochloride) and use of pairs of nucleotides having reactive groups that automatically react with one another to form a joined oligonucleotide product. An example of reactive group pair includes, without limitation, a 5′-tosylate or 5′-iodo group on one oligonucleotide for reaction with a 3′-phosphorothioate group on the adjacent oligonucleotide.

In some embodiments, one or both oligonucleotide probes contain a stuffer sequence, or variable spacer sequence, which is designed to have differing lengths for each probe set (i.e. each target sequence) thereby resulting in a ligation product having a target-specific length. Following ligation a defined length oligonucleotide can may be exponentially amplified, such as by PCR or LAMP. In some embodiments, the probes can possess detectable labels (e.g. fluorescent labels, electrochemical labels, magnetic beads, nanoparticles,) to aid in the identification, purification, quantification or detection of the ligated oligonucleotide product. The oligonucleotide probes may also optionally include in their structure: anchoring oligonucleotide sequences designed for subsequent capture on a solid support (e.g. microarrays, microbeads, nanoparticles), molecule handles that promote the concentration or manipulation of the ligated product (e.g. magnetic particles, oligonucleotide coding sequences), and promoter sequences to facilitate subsequent secondary amplification of the ligated product via an enzyme like a DNA or RNA polymerase. In some embodiments, ligation reactions proceed rapidly, are specific for the target(s) of interest, and can produce multiple copies of the ligated product for each target(s), resulting in an amplification of the detectable signal. In general, chemical ligation reactions do not require the presence of exogenously added ligases, nor additional enzymes, although some subsequent reactions may rely on the use of enzymes such as polymerases. Preferred ligation chemistries are ones that can be easily incorporated into routine manufacture techniques, are stable during storage, and demonstrate a large preference for target specific ligation when incorporated into a properly designed ligation probe set. Amplification of the target may also include turnover of the ligation product, in which the ligation product has a lower or comparable affinity for the template or target nucleic acid than do the separate ligation probes. Thus, upon ligation of the hybridized probes, the ligation product is released from the target, freeing the target to serve as a template for a new ligation reaction. Further examples of non-enzymatic amplification strategies are provided in U.S. Pat. No. 7,033,753, U.S. Pat. No. 5,843,650, US20100267585, and US20080124810, which are hereby all incorporated herein by reference in their entirety for all purposes.

Nucleic acid amplification can be rapidly performed with a device disclosed herein. In some embodiments, a nucleic acid process may be completed within 0.1 s or less, 0.5 s or less, 1 s or less, 5 s or less, 10 s or less, 20 s or less, 30 s or less, 45 s or less, 1 min or less, 1 min 30 s or less, 2 min or less, 3 min or less, 4 min or less, 5 min or less, 7 min or less, 10 min or less, 15 min or less, 20 min or less, 30 min or less, 45 min or less, 1 hour or less, 90 min or less, 2 hours or less, 3 hours or less, 5 hours or less, 6 hours or less, 8 hours or less, 12 hours or less, 18 hours or less, 24 hours or less, 36 hours or less, or 48 hours or less of receiving the sample at the device.

The sample processing device may be capable of performing one or more additional sample processing steps. The additional sample processing steps may include one or more sample preparation and/or assay steps. An additional sample processing step may occur prior to, concurrently with, and/or subsequent to an amplification step. The additional sample processing step may utilize the same sample as used in the amplification step or may use a different sample as used in the amplification step. An additional sample processing step may yield one or more signals which may be indicative of a presence and/or concentration of one or more analyte. The signals may or may not be analyzed on board the sample processing device. The signals may be transmitted to an external device which may or may not analyze the signals to yield the presence and/or concentration of the one or more analyte. In some examples, the levels of analytes may include levels of one or more proteins, presence or absence of one or more genetic markers, levels of one or more nucleic acid targets, or the modification state of one or more biomolecules (e.g. nucleic acid modifications such as methylation; protein modifications such as phosphorylation, acetylation, sumoylation; and other modifications known in the art). Such analyte levels may be used for the diagnosis, prognosis, or treatment of a disease of a subject. In some embodiments, such analyte levels may be used for the identification of the subject. The analyte levels may be used in conjunction with a genetic signature of the subject, biometric information of the subject, physiological parameter of the subject, and/or additional information about the subject.

The sample processing device may be capable of performing one or more detection step. In some embodiments, the detection may include detecting one or more signals from an amplification process and/or any other sample processing step. Such detection may occur prior to, concurrently with, or subsequent to the nucleic acid amplification and/or any other sample processing step.

In some embodiments, the detection step may include detecting one or more optical signal relating to the nucleic acid amplification and/or any other sample processing step. Such optical signals may include luminescence, chemiluminescence, fluorescence, phosphorescence, or any other type of visible signal. Such detection may include any other signal along the electromagnetic spectrum including but not limited to visible, UV, infra-red, or far-infrared signals.

In some embodiments, the detection step may include detecting the temperature of the sample or a thermal controller for the sample. Such detected temperatures may be measured in real time, continuously, at fixed intervals, or in response to an event in order to maintain the temperature in a desired range.

The detection step may occur on-board the device. In some embodiments, a sample processing device may receive a sample, perform nucleic acid amplification on the sample, and detect a signal from the nucleic acid amplification on the sample. In some instances, the sample processing device may also perform one or more additional sample processing step on the sample. For example, the sample processing device may perform one or more additional assay of the sample.

One or more detected signal may be transmitted from the device. In some embodiments, data transmitted from the device may be representative of the detected signals, including signals from nucleic acid amplification. The data may be sent as raw data without and pre-processing or analysis. In some embodiments, the data may be sent after some pre-processing (e.g., modifying data format) but without any analysis. In some embodiments, the data may be analyzed on-board the device and transmitted. The transmitted data may or may not be subsequently processed and/or analyzed. The gene may be sequenced on-board the device or external to the device. Transmitted data may include data about sequenced gene portions.

The data may be sent to an external device. Pre-processing and/or analysis of the data may occur on the external device. In some embodiments, analysis may occur on both the sample processing device and the external device. Alternatively, analysis may occur on the sample processing device without occurring on the external device, or analysis may occur on the external device without occurring on the sample processing device.

In some embodiments, analysis may include sequencing one or more portion of the genome representative of the sample. Such sequencing may occur on-board the sample processing device and/or the external device. Such sequencing may occur subsequent to or concurrently with the receipt of the detected signals. Such sequencing may occur immediately after the detected signals or after some time has elapsed from the detection of the signal. Such sequencing may be completed within 0.1 s or less, 0.5 s or less, 1 s or less, 5 s or less, 10 s or less, 20 s or less, 30 s or less, 45 s or less, 1 min or less, 1 min 30 s or less, 2 min or less, 3 min or less, 4 min or less, 5 min or less, 7 min or less, 10 min or less, 15 min or less, 20 min or less, 30 min or less, 45 min or less, 1 hour or less, 90 min or less, 2 hours or less, 3 hours or less, 5 hours or less, 6 hours or less, 8 hours or less, 12 hours or less, 18 hours or less, 24 hours or less, 36 hours or less, or 48 hours or less of detecting said signals. In some embodiments, such sequencing may be completed within any amount of time, including the times mentioned, from receiving the sample at the sample processing device.

A genetic signature may be generated based on the sample. The genetic signature may be generated based on a sample that has undergone nucleic acid amplification. The genetic signature may be generated based on a completely sequenced or partially sequenced genome of the subject, which may be determined based on the received sample. A genetic signature may be generated based on a sample subjected to endonuclease or exonuclease treatment, with or without prior amplification. Endonuclease treatment includes restriction endonuclease treatment, such as may be used in restriction fragment length polymorphism analysis. A sample may be subjected to one or more of such methods, sequentially or simultaneously, and may include separation of a sample into two or more aliquots (e.g. 2, 3, 4, 5, 6, 7, 8, 9, 10, 11, 12, 13, 14, 15, 25, 50, or more aliquots). In some embodiments, a genetic signature comprises two or more different types ISCs, each type determined using a different process.

In some embodiments, the genetic signature may be raw data indicative of the genetic sequence for a subject. The genetic signature need not require any sort of calculation or processing.

Alternatively, the genetic signature may be generated based on a calculation, algorithm, or hash based on the genetic sequence of the subject. The genetic signature may include a computer representation of a biological sample collected from the subject. The computer representation can be based on a calculation, algorithm, hash, or any other type of computer representation. The genetic signature may include bits of data that may be representative of the genetic sequence. The genetic signature may be based on binary code, strings, and/or any other form of data. The genetic signature may be unique for the subject. The genetic signature may be of a sufficient length or complexity to be unique for the subject. The genetic signature may be a hash of a sequenced portion of the sample.

The genetic signature may be generated on-board the sample processing device or may be generated external to the device. In some instances, the genetic signature may be generated at an external device capable of communicating with the sample processing device. The genetic signature may be optionally generated at an external device that is not in communication with the sample processing device. The genetic signature may be generated on a cloud computing based infrastructure. The genetic signature may be transmitted from its generation device. For example, if the genetic signature is generated on-board a sample processing device, it may be transmitted to an external device. If a genetic signature is generated at an external device, it may be transmitted to another external device, or to the sample processing device.

The genetic signature may be generated using a processor. The processor may receive genetic information associated with the subject. The genetic information may be sequenced gene information for the subject. The processor may implement one or more code, logic, or instructions stored in computer readable media, thereby generating the genetic signature.

The generation of the genetic signature may occur quickly. In some instances, the genetic signature may be generated within 0.1 s or less, 0.5 s or less, 1 s or less, 5 s or less, 10 s or less, 20 s or less, 30 s or less, 45 s or less, 1 min or less, 1 min 30 s or less, 2 min or less, 3 min or less, 4 min or less, 5 min or less, 7 min or less, 10 min or less, 15 min or less, 20 min or less, 30 min or less, 45 min or less, 1 hour or less, 90 min or less, 2 hours or less, 3 hours or less, or 5 hours or less of receiving the genetic information for the subject. The genetic signature may be generated within 0.1 s or less, 0.5 s or less, 1 s or less, 5 s or less, 10 s or less, 20 s or less, 30 s or less, 45 s or less, 1 min or less, 1 min 30 s or less, 2 min or less, 3 min or less, 4 min or less, 5 min or less, 7 min or less, 10 min or less, 15 min or less, 20 min or less, 30 min or less, 45 min or less, 1 hour or less, 90 min or less, 2 hours or less, 3 hours or less, 5 hours or less, 6 hours or less, 8 hours or less, 12 hours or less, 18 hours or less, 24 hours or less, 36 hours or less, or 48 hours or less of receiving a sample at a sample processing device.

The genetic signature may be stored in memory. The genetic signature may be stored in one or more database. The genetic signature may be stored in a cloud computing based infrastructure. The one or more database may have a cloud computing infrastructure. The genetic signature may be accessible by one or multiple devices.

Additional information may be associated with the genetic signature. The additional information may include information relating to the subject from whom the sample was collected, and from whom the genetic signature was generated. The additional information may include information as described elsewhere herein. FIG. 3 shows an example of genetic signatures associated with additional information.

One or more data repository may be generated with the genetic signature and the additional information. The genetic signature may provide a key or index for the data repository. In some embodiments, the data repository may be an electronic medical records database. In other embodiments, the data repository may be a financial database. The data repository may also be a database for any other type of health, financial, or identification database including those described elsewhere herein. In some embodiments, the data repository may contain or be affiliated with one database. In some embodiments, the data repository may contain or be affiliated with two, three, or more databases.

In some embodiments, methods of creating a data repository may be provided. Such methods may include associating the genetic signature of a subject with at least one additional piece of information about the subject, wherein the genetic signature is obtained by a biological sample suspected to contain at least one nucleic acid molecule of said subject, and/or generating a genetic signature from said at least one nucleic acid molecule, wherein said genetic signature is indicative of the identity of said subject. The method may also include storing the genetic signature and the additional information in one or more database. The additional information may include identifying information about the subject, medical records of the subject, financial records of the subject, or any other information as described elsewhere herein.

In some embodiments, in a method of creating a data repository containing genetic signatures from multiple subjects, each subject's genetic signature may contain information regarding the same genetic elements of the subject.

The genetic signature may be used as a unique identifier for the associated additional information. For example, the genetic signature may be a unique identifier for an associated medical record. The genetic signature may be a unique identifier for an associated financial record. The genetic signature may be a unique identifier for any information relating to the subject. The genetic signature may form an index of a database comprising information relating to the subject, such as medical or financial records of the subject. The genetic signature may be stored in one or more database and may be associated with additional information in the database, such as medical and/or financial records of the subject.

FIG. 5 shows an example of an identifier, having a plurality of components. An identifier may have at least one static component 501 and/or at least one dynamic component 502. One example of a static component may be a genetic signature 503. Examples of dynamic components may include a dynamic biological signature, such as a proteomic signature 504, metabolomic signature, or any signature that may relate to one or more analyte level of the subject, physiological characteristic of the subject, or personal characteristic of the subject.

A static component of the identifier may be fixed. The static component may not change. For example, a genetic sequence of a subject may be fixed. A dynamic component of the identifier may be changeable. For example, different levels of proteins within a subject may vary. In some instances, the proteomic signature of a subject may change in anticipated manners. In another example, different levels of metabolites within a subject may vary. The metabolomic signature of a subject may change in anticipated manners.

The identifier may be generated based on an algorithm, calculation, logic, hash of the static and/or dynamic components. In some instances, a single identifier may be generated based on the combination of the static and dynamic components. Alternatively, identifier components may be separately generated for the static and dynamic components. The separate identifier components may be associated with one another and/or appended to one another.

In some embodiments, a static component of the identifier may expect to be fixed and/or unchanging. For example, the genetic signature of a subject may be unique and may remain the same for the subject. If the apparent genetic signature of a subject changes, then authentication for the subject may not occur.

The dynamic component of the identifier may be variable, but may be variable in accordance with one or more set of rules. For example, the trend of one or more dynamic component may be predictable with a range. The change in value of the dynamic component, the rate of change of the dynamic component, the rate of the rate of change of the dynamic component, or any other characteristic of the dynamic component may be trended or predicted. In some embodiments, a dynamic component may have a known or predicted trajectory. In one example, a known or predicted trajectory may be based on knowledge in the art about trends. For example, it may be known that the levels of certain proteins may typically change at a certain rate.

A predicted trajectory may be based on knowledge of particular trends. For example, it may be known that as a person gets older, certain analytes may fall within a certain range. Similarly, it may be expected that for certain ages, a person's height may increase at an expected rate.

In some examples, a predicted trajectory may be determined based on a predictive model. The predictive model may take into account data collected with respect to levels, trajectories, trends, rates of change, rates of rates of change of analytes (e.g., proteins, nucleic acids (DNA, RNA, hybrids thereof, mRNA, microRNA, RNAi, EGS, antisense), metabolites, gasses, ions, particles (including crystals), small molecules and metabolites thereof, elements, toxins, enzymes, lipids, carbohydrates, prion, formed elements (e.g., cellular entities (e.g., whole cell, cell debris, cell surface markers)) or additional information such as biometrics (fingerprint, iris or retinal scan, voice, or any others described elsewhere herein) or physiological parameters (e.g., heart rate, blood pressure, height, weight, or any others described elsewhere herein). In some embodiments, the predictive model may take into account data related to indicators of gene expression changes. Indicators of gene expression changes include, but are not limited to, changes in the absolute or relative levels of gene expression products, such as transcription products (e.g. RNA, mRNA, miRNA, piRNA, rRNA) and proteins; chemical modifications of DNA, such as methylation; chemical modifications of histones, such as by methylation, acetylation, and phosphorylation; and changes in the levels of DNA-binding proteins, either in general or at one or more specific loci. DNA binding proteins include, but are not limited to, histones, transcription factors, polymerases, and cell signaling proteins. A feedback of information may assist with fine-tuning the predictive capabilities of the model. Thus, the predictive model may be self-learning.

The predictive model may be directed to an individual based on previous information collected about the individual. For example, the predictive model may take into account how the individual's various analyte levels have fluctuated in the past. In another example the predictive model may take into account the rate at which the individual's height increased in the past. The predictive model may also be directed to a general population or specific groups within a population (e.g., age, gender, disease, family history, specific genetic markers or traits, environment, geographic location, physiological traits (e.g., heart rate, blood pressure), diet, exercise habits, other lifestyle habits, other demographic information). For example, if an individual is a male in his mid-40's who is diabetic, the predictive model may draw on data for other males in their mid-40's who are diabetic. The predictive model may predict the trajectories for one or more analytes for diabetic males in their mid 40's. The predictive model additionally or alternatively may predict the trajectories for one or more analytes based on past measurements for the individual, such as blood glucose and/or glycated hemoglobin in the case of the example diabetic male. Any combinations of groups or factors may be considered in the predictive model. The feedback may be specific to the individual, one or more group, or the general population.

In some instances, the predictive model may take into account how different biological features, such as different analytes, genetic traits, biometrics, and/or physiological parameters may interact with one another. For example, the predictive model may form a prediction that when a first analyte increases in concentration, a second analyte will decrease. In a further example, the predictive model may note that for someone with a first genetic sequence, the increase in the first analyte may correlate with a decrease in the second analyte, while for someone with a second genetic sequence, the increase in the first analyte may correlate with an increase in the second analyte. In another example, the predictive model may form a prediction that if a subject gains weight, an analyte level will increase. Thus, dynamic components may be compared in isolation, or in conjunction with other dynamic components. For example, the two analytes may both be compared against pre-collected analytes to detect whether they fall within the predicted trajectories together (e.g., that if the first analyte level increases, the second analyte level decreases). The predictive model may form interrelationships between one or more biological features. The predictive model may be able to form predictions of increased complexity that may be beyond the realm of standard knowledge of dynamic biological changes.

The predictive model may be software that may predict values, trajectories, rates of changes or rates of rates of changes from the aggregated records. A processor may perform one or more steps for the predictive model.

Certain drastic changes or unpredictable changes may raise a red flag for identification. Additionally, if the levels are expected to change and never change over a long time, this may present a red flag. Acceptable dynamic ranges may be based on magnitude of change, relative degree of change, trending analysis, or any other information. Different dynamic components may be expected to change or not change in different ways.

In some embodiments, a dynamic component may be a dynamic biological signature. A dynamic biological signature may be generated based on a sample from the subject. The same sample may be used to generate the dynamic biological signature and the genetic signature. Alternatively, different samples may be used to generate the dynamic biological signature and the genetic signature. In some instances, multiple samples may be provided, and genetic signatures and/or dynamic biological signatures may be derived from one or more of the multiple samples. For example, a blood sample and a hair sample may be collected. The genetic signatures of both the blood and hair may be generated. The genetic signatures may be compared, and may be determined whether they match. If the genetic signatures match, it may be determined that the blood and hair came from the same individual. In some embodiments, the dynamic biological signatures of both the blood and hair may be generated. The dynamic biological signatures may be compared. In some instances, the dynamic biological signatures may be expected to match if they were taken at the same time. Alternatively, the dynamic biological signatures may be expected to be offset by a certain amount or percentage if they are from different types of samples. In some instances, the dynamic biological signatures may be compared with a pre-collected biological signature to determine whether they fall in a predicted trajectory. Such predicted trajectory may be determined based on sample type.

In some embodiments, predicted trajectories are calculated from one or more previous analyses of one or more analytes. Non-limiting examples of analytes that may be analyzed for the purpose of predicting trajectories for comparison to samples at later time points include proteins, nucleic acids (DNA, RNA, tRNA, miRNA, piRNA, and other DNA transcription products), metabolites, gasses, ions, particles (including crystals), small molecules and metabolites thereof, elements, toxins, enzymes, lipids, carbohydrates, prion, isotopes, drugs, drug metabolites, and formed elements (e.g., cellular entities such as whole cell, cell debris, cell surface markers). In general, the trajectory is calculated for an analyte having a known reference level and a known time-variable component. For example, telomeres, repetitive elements forming the ends of chromosomes, progressively shorten proportional to the rate of cell division in a given tissue, and thus shorten with age. Analysis of telomere length in a given sample type, such as blood, collected at two or more points can be used to establish a rate of decay in the length of an individual's telomeres. Alternatively, a rate can be estimated using a single reference point and a knowledge of general telomere shrink rates. This rate can be used to calculate the anticipated length of telomeres in a similar sample collected from the individual at a later time, within a degree of statistical error. Similar projections may be made for other analytes, levels or characteristics of which may increase, decrease, or cycle in sufficiently predictable fashion to establish a basis for prediction and comparison between past and future samples. In some embodiments, a match between the predicted trajectory of one or more analytes and the level in a test sample is required to establish positive identification of an individual. Trend data may be combined with a genetic signature, and optionally other data, to establish positive identification.

The identifier may be associated with additional information 505. The identifier may be associated with medical and/or financial records of the subject, or any other types of information associated with the subject as described elsewhere herein.

In some embodiments, the identifier may only have a single component. The single component may be a static component. The static component may be a genetic signature. Alternatively, the single component may be a dynamic component. The dynamic component may be a proteomic signature. The identifier may include one, two or more static components, and/or one, two or more dynamic components.

Using a Genetic Signature

An identifier, such as a genetic signature may be useful for identification purposes. A genetic signature may identify a subject. The genetic signature may be a unique identifier for a subject, and may be useful for tracking information about the subject.

In some embodiments, genetic signatures for multiple subjects are prepared using the same genetic elements to generate each subject's genetic signature. For example, for multiple subjects, the same ISCs may be examined for each subject, to generate genetic signatures for multiple subjects which each have the same format/which have information regarding the same elements (but which may contain different alleles/variants at each ISC). In another example, for multiple subjects, the same sections of genomic DNA from each individual may be examined, to generate genetic signatures for multiple subjects which each contain information regarding the same sections of genomic DNA. In some embodiments, in a method or system provided herein, genetic signatures which have the same format/which have information regarding the same genetic elements may be used and/or compared for multiple subjects.

In some embodiments, multiple genetic signatures for a single subject are prepared using the same genetic elements to generate each genetic signature for the subject. For example, if certain ISCs are examined for a subject on one occasion to generate a first genetic signature for the subject, on a second occasion, the same ISCs may be examined to generate a second genetic signature for the subject. In some embodiments, in a method or system provided herein, genetic signatures which have the same format/which have information regarding the same genetic elements may be used and/or compared when working with multiple genetic signatures from a single subject.

Identification, Records Tracking

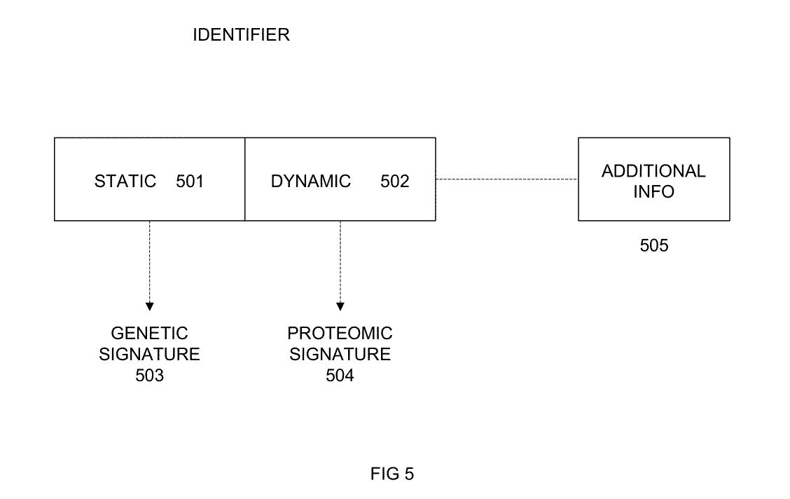

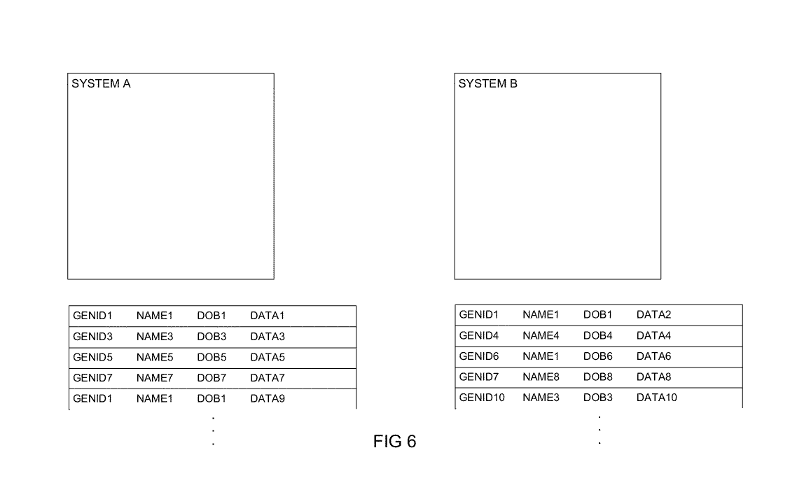

FIG. 6 provides an example of data which may utilize a genetic signature to assist with tracking information about a subject.

A plurality of databases may be provided. In one example a database may include a plurality of records. For example, a database may include records showing GENID1, GENID3, GENID5, GENID7, GENID1, wherein GENID# represents a genetic signature. Additional information may be associated with the genetic signatures. For example, the first instance of GENID1 may be associated with NAME1, DOB1, and DATA1; GENID3 may be associated with NAME3, DOB3, and DATA3; GENID5 may be associated with NAME 5, DOB5, and DATA5; GENID7 may be associated with NAME 7, DOB7, and DATA7, and the second instance of GENID1 may be associated with NAME 1, DOB1, and DATA9.

These records may be associated with four different subjects. Four unique genetic signatures (GENID1, GENID3, GENID5, and GENID7) may be provided. In one instance, the same genetic signature may be repeated (GENID1). In this situation, the genetic signatures, names, and date of births may be a match. The data may be different. In one example, DATA1 may include data collected at a first time and DATA9 may include data collected at a second time. Data of a subject may change. In some instances, different types of data may be collected about a subject. On other instances, the same type of data may be collected, but the levels indicated by the data may change. For example, for medical records, one or more analyte levels for a subject may change. For financial records, the financial situation of a subject may change.

These records may be part of the same system (e.g., System A) or may be spread out over multiple systems. In one illustration, an additional system (e.g., System B) may be provided, which may also include records. In one example, System A may be a first medical system and System B may be a second medical system. For example, System A may be a clinic, hospital, or laboratory and System B may be a different clinic, hospital, or laboratory. In another example System A may be a first financial institution, and System B may be a second financial institution. For instance, System A may be a first bank and a System B may be a second bank. The System A and System B may also be different types of systems (e.g., one system may be a medical system while system B may be a financial system). Any systems may apply to any types of applications including but not limited to health care, banking, embassy, electronic commerce, private or publication transportation services, building security, location access, and/or device access. Any number of systems may be provided, including but not limited to one or more, two or more, three or more, four or more, five or more, six or more, seven or more, eight or more, nine or more, ten or more, fifteen or more, twenty or more, thirty or more, fifty or more, one hundred or more, two hundred or more, five hundred or more, or one thousand or more systems. The various systems may be the same or different types of systems of various applications.

In some embodiments, each of the systems may have one or more sets of records with genetic identifiers. For example, System B may be provided which may include records with GENID1, GENID4, GENID6, GENID7, and GENID10. These records may be associated with five different subjects. Five unique genetic signatures (GENID1, GENID4, GENID6, GENID7, and GENID10) may be provided. In one instance, the same name may be repeated (NAME1) but different genetic signatures may be provided (GENID1, GENID6). In some instances, different people may have the same name (e.g., John Smith). However, even if different people have the same name, they may still be distinguishable by their genetic signatures, which are unique.

When tracking an individual over a single system or multiple systems, it may be useful to have a unique identifier for which one can be assured that the record refers to a particular individual. Even if one were to look at the same name, date or birth, or other information associated with a subject, one cannot have a 100% degree of certainty that the record refers to the same person. Also, in some instances, there may be fraudulent cases of identity theft or borrowing. For example, an individual may borrow another individual's identity to undergo health care. Thus, a unique identifier that is connected to the subject and not easily falsifiable may be beneficial.

When viewing the records between System A and System B, it can be noticed that GENID1 shows up three times. In all instances, the subject's name (NAME 1) and date of birth (DOB1) match. The data associated with the subject may vary (DATA1, DATA 2, DATA 9). This may represent a case where records relating to an individual may be available on multiple systems, and different types of data, or the same types of data were collected for the individual. In one example, the data associated with the subject may be medical records, including electronic medical records. If a health care professional wanted to view all of the medical records associated with the subject with GENID1, the system may search for the records by the GENID1 index, and draw up all the records corresponding thereto. The search may be within a single system (e.g., System A) or may encompass multiple systems (e.g., System A and System B).

When viewing the records between System A and System B, it can be noticed that GENID7 shows up twice. In the instances it shows up, the subject's name may be different (e.g., NAME7 and NAME8). The subject's date of birth (e.g., DOB7, DOB8) may also be different. This may be a situation where an individual may be trying to pass off as multiple individuals. In one example, an individual may have bad credit, and may be trying to pass off as a different individual when applying for a loan or credit card. This may raise an alert or red flag. It may be difficult for an individual to falsify the individual's genetic signature.

Furthermore, when viewing the records of System A and System B, it can be noticed that two different genetic signatures (GENID3, GENID10) are provided for the same name (NAME3) and date of birth (DOB3). This may suggest a situation where multiple individuals are trying to pass off as the same individual. In one example an individual may not have health insurance, but may try to pass oneself off as one's friend or family member who has health insurance. However, the genetic signatures will appear differently for the two individuals claiming to be the same subject. This may raise a red flag.

Thus, tracking records via genetic signature may be a useful way of determining which individuals a record really is associated with. As previously mentioned, there are challenges with different systems or within the same system where certain pieces of information are not guaranteed to be unique for an individual (e.g., name, date of birth). Similarly, different systems may have different formats for records, which may provide an added challenge if determining if particular pieces of information are equivalent. Thus, it may be advantageous to track records using a genetic signature which may be the same across all the systems and may be unique for the subject. In one example, a user may be interacting with a graphical user interface, such as a web site. The user may be interacting with a subject's records via the web site. The user may enter information relating to the subject within a search field of the web site. For example, the user may enter the subject's genetic signature or other information associated with an identifier for the subject. The system may search accessible records and pull records that include the subject's genetic signature. The system may compare the entered genetic signature with one or more genetic signature in the system. If the signatures match, the system may pull the records associated with the matching genetic signature. The signatures may need to match exactly in order to pull records. Alternatively, the signatures may fall within an acceptable range, if a dynamic component is also considered as part of the signature or identifier.

The system may only have access to records within the system (e.g., if user is accessing System A through the website, the user may have access to only System A records). Alternatively, the system may have access to records in multiple systems (e.g., if user is accessing System A through the website, the user may have access to System A and System B records). The entry system may have access to multiple systems of the same type as the entry system. For example if a user logs into a medical web site, the user may be able to access records from other medical systems. The entry system may have access to multiple systems of different types as the entry system. If the user logs into a medical web site, the user may also be able to access financial records from other systems.

As previously described, a genetic signature may be used to index any sort of information relating to the subject. The genetic signature may be linked to medical records, insurance records, prescription records, financial records, embassy records, electronic commerce records, sales records, transportation records, building security records, employment records, government records, criminal records, news records, birth records, education records, and/or any other type of records associated with the subject.

In some embodiments, it may be useful to use a genetic signature to access multiple types of medical records, including records at hospitals, emergency rooms, clinics, laboratories, physician's office, pharmacies, payers (such as health insurance companies), or any other types of medical records. Any medical records described herein may be electronic medical records, and may be part of an electronic medical record database.

In some embodiment, methods are provided for correcting a record in a database. Using a system or method as described herein, genetic signatures from subjects may be associated with the subjects' records in one or more database. The subjects' records may contain descriptive information relating to the subject, such as name, date of birth, etc. Multiple records from within the same database or different databases may be analyzed and grouped based on the genetic signature associated with the records. In the event that this analysis identifies records which share the same genetic signature, but which have different descriptive information relating to the subject, these records can be flagged for further analysis and/or corrected. Records flagged for analysis and/or correction may be reviewed, for example, by an operator of the system or other party to identify the correct descriptive information relating to the subject for each of the records. An operator of the system or other party may correct the record(s) at issue as appropriate.

In some situations, a record can be automatically corrected. In an example, a first record and a second record are involved. Each record may contain (i) a genetic signature and (ii) descriptive information relating to a subject (e.g. name, date of birth, etc.). The first record may be automatically corrected, if, for example, based its genetic signature, it is grouped with the second record, and the first record has different descriptive information relating to the subject than the second record. If it is known that the second record is of a source that generally has more accurate descriptive information relating to subjects than the source of the first record, the first record may be corrected to change its descriptive information relating to the subject to match the descriptive information for the subject in the second record. In another example, a first record and a plurality of other records (e.g. 2, 3, 4, 5, or more) (the “additional records”) are involved. Each record may contain (i) a genetic signature and (ii) descriptive information (e.g. name, date of birth, etc.) relating to a subject. The first record may be automatically corrected, if, for example, based its genetic signature, it is grouped with a plurality of other records, and each of the additional records share the same descriptive information relating to the subject, but the first record has different descriptive information relating to the subject. In this circumstance, the first record may be corrected to change its descriptive information relating to the subject to match the descriptive information for the subject in the additional records. Additional methods for the automatic correction of records may be used, as well.

Any description herein of a unique identifier, may be applied to a genetic signature, or other type of unique identifier (which may include a static and/or dynamic component as described elsewhere herein) and vice versa.

Data Aggregation

An identifier, such as a genetic signature, may be useful for aggregating data from different systems. Different systems may have the same format or different formats. For example some systems may save a subject's name in its entirety (e.g., “John Smith”, or “Smith, John”) while other systems may save a subject's first and last names as different fields (e.g., “John” and “Smith”). Different systems may collect the same or different types of information relating to a subject. When considering information gathered across multiple systems, one of the challenges with conventional systems may be to account for information may that may be stored in different manners. Thus, a genetic signature may be useful, as an identifier that may be unique for a subject regardless of the system, and that may have the same format or comparable identifiable formats across multiple systems. The genetic signature may be useful as an index or basis for aggregating data from multiple systems.

FIG. 6 shows an example of multiple systems (SYSTEM A, SYSTEM B). The systems may each have one, two or more records. The records may or may not have different formats. The records may be associated with a subject, and may be indexed by an identifier for the subject. Preferably, the identifier may be a unique identifier, such as the subject's genetic signature (e.g., GENID1, GENID3, GENID4, . . . ).

The records across a plurality of systems may be aggregated. The records may be aggregated by associating records belonging to the same subject with one another. In some instances, the records belonging to the same subject may remain within their respective systems but may be associated with one another. For example, the records associated with GENID1 may remain in SYSTEM A and SYSTEM B respectively, while these records may be somehow associated or linked to one another.

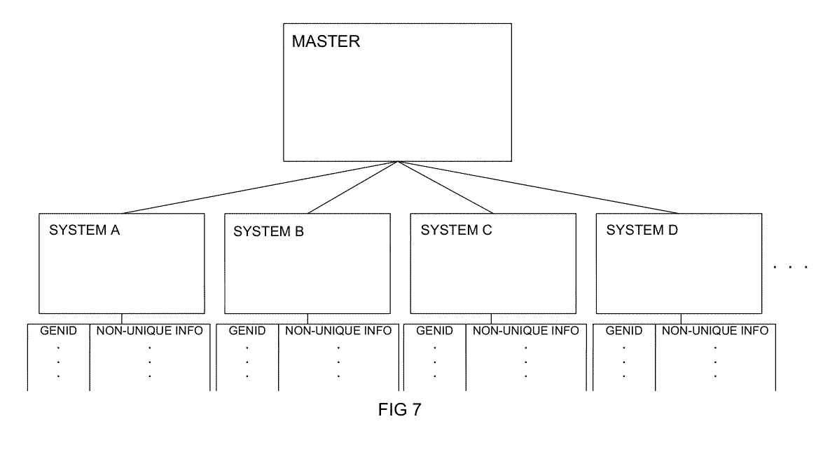

In other instances, the records belonging to the same subject may be associated with one another by being brought and/or copied into a master system having an aggregated set of records. For example, FIG. 7 provides an illustration of a master system (MASTER) capable of accessing a plurality of subsystems (e.g., SYSTEM A, SYSTEM B, SYSTEM C, SYSTEM D). One or more records of the subsystems may include a unique identifier (e.g., genetic signature GENID), and additional information (e.g., non-unique information). The records of the subsystems may be aggregated within a single records system accessible by the master system. Alternatively, the records of the subsystems may be remain within their respective subsystems, but be accessible by the master system. The master system may provide access to a single aggregated records system, or may provide access to a plurality of records systems that may be aggregated by association.

When creating a single aggregated records system, the master system may search the subsystem by genetic signature, and may aggregate the records associated with a particular genetic signature together. In some instances, within a single aggregated records system, only one set of records may be provided per genetic signature. The one set of records may include an aggregation of the various records that were previously associated with the genetic signature. Alternatively, the single aggregated records system may permit a plurality of records per genetic signature. The plurality of records for a particular genetic signature may be stored together or may be linked or associated with one another. A user may be able to search the records system for all records associated with a particular genetic signature.

When accessing a distributed aggregated records system (e.g., distributed over multiple systems), the master server may be able to search for and pull records based on the genetic signature as the index from the multiple subsystems. The records may or may not be associated or linked with one another.

A method of aggregating a plurality of records may include providing a first record system and a second record system. The first record system may have a first memory unit that may store one or more records relating to one or more subjects, an individual record comprising a genetic signature of an individual subject that is associated with at least one type of personal information of said individual subject. The second record system may have a second memory unit that may store one or more records relating to one or more subjects, an individual record comprising a genetic signature of an individual subject that is associated with at least one type of personal information of said individual subject.

The method may include comparing the genetic signature of the first record system and the genetic signature of the second record system. Said comparison may be performed by a processor. If the genetic signatures of the first and second record systems are the same, then the records of the first and second record systems may be associated with one another, thereby aggregating the plurality of records.

In some embodiments, the at least one type of personal information may include any information of the subject. For example, the personal information may include the subject's name, date of birth, address, telephone number, email address, medical records, financial records, payer records, or any other type of information described elsewhere herein. In one example the first record system and the second record system may be medical records systems, financial records systems, or any other types of record systems described herein. The genetic signature may include a hash, or may be based any other algorithm or calculation, of a sequenced portion of a biological sample collected from the subject.

In some instances, data aggregation may occur within a single system. Records having the same unique identifier, such as a genetic signature, within a single system may be associated with one another. In some instances, the records may be appended or consolidated. For example, SYSTEM A of FIG. 6 may include a plurality of records having GENID1 as an identifier. All the records having GENID1 may be associated with or linked to one another. Alternatively, all the records having GENID1 may be consolidated into a single record, so that only a single GENID1 record exists.

Authentication/Passcode

A genetic signature may be useful for authenticating a subject. The genetic signature may be used to verify the identity of a subject. The identity of the subject may be verified in order to grant the subject access to a location, item, and/or service. In some instances, the subject may be identified for legal identification purposes.

For example, a subject may wish to gain access to a location. The subject's identity may be verified prior to providing access for a subject to that location. Locations may include stationary and/or movable locations. Examples of stationary locations may include a building, room, office, laboratory, park, parking lot. Stationary locations may include health care facilities (e.g., hospitals, emergency rooms, clinics, laboratories, pharmacies, physician's offices), financial facilities (e.g., bank), embassies, government facilities, law enforcement facilities, or any other location that may want to control access. Examples of movable locations may include transportation, such as vehicles, cars, buses, trains, airplanes, helicopters, vans, boats, ships, trolleys, trucks, or any other movable locations that may wish to control access.

In some instances, a subject may wish to gain access to an item and/or system. The subject may need to verify the subject's identity before gaining access to the item. For example, the subject may need to verify the subject's identity before a subject can log into a computer or other networked device. In another example, a subject may need to verify the subject's identity before the subject can pick up prescription drugs.

A subject's identity may be verified before a subject can gain access to a service. For example, a subject's identity may be verified before a subject receives one or more medical services (e.g., performing one or more test on a subject at a sample processing device). The subject's identity may be verified before the subject receives specialized information (e.g., logging into a computer before gaining access to information accessible by the computer, such as financial or electronic commerce information).

A subject's identity may be verified so that the subject can receive legal documents and/or be legally identified. For example, a subject's identity can be verified to receive a passport, driver's license, or other legal documentation. The subject's identity can be verified to be used in place of a legal document. For example, the subject's identity can be verified to permit a subject to travel in situations where the subject would otherwise require a passport, or to permit the subject to apply for a job, where the subject would normally need to bring two forms of identification.

Using systems and/or methods provided herein, a subject's identity may be verified quickly. In some instances, a subject's identity may be verified within 0.1 s or less, 0.5 s or less, 1 s or less, 5 s or less, 10 s or less, 20 s or less, 30 s or less, 45 s or less, 1 min or less, 1 min 30 s or less, 2 min or less, 3 min or less, 4 min or less, 5 min or less, 7 min or less, 10 min or less, 15 min or less, 20 min or less, 30 min or less, 45 min or less, 1 hour or less, 90 min or less, 2 hours or less, 3 hours or less, or 5 hours or less of a system receiving the genetic information for the subject. The subject's identity may be verified within 0.1 s or less, 0.5 s or less, 1 s or less, 5 s or less, 10 s or less, 20 s or less, 30 s or less, 45 s or less, 1 min or less, 1 min 30 s or less, 2 min or less, 3 min or less, 4 min or less, 5 min or less, 7 min or less, 10 min or less, 15 min or less, 20 min or less, 30 min or less, 45 min or less, 1 hour or less, 90 min or less, 2 hours or less, 3 hours or less, 5 hours or less, 6 hours or less, 8 hours or less, 12 hours or less, 18 hours or less, 24 hours or less, 36 hours or less, or 48 hours or less of receiving a sample at a sample processing device. The subject's identity may be verified in real time.

FIG. 8 shows an example of a system for authenticating one or more subject. A subject 801 may provide a sample to a point of service location 802. The point of service location may communicate with an authenticating entity 803 over a network 804. The authenticating entity may determine whether the subject's identity is verified.

In some instances, a plurality of samples may be provided. In some instances, the plurality of samples may include a single type of sample, or a plurality of types of samples.

A sample processing device may be provided at the point of service location. The sample processing device may be capable of receiving the sample and performing one or more sample processing steps. In some instances, the sample may be received at the device directly from the subject without any intervening sample processing steps. The sample processing device may utilize one or more of the steps described elsewhere herein when receiving one or more sample. The sample processing device may transmit information related one or more detected signals from the processed sample. The information may be transmitted to an authenticating entity. The authenticating entity may verify the identity of the subject. The authenticating entity may include one or more processor and/or memory. The authenticating entity may operate via a cloud computing based infrastructure.

In alternative embodiments, the sample processing device may be an authenticating entity and need not transmit any authenticating. For example, the sample processing device may determine on-board whether the subject is entitled to have one or more test performed on the subject's sample at the sample processing device.

The genetic signature may be generated on-board the device. The genetic signature may be generated at the point of service location. Alternatively, the genetic signature may be generated at the authenticating entity, or any other third party entity. The sample from the subject may be sequenced at the device or at any other location.

The authenticating entity may compare a genetic signature based on the sample received by the sample processing device with one or more records accessible by the authenticating entity. In some instances, the authenticating entity may be capable of accessing records of individuals who are entitled to access a location, item, or service. The authenticating entity may compare the genetic signature from the sample with a genetic signature stored in the records. If the genetic signature from the sample matches a genetic signature stored in the records, the identity of the subject who provided the sample may be verified as the identity of the individual whose genetic signature is stored in records. Access may be granted to the subject if the individual in records is listed as an individual for whom access granted. In some embodiments, the records may indicate what degree of access the individual is granted, and the subject may be granted access accordingly. The records may indicate if an individual is not granted access (e.g., blacklist), and the subject may be prevented from gaining access accordingly.

Any description of a genetic signature from a sample matching a genetic signature in records may also be applicable to comparing an identifier generated from a sample with an identifier in records. For example, the identifiers may “match” if they are identical, or if they fall within an acceptable range, predicted trajectory, or within an acceptable variation. For example, the identifiers may also include one or more dynamic components that may be considered. Trending analysis, predictive models, or other rules may be accessed to determine whether a dynamic component falls within an expected and/or predicted value range or trajectory, and that the identifiers can be said to match. In some instances, an identifier may include additional information collected about the subject, such as biometric data and/or physiological data. Alternatively, the biometric data and/or physiological data may be associated with the identifier, and may be compared separately to determine if they match. For example, a subject's collected fingerprint may be matched with one or more fingerprint stored in records. If they are the same, they may be considered to “match.” In another example, the subject's height may be measured and may be matched with the subject's height stored in records. If they fall within a predicted value range and/or trajectory, they may be said to “match.” This may involve additional information about the subject. For example, if the subject is an adult, the subject's height may not be expected to change to any significant degree. If the subject is a child, the subject's height may be expected to increase by a predicted amount, while the subject is not expected to shrink. If the subject's height increases outside the predicted range (e.g., the subject grows two feet overnight), then a red flag may be ranged and the subject's height is not said to “match.”

A dynamic component may include a dynamic biological signature of a subject, such as a proteomic, metabolomic, or other analyte signature of the subject. A proteomic, metabolomic, or other analyte signature may be generated from a sample provided by the subject to the sample processing device. The proteomic, metabolomic, or other analyte signature may be generated from the same sample from which the genetic signature is derived. Alternatively, the subject may provide multiple samples to the sample processing device (which may be the same time or different types of samples), which may be used to separately generate the genetic signature and/or proteomic, metabolomic, or other analyte signature. A dynamic component may be generated based on a sample provided by the subject, which may or may not be the same sample used to generate a static portion of an identifier. The dynamic component may utilize protein levels of the subject, metabolite level of the subject, analyte levels of the subject, physiological parameters of the subject, biometric information of the subject, and/or any other information relating to the subject. The dynamic component may include a proteomic signature, metabolomic signature, any analyte signature, physiological signature, biometric signature, or any combination thereof. Any description herein of a proteomic signature may apply to any other type of dynamic signature described herein, and vice versa.

Authentication may require additional verification. For example, a subject may need to provide an identification card, an image of the subject, audio sample of the subject, biometric information of the subject, physiological parameter of the subject, dongle with a changing number, image or string, answers to key questions, and/or a password to authenticate the subject. The subject's unique identifier (such as a genetic signature) may be compared with a genetic signature stored in an authenticating entity's records. The additional information provided by the subject may be compared with the additional information in records. The additional information may need to be identical to the information in records, or may need to fall within a certain range, trajectory or variation with respect to the information in records. For example, the subject's fingerprint or password may be expected to stay the same, while the subject's heart rate may vary within an acceptable range. In another example, the subject's password may be expected to match the password in records, while the number provided by the dongle may change in a predictable manner.

If the identity of the subject is verified, and the records state that the subject is granted a particular access, the subject may be granted access to the location, item, and/or service that the subject is requesting. An individual may be provided with access to a secured location, item/device, and/or service if the verified identity of the individual falls within a group of one or more identities permitted to access the secured location, item/device, and/or service.

A method of verifying an identifying a subject may include comparing a genetic signature with a pre-collected genetic signature of an individual. The pre-collected genetic signature may be stored in a memory unit. The genetic signature of the subject may be obtained by analyzing a biological sample from the subject tendered at a point of service location. A match between the genetic signature and the pre-collected genetic signature may verify the identity of the subject. The point of service location may include a sample processing device that may be configured to receive the biological sample from the subject and process the sample to yield the genetic signature. The device may be configured to run one or more chemical reaction with the biological sample. The device may be configured to prepare the sample for the one or more chemical reaction.

The comparison may be made with the aid of a processor. The processor and memory unit may be part of the same device. Alternatively, the processor and memory unit need not be part of the same device. The processor and/or memory unit may have a cloud computing-based infrastructure. The pre-collected genetic signature may be associated with additional information about the individual. Such additional information may include medical records (e.g., laboratory test result), financial records, or any other types of records as described elsewhere herein. Verifying the identity of an individual may permit the association of the genetic signature with the additional information.

In some embodiments, the amount of time between collecting the biological sample from the subject and the completion of comparing the genetic signature with the pre-collected genetic signature may be no more than 1 s, 5 s, 10 s, 30 s, 1 min, 2 min, 5 min, 10 min, 15 min, 20 min, 30 min, 45 min, 1 hour, 90 min, 2 hours, 3 hours, 4 hours, 5 hours, 6 hours, 7 hours, 8 hours, 10 hours, 12 hours, 15 hours, 18 hours, 24 hours, 30 hours, 36 hours, 42 hours, 48 hours, or any other length of time including those described elsewhere herein.

Characteristic Identification

A genetic signature may be used for characteristic identification applications. For example, sample processing, which may include genomic analysis, may be carried out to identify subjects having certain characteristics. Such characteristics may include permanent characteristics, or a state of the subject. Such analysis may occur on any data collected about the subject, which may include data based on nucleic acid amplification of the subject, sequenced genomic information of the subject, and/or genetic signatures of the subject.

Such characteristics may impact certain tasks for the subject. For example, for certain critical tasks, such as emergency response or military exercises, genetic traits may provide individuals with certain characteristics that may be beneficial in certain situations. Some individuals may have resistance or susceptibility to certain toxins. Such individuals could be identified and selected or rejected ahead of time or in real-time based on testing for certain rescue missions. In other examples, such characteristics may impact pharmacological compounds that the subject may be able to take, as described in greater detail below.

Other tests could be performed to help assess an individual's current mental, health and/or physical state. Examples of such states may include how exhausted a person may be or other health measures, such as infectious or immunity states. The testing could also be used to determine allergies or other sensitivities that may be avoided for the individual. In some instances, for example, if an individual is part of an emergency rescue task but has a particular sensitivity to a compound, the individual may not be selected for a mission in an area that has a high concentration of the compound. Similarly, if an individual is a health care professional and a lowered immunity state is detected, the individual may not be selected to respond to an epidemic.

When generating a genetic signature for an individual, characteristics of the subject may be assessed. Such characteristics may be determined based on genetic information of the subject. The same sample used to generate a genetic signature for the subject may be used for characteristic identification. Alternatively, separate samples or portions of a sample may be used to generate the genetic signature and determine characteristic information. In another example, the genetic signature may be used to determine the characteristic information.

Pharmacogenomics

A genetic signature may be used for pharmacogenomic applications. In some embodiments, a subject's genetic signature may be used to determine whether a prescription is proper and/or optimal for a subject, or to assist with determining which drugs to prescribe to a subject, and optionally at what dose. The subject's genetic signature may also be used to confirm a subject's identity when the subject picks up a prescription or drug. This may reduce the likelihood of identity fraud. The genetic signature may be useful for tracking records for the subject's prescriptions. The genetic signature may permit records across multiple systems to be accessed to create a more complete historical picture of the subject's past and current prescriptions. Accessing a history of the subject's prescriptions may permit a support system to raise any red flags if the subject is refilling certain prescriptions at a faster than acceptable rate. Red flags may also be raised if the subject is taking out conflicting prescriptions.

The subject's signature may also be used to evaluate the subject's genetic information to check if there are any conflicts with the prescription and genetic information about the subject. For example, if the subject's genetic signature registers that the subject is a male and the prescription is only applicable to females, then a flag may be raised. Similarly, if the subject's genetic information indicates a genetic risk presented for certain kinds of drugs, a red flag may be raised if the subject is picking up that type of drug. A prescription support system may be useful in suggesting prescriptions to a health care professional, or raising red flags on prescriptions entered by the health care professional. For example, individuals with certain gene sequences may be known to have severe side effects with a particular drug, type of drug, or drug dosage. In such situations, another prescription or dosage to treat particular symptoms, but without the severe side effects may be suggested. In another example, a prescription support system may note that certain prescriptions may be more effective for individuals of a certain genetic make-up than other prescriptions, and such prescriptions may be suggested.

The prescription support system may store and collect data relating to genetic information of individuals, prescriptions, and/or impact on the individuals (e.g., efficacy, toxicity). The prescription support system may utilize one or more predictive model, which may determine a likelihood of an impact of a particular drug on an individual of certain genetic make-ups. The predictive model may take into account additional data collected with respect to impact of prescriptions on individuals with certain genetic information. A feedback of information may assist with fine-tuning the predictive capabilities of the model. Thus, the prescription support system may be self-learning. The prescription support system may be directed to an individual based on previous information collected about the individual. The prescription support system may also be directed to a general population or specific groups within a population (e.g., age, gender, disease state or states, family history, specific genetic markers or traits, environment, geographic location, physiological traits (e.g., heart rate, blood pressure), diet, exercise habits, other lifestyle habits, infections, other medications, stress, treatment history, other demographic information).

Pharmacogenomic information may be combined with other patient information and compared to a database stratifying patients based on such information. Additional information may include proteomic data, data concerning drug metabolism, pharmacokinetic data (e.g. distribution, metabolism, and excretion of a drug and its metabolites following administration), pharmacodynamics (e.g. effects of a drug and its metabolites on the body over time), and disease progression (e.g. disease responses to medication).

Any red flags or suggestions may be raised by a decision support system, which may be a prescription support system and/or may have any of the characteristics of the prescription support system described herein. The decision support system may be a software that may detect certain conditions from the aggregated records. Alternatively, red flags may be raised, or suggestions for prescriptions may be made, by a physician (e.g., prescribing physician), pharmacist, or other health care professional who may have access to the aggregated records.

Additional Fields

A unique identifier, such as a genetic signature, may be useful for identification of organisms that need not be human. For example, organisms may be any subject described elsewhere herein, and/or plants or other organisms which may have genetic information.

The systems and methods described herein may be useful in agricultural and/or industrial biotechnological fields, or any other field where the identity of highly engineered organisms may be valued.

For example, a unique identifier, such as those described herein may be used to identify and/or index any organism, including genetically engineered organisms. The unique identifier may be associated with additional data relating to the organisms, which may include genetically engineered organisms. For example, if a genetically engineered plant is created, identifying information, such as a genetic signature, for the genetically engineered plant may be used to index a record relating to the plant. The records for the organisms may be tracked and/or the identification of the genetically engineered organisms may be verified, using any of the systems and methods described elsewhere herein. Various records in different systems relating to the organisms may be aggregated using any of the systems and methods described elsewhere herein. Such records may include agricultural and/or industrial biotechnological records.

Any description herein relating to an identifier and a subject may be applied to any organism, including genetically engineered organisms described herein.

Kinship/Genotyping

In some embodiments, it may be desirable to determine a subject or any other organism's kinship or genotyping. As previously mentioned, any description herein of a subject may be applied to any type of organism, including genetically engineered organisms, microorganisms, plants, or animals. Any description herein of a subject may also be applied to an industrial product containing or derived from an organism, such as an agricultural product, food/beverage product, or any other type of organism-related product. Any description herein of a biological sample may refer to any sample taken from any subject or product.

In one example, a unique identifier, such as a genetic signature, may be used to determine a subject's kinship or genotype. This may include determining the subject's species, genus, geographic origin, genetic origin, or any other type of information about the subject. This may also include determining whether a subject is related to another individual and/or how they are related. Determining relations between a subject and another individual may assist with identifying the subject.

The systems and methods herein may provide a quick method to determine the static signature and/or dynamic signature of a subject. In some instances, for a static signature, which may include a genetic signature, a smaller set of specific genetic markers may suffice for kinship/genotyping purposes than for unique identification purposes. Such tests may be performed at breeding/origin and/or retail stage. In some embodiments, such tests may be performed the first time a subject is being entered into a database and/or the first time the subject's genetic signature is being generated.

In some embodiments, samples from one or more kin of a subject may be collected. If a subject has not yet had a sample collected and/or been entered into a database, the subject's genetic information may be compared with an alleged kin of the subject. One example where there may be useful may be comparing a mother and child's genetic signatures to avoid switching babies. Another example may include post-mortem samples, when a subject is not in a database. For example, if a subject is deceased and not easily identifiable, or identification confirmation is useful, comparing a subject's genetic signature with a genetic signature of other people, who may be the subject's kin, may help identify the subject.

Pathogens

In some embodiments, systems and method provided herein may be used for the identification and/or classification of pathogens. Pathogens can include, without limitation, bacteria, viruses, and protists. Examples of pathogens include, without limitation, influenza A virus, HIV, hepatitis B virus, etc.

In an example, systems or methods provided herein may be used to identify a pathogen in a sample. For example, a sample suspected of containing a pathogen may be collected, and the sample processed as described herein to assay for the pathogen. In an example, a unique identifier such as a genetic signature may be generated for an organism from a sample, and the unique identifier may be used to identify the organism and/or to index the organism as a pathogen. In another example, a sample may be processed to assay for one or more analytes indicative of the pathogen (e.g. levels of one or more proteins, presence or absence of one or more genetic markers, or levels of one or more nucleic acid targets which are indicative of the presence or absence of the pathogen). In another example, a sample from a subject suspecting of having an infection may be processed to identify whether the suspect has a bacterial or viral infection.

Systems and methods proved herein may be used for the rapid identification of a pathogen in a sample. In some instances, a pathogen in a sample may be identified within 0.1 s or less, 0.5 s or less, 1 s or less, 5 s or less, 10 s or less, 20 s or less, 30 s or less, 45 s or less, 1 min or less, 1 min 30 s or less, 2 min or less, 3 min or less, 4 min or less, 5 min or less, 7 min or less, 10 min or less, 15 min or less, 20 min or less, 30 min or less, 45 min or less, 1 hour or less, 90 min or less, 2 hours or less, 3 hours or less, 5 hours or less, 6 hours or less, 8 hours or less, 12 hours or less, 18 hours or less, 24 hours or less, 36 hours or less, or 48 hours or less of a sample containing the pathogen being received at a sample processing device. Systems and methods proved herein may be used to rapidly identify if a subject is infected with a pathogen and/or to identify the specific pathogen or type of pathogen infecting the subject. Using a system or method provided herein, a physician or other health care provider may rapidly identify a pathogen in a subject and/or sample from a subject. In addition, using a system or method provided herein, the physician or other health care provider may rapidly and accurately diagnose an infection in a subject and/or prescribe a therapy for a subject to combat the infection or ameliorate the symptoms of the infection.

### EXAMPLES

### Example 1

### Extraction of DNA and RNA

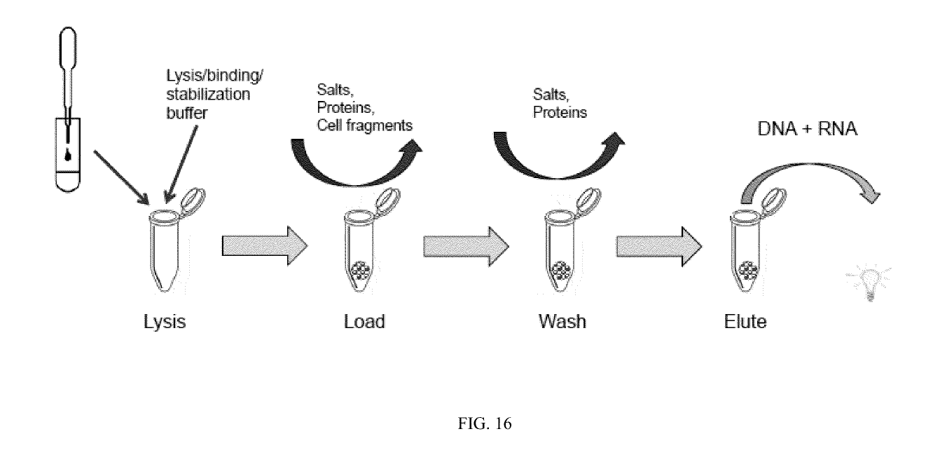

FIG. 16 illustrates an example sample purification process. In a tube, tip, or other container, a collected sample is combined with a lysis buffer for the lysis of cells or particles, and stabilization and binding of nucleic acids. The lysis buffer may comprise guanidinium thiocyanate, isopropanol, triton X-100, MOPS buffer at pH 7, and carrier RNA. Released nucleic acids bind to the internal surface of the container (or a solid phase contained therein, such as beads), and unbound materials (e.g. salts, proteins, cell fragments and other debris) are removed. The sample is then washed by the addition and removal of a wash buffer. The wash buffer may comprise MOPS buffer at pH 7, salt (e.g. NaCl), and ethanol. The wash may be performed once, or may be repeated for increased purity of the subsequent eluate. After removal of wash buffer, an elution buffer is added to release bound nucleic acids. The elution buffer may comprise Tris-HCl at pH 8.5. Where beads are used as the solid surface for nucleic acid capture, the beads may be magnetic or paramagnetic, and retention of beads and attached nucleic acids may be effected by the application of a magnetic field. Beads may comprise a silica surface. Purified nucleic acid products may then be passed to an amplification process.

While the above is a complete description of the preferred embodiments of the present invention, it is possible to use various alternatives, modifications and equivalents. Therefore, the scope of the present invention should be determined not with reference to the above description but should, instead, be determined with reference to the appended claims, along with their full scope of equivalents. Any feature, whether preferred or not, may be combined with any other feature, whether preferred or not. The appended claims are not to be interpreted as including means-plus-function limitations, unless such a limitation is explicitly recited in a given claim using the phrase “means for.” It should be understood that as used in the description herein and throughout the claims that follow, the meaning of “a,” “an,” and “the” includes plural reference unless the context clearly dictates otherwise. Also, as used in the description herein and throughout the claims that follow, the meaning of “in” includes “in” and “on” unless the context clearly dictates otherwise. Also, as used in the description herein and throughout the claims follow, terms of “include” and “contain” are open ended and do not exclude additional, unrecited elements or method steps. Finally, as used in the description herein and throughout the claims that follow, the meanings of “and” and “or” include both the conjunctive and disjunctive and may be used interchangeably unless the context expressly dictates otherwise. Thus, in contexts where the terms “and” or “or” are used, usage of such conjunctions do not exclude an “and/or” meaning unless the context expressly dictates otherwise.

1-35. (canceled)

36. A method of associating a genetic signature of an individual subject with a medical record, comprising:
comparing, with the aid of a processor, a genetic signature of the individual subject with a pre-collected genetic signature of the individual subject stored in a memory unit,
wherein,
the genetic signature is obtained by analyzing a biological sample of the individual subject tendered at a point of service location,
a match between the genetic signature and the pre-collected genetic signature verifies the identity of said individual subject,
the pre-collected genetic signature has one or more medical record associated therewith, and,
verification of the identity of the individual subject permits the association of the genetic signature with said one or more medical record.

37. The method of claim 36, wherein the one or more medical record is a laboratory test result.

38-43. (canceled)

44. The method of claim 36, wherein said medical record comprises a first record, and further comprising at least a second record effective to provide a method of aggregating a plurality of records, comprising:
providing a first record system comprising a first memory unit that stores one or more records relating to one or more subjects, and an individual record comprising a genetic signature of an individual subject that is associated with at least one type of personal information of said individual subject, wherein said individual record comprises a medical record;
providing a second record system comprising a second memory unit that stores one or more records relating to one or more subjects, an individual record comprising a genetic signature of an individual subject that is associated with at least one type of personal information of said individual subject; and
comparing, using a processor, a genetic signature of the first record system and a genetic signature of the second record system, wherein if the genetic signature of the first record system and the genetic signature of the second record systems are the same, associating the records of the first and second records systems, thereby aggregating the plurality of records.

45. The method of claim 44, wherein the personal information includes one or more of the individual's name, date of birth, address, telephone number, email address, medical records, financial records, or payer records.

46. The method claim 44, wherein the genetic signature includes a hash of a sequenced portion a biological sample collected from the individual.

47-79. (canceled)

80. A system for associating a genetic signature of an individual with a medical record, the system comprising:
a memory unit configured to store a pre-collected genetic signature of the individual; and
a processor configured to compare a genetic signature of the individual with the pre-collected genetic signature,
wherein,
the genetic signature is obtained by analyzing a biological sample of the individual,
a match between the genetic signature and the pre-collected genetic signature verifies the identity of said individual,
the pre-collected genetic signature has one or more medical record associated therewith, and
verification of the identity of the individual permits the association of the genetic signature with the one or more medical record.

81. The system of claim 80, wherein the one or more medical record is a laboratory test result.

82-84. (canceled)

85. The system of claim 80, comprising a plurality of record systems suitable for aggregation, said plurality of record systems including a medical record system, providing a records aggregation system comprising:
a first record system comprising a first memory unit that stores one or more individual records relating to one or more subjects, an individual record comprising a genetic signature of an individual subject that is associated with at least one type of personal information of said individual subject, wherein said first type of personal information comprises a medical record;
a second record system comprising a second memory unit that stores one or more individual records relating to one or more subjects, an individual record comprising a genetic signature of an individual subject that is associated with at least one type of personal information of said individual subject; and
a processor configured to compare the genetic signature of the first record system and the genetic signature of the second record system, wherein if the genetic signature of the first record system and the genetic signature of the second record systems are the same, the processor associates the records of the first and second records systems, thereby aggregating the plurality of records.

86. The records aggregation system of claim 85, wherein the personal information includes one or more of the individual's name, date of birth, address, telephone number, email address, medical records, financial records, or payer records.

87. The records aggregation system of claim 85, wherein the genetic signature includes a hash of a sequenced portion a biological sample collected from the individual.

88-116. (canceled)

117. A tangible computer readable media comprising machine-executable code for implementing a method of aggregating a plurality of records, comprising:
providing a first record system comprising a first memory unit that stores one or more records relating to one or more subjects, an individual record comprising a genetic signature of an individual subject that is associated with at least one type of personal information of said individual subject;
providing a second record system comprising a second memory unit that stores one or more records relating to one or more subjects, an individual record comprising a genetic signature of an individual subject that is associated with at least one type of personal information of said individual subject; and
comparing, using a processor, the genetic signature of the first record system and the genetic signature of the second record system, wherein if the genetic signature of the first record system and the genetic signature of the second record systems are the same, associating the records of the first and second records systems, thereby aggregating the plurality of records.

118. The tangible computer readable media of claim 117, wherein the personal information includes one or more of the individual's name, date of birth, address, telephone number, email address, medical records, financial records or, payer records.

119. The tangible computer readable media of claim 117, wherein the genetic signature includes a hash of a sequenced portion a biological sample collected from the individual.

120-129. (canceled)

130. The method of claim 36, wherein the biological sample is processed in a device comprising at least one of: a sample collection unit, a sample processing unit, a detection unit, or a transmission unit.

131. The method of claim 36, wherein the biological sample is processed in a device comprising at least two of: a sample collection unit, a sample processing unit, a detection unit, or a transmission unit.

132. The method of claim 36, wherein the biological sample is processed in a device comprising at least three of: a sample collection unit, a sample processing unit, a detection unit, or a transmission unit.

133. The method of claim 36, wherein the biological sample is processed in a device comprising: a sample collection unit, a sample processing unit, a detection unit, and a transmission unit.

134. The method of claim 130, wherein the sample processing unit comprises a nucleic acid amplification unit.

135. The method of claim 130, wherein the units are enclosed in a housing.

136-143. (canceled)

144. The system of claim 80, wherein the system further comprises a sample processing device, the sample processing device comprising at least one of: a sample collection unit, a sample processing unit, a detection unit, or a transmission unit.

145. The system of claim 80, wherein the system further comprises a sample processing device, the sample processing device comprising at least two of: a sample collection unit, a sample processing unit, a detection unit, or a transmission unit.

146. The system of claim 80, wherein the system further comprises a sample processing device, the sample processing device comprising at least three of: a sample collection unit, a sample processing unit, a detection unit, or a transmission unit.

147. The system of claim 80, wherein the system further comprises a sample processing device, the sample processing device comprising a sample collection unit, a sample processing unit, a detection unit, and a transmission unit.

148. The system of claim 144, wherein the sample processing unit comprises a nucleic acid amplification unit.

149. The system of claim 144, wherein the units are enclosed in a housing.
